(19) United States
(12) Patent Application Publication
(10) Pub. No.: US 2026/0109469 A1
(43) Pub. Date: Apr. 23, 2026

(54) TURBOFAN ENGINE INCLUDING A FAN ACTUATION SYSTEM

(71) Applicants: General Electric Company, Evendale, OH (US); GE Avio S.r.l., Rivalta di Torino (IT)

(72) Inventors: Randy M. Vondrell, Newport, KY (US); Keith A. Miedema, Fairfield, OH (US); Simone Iurlaro, Torino (IT)

(21) Appl. No.: 19/426,656

(22) Filed: Dec. 19, 2025

Related U.S. Application Data
(63) Continuation-in-part of application No. 19/357,928, filed on Oct. 14, 2025.
Application No. 19/357,928 is a continuation-in-part of application No. 19/097,493, filed on Apr. 1, 2025, now Pat. No. 12,480,415.
Application No. 19/097,493 is a continuation-in-part of application No. 18/400,746, filed on Dec. 29, 2023, now Pat. No. 12,345,178.

(51) Int. Cl. B64D 35/02; F02C 7/06; F02C 7/36; F16H 1/46; F16H 57/04

(52) U.S. Cl. CPC B64D 35/02; F02C 7/06; F02C 7/36; F16H 1/46; F16H 57/0486; F05D 2220/36; F05D 2260/40311

(57) ABSTRACT

A turbofan engine for an aircraft includes a fan and a fan actuation system. The fan has a plurality of fan blades coupled to a fan shaft having one or more fan bearings. The fan blades are rotatable about a pitch axis. The fan actuation system is disposed within a fan hub and includes one or more actuators for rotating the fan blades about the pitch axis and one or more radial thrust bearings. The fan actuation system is characterized by a fan actuation system length envelope in a range from 8.5 to 24 and given by

$$\frac{{N}_{FB} \times {D}_{FT}}{{L}_{AXIAL} \times ( \frac{{R}_{TB}}{{N}_{FB}} )} .$$

N_{FB} is a number of the fan blades, D_{FT} is a fan tip diameter of the fan blades, R_{TB} is a thrust bearing radius of the radial thrust bearings, and L_{AXIAL} is an axial length from a fan hub tip to the fan bearings.

### CROSS REFERENCE TO RELATED APPLICATIONS

This application is a continuation-in-part of U.S. patent application Ser. No. 19/357,928, filed Oct. 14, 2025, which is a continuation-in-part of U.S. patent application Ser. No. 19/097,493, filed Apr. 1, 2025, which is a continuation-in-part of U.S. patent application Ser. No. 18/400,746, filed on Dec. 29, 2023, and issued as U.S. Pat. No. 12,345,178 on Jul. 1, 2025, the contents of all of which are hereby incorporated by reference herein in their entireties.

### TECHNICAL FIELD

The present disclosure relates generally to fan actuation systems for turbofan engines.

### BACKGROUND

Turbofan engines, for example, for an aircraft, generally include a fan having fan blades, a compressor section, a combustion section, and a turbine section arranged in flow communication with one another. Some turbofan engines include a fan actuation system for actuating the fan blades of the fan.

### BRIEF DESCRIPTION OF THE DRAWINGS

The foregoing and other features and advantages will be apparent from the following, more particular, description of various exemplary aspects, as illustrated in the accompanying drawings, wherein like reference numbers generally indicate identical, functionally similar, or structurally similar elements.

FIG. 1 is a schematic cross-sectional diagram of a turbofan engine, taken along a longitudinal centerline axis of the turbofan engine, according to the present disclosure.

FIG. 2 shows a schematic view of a turbofan engine, according to the present disclosure.

FIG. 3 shows a fan having a fan actuation system, according to the present disclosure.

FIG. 4 is a schematic cross-sectional diagram of a fan actuation system for a turbofan engine, taken along a longitudinal centerline axis of the turbofan engine, according to the present disclosure.

FIG. 5 is a schematic cross-sectional view of a fan actuation system for a turbofan engine, according to another aspect.

FIG. 6 is a schematic cross-sectional view of a fan actuation system for the turbofan engine, taken along the longitudinal centerline axis of the turbofan engine, according to the present disclosure.

FIG. 7 is a schematic cross-sectional view of a fan actuation system for the turbofan engine, taken along the longitudinal centerline axis of the turbofan engine, according to another aspect.

FIG. 8 is a schematic cross-sectional view of a fan actuation system for the turbofan engine, taken along the longitudinal centerline axis of the turbofan engine, according to another aspect.

FIG. 9 is a schematic cross-sectional view of a fan actuation system for the turbofan engine, taken along the longitudinal centerline axis of the turbofan engine, according to another aspect.

FIG. 10 is a schematic cross-sectional view of a fan actuation system for the turbofan engine, taken along the longitudinal centerline axis of the turbofan engine, according to another aspect.

FIG. 11 represents, in graph form, a fan actuation system envelope as a function of a loading envelope, according to the present disclosure.

FIG. 12 represents, in graph form, the fan actuation system envelope as a function of a spacing envelope, according to the present disclosure.

FIG. 13 represents, in graph form, a fan actuation system length envelope as a function of a loading envelope, according to the present disclosure.

FIG. 14 represents, in graph form, the fan actuation system length envelope as a function of a spacing envelope, according to the present disclosure.

FIG. 15 is a schematic view of a forward end of a fan of the turbofan engine of FIG. 2, according to the present disclosure.

FIG. 16 is an enlarged, schematic, cross-sectional diagram of the turbofan engine of FIG. 1 and having one or more fan bearings, taken at detail 16 in FIG. 1, according to the present disclosure.

FIG. 17 is an enlarged, schematic, cross-sectional diagram of the turbofan engine of FIG. 1 and having one or more fan bearings, taken along the longitudinal centerline axis, according to another aspect.

FIG. 18 is a schematic cross-sectional view of a fan bearing for the turbofan engine of FIG. 1, according to another aspect.

FIG. 19 represents, in graph form, a fan bearing envelope as a function of a takeoff thrust of the turbofan engine, according to the present disclosure.

FIG. 20 represents, in graph form, the fan bearing envelope as a function of the takeoff thrust, according to another aspect.

FIG. 21 is an enlarged schematic, cross-sectional view of a segment of a fan of having a fan actuation system, according to another aspect.

FIG. 22 is a front schematic view of an aircraft having an engine system, according to the present disclosure.

FIG. 23A is an elevational view showing a counterclockwise gearbox assembly for a turbofan engine, according to the present disclosure.

FIG. 23B is a schematic cross-sectional view of the counterclockwise gearbox assembly of FIG. 23A, taken along a longitudinal centerline axis of the counterclockwise gearbox assembly, according to the present disclosure.

FIG. 23C is an enlarged schematic cross-sectional view of the counterclockwise gearbox assembly of FIG. 23B, taken at detail 23C in FIG. 23B, according to the present disclosure.

FIG. 23D is an enlarged schematic front view of the counterclockwise gearbox assembly of FIG. 23A, taken at detail 23D in FIG. 23A, according to the present disclosure.

FIG. 24A is an elevational view showing a clockwise gearbox assembly for a turbofan engine, according to the present disclosure.

FIG. 24B is a schematic cross-sectional view of the clockwise gearbox assembly of FIG. 24A, taken along a longitudinal centerline axis of the counterclockwise gearbox assembly, according to the present disclosure.

FIG. 24C is an enlarged schematic cross-sectional view of the clockwise gearbox assembly of FIG. 24B, taken at detail 24C in FIG. 24B, according to the present disclosure.

FIG. 25 is a schematic cross-sectional view of a counterclockwise gearbox assembly, taken along a longitudinal centerline axis of the counterclockwise gearbox assembly, according to another embodiment.

FIG. 26 is a schematic cross-sectional view of a gearbox assembly, taken along a longitudinal centerline axis of the gearbox assembly, according to another embodiment.

FIG. 27 is a cross-sectional view of a planet gear of the gearbox assembly of FIG. 26 isolated from the gearbox assembly, according to the present disclosure.

FIG. 28 is a schematic view of the planet gear of FIG. 27, according to the present disclosure.

FIG. 29 is a schematic view of a gear assembly of the gearbox assembly of FIG. 26 and isolated from the gearbox assembly, according to the present disclosure.

FIG. 30 is a schematic view of the gear assembly of FIG. 29, with a portion of a ring gear removed for clarity, according to the present disclosure.

FIG. 31 is an aft schematic view of a planet carrier of the gearbox assembly of FIG. 26, according to the present disclosure.

FIG. 32 is a forward schematic view of the planet carrier of FIG. 31, according to the present disclosure.

FIG. 33 is a schematic view of a gear assembly, according to the present disclosure.

FIG. 34 is a schematic view of a gear assembly, according to another embodiment.

FIG. 35 is a schematic view of a gear assembly, according to another embodiment.

FIG. 36 is a schematic view of a gear assembly, according to another embodiment.

FIG. 37A is a forward schematic view of the gear assembly of FIG. 34, according to the present disclosure.

FIG. 37B is a forward schematic view of the gear assembly of FIG. 36, according to the present disclosure.

FIG. 38 is a chart illustrating preferred ranges for an axial envelope and a radial envelope, according to the present disclosure.

### DETAILED DESCRIPTION

Features, advantages, and aspects of the present disclosure are set forth or apparent from a consideration of the following detailed description, drawings, and claims. Moreover, the following detailed description is exemplary and intended to provide further explanation without limiting the scope of the disclosure as claimed.

Various aspects of the present disclosure are discussed in detail below. While specific aspects are discussed, this is done for illustration purposes only. A person skilled in the relevant art will recognize that other components and configurations may be used without departing from the present disclosure.

As used herein, the terms “first,” “second,” “third,” and “fourth” may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “forward” and “aft” refer to relative positions within a turbofan engine or vehicle, and refer to the normal operational attitude of the turbofan engine or vehicle. For example, with regard to a turbofan engine, forward refers to a position closer to an engine inlet and aft refers to a position closer to an engine nozzle or exhaust.

As used herein, the terms “low,” “mid” (or “mid-level”), and “high,” or their respective comparative degrees (e.g., “lower” and “higher”, where applicable), when used with compressor, combustor, turbine, shaft, fan, or turbofan engine components, each refers to relative pressures, relative speeds, relative temperatures, or relative power outputs within an engine unless otherwise specified. For example, a “low-power” setting defines the engine or the combustor configured to operate at a power output lower than a “high-power” setting of the engine or the combustor, and a “mid-level power” setting defines the engine or the combustor configured to operate at a power output higher than a “low-power” setting and lower than a “high-power” setting. The terms “low,” “mid” (or “mid-level”) or “high” in such aforementioned terms may additionally, or alternatively, be understood as relative to minimum allowable speeds, pressures, or temperatures, or minimum or maximum allowable speeds, pressures, or temperatures relative to normal, desired, steady state, etc., operation of the engine. A mission cycle for a turbofan engine includes, for example, a low-power operation, a mid-level power operation, and a high-power operation. Low-power operation includes, for example, engine start, idle, taxiing, and approach. Mid-level power operation includes, for example, cruise. High-power operation includes, for example, takeoff and climb.

The various power levels of the turbofan engine are defined as a percentage of a sea level static (SLS) maximum engine rated thrust. Low power operation includes, for example, less than thirty percent (30%) of the SLS maximum engine rated thrust of the turbofan engine. Mid-level power operation includes, for example, thirty percent (30%) to eighty-five percent (85%) of the SLS maximum engine rated thrust of the turbofan engine. High power operation includes, for example, greater than eighty-five percent (85%) of the SLS maximum engine rated thrust of the turbofan engine. The values of the thrust for each of the low power operation, the mid-level power operation, and the high power operation of the turbofan engine are exemplary only, and other values of the thrust can be used to define the low power operation, the mid-level power operation, and the high power operation.

The terms “coupled,” “fixed,” “attached,” “connected,” and the like, refer to both direct coupling, fixing, attaching, or connecting, as well as indirect coupling, fixing, attaching, or connecting through one or more intermediate components or features, unless otherwise specified herein.

The singular forms “a,” “an,” and “the” include plural references unless the context clearly dictates otherwise.

As used herein, the terms “axial” and “axially” refer to directions and orientations that extend substantially parallel to a centerline of the turbofan engine. Moreover, the terms “radial” and “radially” refer to directions and orientations that extend substantially perpendicular to the centerline of the turbofan engine. In addition, as used herein, the terms “circumferential” and “circumferentially” refer to directions and orientations that extend arcuately about the centerline of the turbofan engine.

As used herein, a “turbofan engine” includes a core flowpath defined by a compressor section, a combustion section, and a turbine section, and a fan that directs air into the core flowpath, and rated for use in a regional aircraft, a narrow body aircraft, or a wide body aircraft. A turbofan engine rated for use on a regional aircraft will have a maximum takeoff thrust in a range from ten thousand pound-force to twenty thousand pound-force (10,000 lbf to 20,000 lbf). A turbofan engine rated for use on a narrow body aircraft will have a maximum takeoff thrust in a range from fifteen thousand pound-force to thirty thousand pound-force (15,000 lbf to 30,000 lbf). A turbofan engine rated for use on a wide body aircraft will have a maximum takeoff thrust in a range from forty thousand pound-force to one hundred ten thousand pound-force (40,000 lbf to 110,000 lbf).

As used herein, the term “cruise,” “cruise conditions,” or “cruise speed” refers to operation of a turbofan engine utilized to power an aircraft that may operate at a cruising speed when the aircraft levels after climbing to a specified altitude. A turbofan engine may operate at a cruising speed that is from 50% to 90% of a rated speed, such as from 70% to 80% of the rated speed. In some aspects, a cruising speed may be achieved at about 80% of full throttle, such as from about 50% to about 90% of full throttle, such as from about 70% to about 80% full throttle. As used herein, the term “cruise flight” refers to a phase of flight in which an aircraft levels in altitude after a climb phase and prior to descending to an approach phase. In various examples, cruise flight may take place at a cruise altitude up to approximately 65,000 ft. In certain examples, cruise altitude is in a range from approximately 28,000 ft. to approximately 45,000 ft. In yet other examples, cruise altitude is expressed in flight levels (FL) based on a standard air pressure at sea level, in which cruise flight is between FL280 and FL650. In another example, cruise flight is between FL280 and FL450. In still certain examples, cruise altitude is defined based at least on a barometric pressure, in which cruise altitude is in a range from approximately 4.85 psia to approximately 0.82 psia based on a sea-level pressure of approximately 14.70 psia and sea-level temperature at approximately 59 degrees Fahrenheit. In another example, cruise altitude is in a range from approximately 4.85 psia to approximately 2.14 psia. In certain examples, the ranges of cruise altitude defined by pressure may be adjusted based on a different reference sea-level pressure and/or sea-level temperature.

As used herein, the term “ducted engine” means a turbofan engine with a fan casing or nacelle that circumferentially surrounds the fan.

As used herein, an “unducted fan engine” or an “open fan engine” means a turbofan engine without a fan casing or a nacelle surrounding the fan.

Hereafter, the term “turbofan engine” will refer to either a “ducted engine” or an “open fan engine.”

As used herein, a “fan tip diameter” is defined as a diameter of a fan blade and is measured from the longitudinal centerline axis of the turbofan engine to a fan tip of the fan blade at an axial location of the blade where the diameter is a maximum.

As used herein, a Mach number is a ratio of the speed of the aircraft to the speed of sound in the surrounding airflow. The Mach number at cruise as defined herein is a maximum operating Mach number as provided by a Type Certificate Data Sheet (TCDS) for the turbofan engine.

An aircraft's quoted cruise Mach number is generally known in the industry to be applied during a “standard day” temperature day. Therefore, the temperature is a fixed value based on altitude according to the established International Standard Atmosphere (ISA) tables. High speed civil gas turbine powered transport aircraft quote their speed by Mach number and have set cruising altitudes based on their size and mission profile (e.g., smaller aircraft fly at lower altitudes). Turboprops and smaller aircraft may have their cruising speed quoted in knots such as VTAS (velocity true airspeed) or KCAS (knots calibrated air speed), where ambient temperature is considered. Engine performance can be modeled for “hot days” or “cold days” where the ambient temperature is hotter or cooler than standard day by a prescribed amount, but this is part of off-design performance. Further, between 36,000 and 80,000 feet, where most commercial aircraft cruise, the ambient temperature is actually constant.

As used herein, a “thrust bearing radius” of a radial thrust bearing is defined in the radial direction from the longitudinal centerline axis to a radial center of the radial thrust bearing. Particularly, the radial center of the radial thrust bearing is a radial center of the rolling elements of the radial thrust bearing.

As used herein, a “fan hub axial length” is an axial length, in the axial direction (e.g., parallel with the longitudinal centerline axis 112) from a fan hub tip of the fan hub to a pitch axis P of the fan blades of the fan.

As used herein, a “fan actuation system axial length” is an axial length, in the axial direction (e.g., parallel with the longitudinal centerline axis 112), from an axially forward-most surface of the fan actuation system to the pitch axis P of the fan blades of the fan.

As used herein, a “fan bearing axial length” is an axial length, in the axial direction (e.g., parallel with the longitudinal centerline axis 112) from the pitch axis P of the fan blades of the fan to an axial center of one or more fan bearings that support rotation of the fan shaft.

The term “leading edge” refers to components and/or surfaces which are oriented predominately upstream relative to the fluid flow of the system, and the term “trailing edge” refers to components and/or surfaces which are oriented predominately downstream relative to the fluid flow of the system.

As used herein, a “rolling element diameter” of a rolling element of the fan bearing is a distance of a straight line passing from side to side through a center of the rolling element.

As used herein, a “fan hub trailing edge radius” or “R_{FHTE}” of a fan hub is defined in the radial direction from the longitudinal centerline axis to the fan hub at a trailing edge of the fan blades.

As used herein, a “fan tip radius” of a fan blade is defined in the radial direction from the longitudinal centerline axis to the fan tip at the trailing edge of the fan blade.

As used herein, a “fan hub radius ratio” is defined as a ratio of the fan hub trailing edge radius R_{FHTE} to the fan tip radius of the fan blades.

As used herein, a “fan hub leading edge radius” or “R_{FHLE}” of a fan hub is defined in the radial direction from the longitudinal centerline axis to the fan hub at a leading edge of the fan blades.

As used herein, a “fan bearing radius” or “R_{FBRG}” of a fan bearing is defined as a distance along the radial direction from the longitudinal centerline axis of the turbofan engine to a central axis or a center point of the fan bearing.

As used herein, a “fan bearing radius ratio” or “R_{FHLE}:R_{FBRG}” is a ratio of the fan hub leading edge radius R_{FHLE} to the fan bearing radius R_{FBRG}.

As used herein, “clockwise” or a “clockwise direction” is a direction of rotation when viewed from forward of the aircraft, the turbofan engine, or the gearbox assembly, that corresponds to a direction in which the hands of a clock rotate as viewed from forward of the clock.

As used herein, “counterclockwise” or a “counterclockwise direction” is a direction of rotation when viewed from forward of the aircraft, the turbofan engine, or the gearbox assembly, that corresponds to an opposite direction to that in which the hands of the clock rotate as viewed from forward of the clock. Counterclockwise is a rotation direction that is opposite clockwise.

As used herein, “gear ratio” is a ratio of a rotational speed of an input of the gearbox assembly to a rotational speed of an output of the gearbox assembly. In particular, the gear ratio is an absolute value of the rotational speed of the input to the rotational speed of the output.

As used herein, a “double gearbox assembly” is a gearbox assembly having two stages of gear assemblies. For example, the double gearbox assemblies detailed herein include a first stage gear assembly and a second stage gear assembly. The output of the first stage gear assembly is the input of the second stage gear assembly.

Here and throughout the specification and claims, range limitations are combined and interchanged. Such ranges are identified and include all the sub-ranges contained therein unless context or language indicates otherwise. For example, all ranges disclosed herein are inclusive of the endpoints, and the endpoints are independently combinable with each other.

The present disclosure provides for turbofan engines that have a variable pitch fan. Such engines include a fan actuation system that includes one or more actuators for changing a pitch of fan blades of the variable pitch fan. The fan actuation system typically includes a hydraulic system that supplies hydraulic fluid to one or more chambers to actuate the actuators. The actuators are coupled to the fan blades and actuation of the actuators causes the fan blades to rotate about a pitch axis P to change the pitch of the fan blades. Some fan actuation systems are designed for turboprop engines that include a propeller, rather than a fan.

Turboprop engines produce less thrust than turbofan engines. Turboprop engines typically provide cruise speeds for an aircraft with a Mach number that is less than 0.7 and have fewer than ten propeller blades, such as fewer than eight propeller blades or fewer than five propeller blades. Turbofan engines include ten or more fan blades that extend from a disk and provide cruise speeds for an aircraft with a Mach number that is 0.7 or greater. To achieve these higher speeds, the fan aerodynamics for the turbofan engines are different than the propeller aerodynamics for turboprop engines, resulting in the turbofan engines having more fan blades for aerodynamic efficiency at higher Mach speeds. Turbofan engines with variable pitch fan blades also benefit from guide vanes, such as outlet guide vanes behind the fan blades, and/or inlet guide vanes forward of the fan, to reduce losses at higher speeds.

The loading environment associated with the variable pitch mechanism for turboprop engines is less than the loading environment presented for a variable pitch turbofan engine. There is a lower disk loading capability requirement on parts (e.g., trunnion, bearings, gearing, actuators, etc.) and associated less actuation force resources needed (e.g., hydraulic fluid) to operate a variable pitch turboprop as compared to a variable pitch turbofan engine. At the same time, the available space, the desirable space, or the volume in that part of the engine for the higher-load-carrying fan blade pitch actuation system and the greater number of blades of a turbofan engine is not correspondingly larger than the space available for the lower-load-carrying fan blade pitch actuation system with fewer fan blades of a turboprop. Turbofan engines having variable pitch fan blades require more compactness for the pitch change system, relative to a turboprop, when considering the larger space requirements assumed if one were to simply scale-up a pitch actuation system for a turboprop for use in a turbofan engine. This can be realized when one considers that a larger, stronger structure is needed to support the more numerous blades and react the higher pitch loads associated with a turbofan engine. One cannot simply scale-up the space available for a pitch change mechanism and associated structure, and also scale up to account for the impact of a significantly increased number of blades when designing a variable pitch turbofan engine. Accommodation of the pitch change mechanism, trunnion, and associated structure for holding and articulating the fan blades within an engine housing therefore presents unique challenges for the turbofan engine in terms of the available space. The existing pitch change mechanisms and structure used to support blades in turboprop engines are not faced with similar challenges and therefore provide limited insight into how to implement a variable pitch mechanism within the more limited space, and more numerous fan blade system of a turbofan engine.

Many actuation systems for turboprop engines include a counterweight system to help pitch the propeller blades (e.g., the weight counteracts inertial loading associated with turning the propeller blade). For turbofan engines, a counterweight system may not be feasible because there is not the space available to accommodate the counterweight system. Thus, an alternative is needed to articulate the blades without exceeding load limits, which implies more compactness given the limited space available. Additionally, it was realized that pitch lock devices to lock the more-numerous fan blades in a feather position for turbofan engines, in case of fan actuation system failure, need to be considered when determining the minimum size needed for the turbofan engine fan actuation system. Additionally, it should be realized the very different types of inlets between a turboprop engine, on the one hand, and turbofan engine on the other hand, impact the amount of available space within the engine housing. Inlets to the turbofan engine (e.g., inlet to the hot gas path through the compressor section, the combustion section, and the turbine section) of a turboprop engine have a relatively narrow circumferential extent (sometimes called “chin” inlets). As such, there is more space available for a pitch change mechanism. Inlets to turbofan engines, however, have annular inlets, which take up more space within the engine housing than the more limited circumferential extent occupied by a turboprop inlet. Accommodating both a pitch change mechanism and annular inlet poses a unique challenge for a turbofan engine with variable pitch fan blades.

For at least these reasons, the loading on a pitch change mechanism and packaging of this system for a turbofan engine having greater number of blades than a turboprop engine presents challenges. It is not simply a matter of scaling-up the space available and size of component parts used in a turboprop engine fan actuation system. Indeed, it has been found that the problem is both unique to the engine type and complex—not amenable to a ready solution based on pre-existing variable pitch turboprop engine design. The inventors, seeking a need to find a solution to this problem, designed and tested several different turbofan engine architectures in an effort to arrive at a fan actuation system that met both the higher loading and more compact space requirements of a turbofan engine.

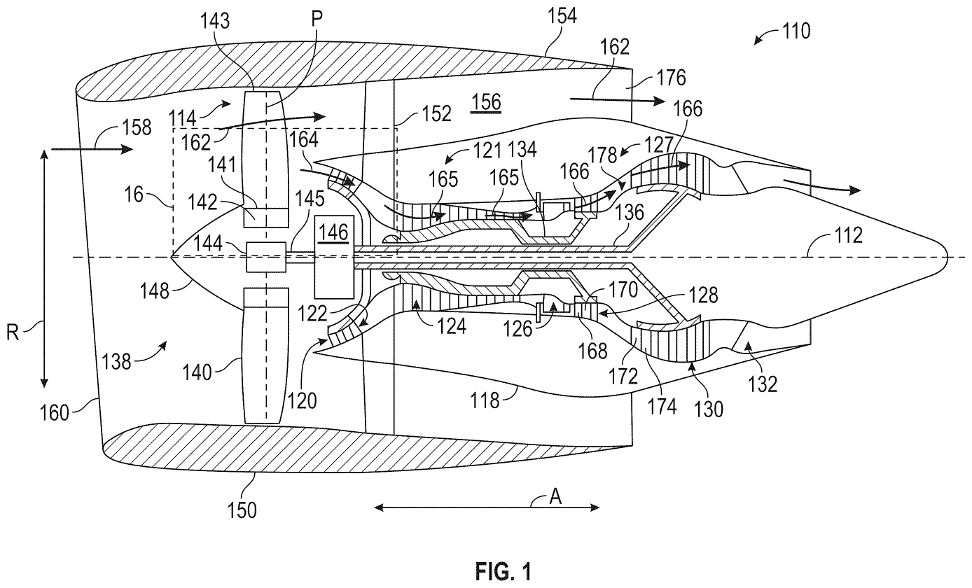

Referring now to the drawings, FIG. 1 is a schematic cross-sectional diagram of a turbofan engine 110, taken along a longitudinal centerline axis 112 of the turbofan engine 110, according to an aspect of the present disclosure. As shown in FIG. 1, the turbofan engine 110 defines an axial direction A (extending parallel to the longitudinal centerline axis 112 provided for reference) and a radial direction R that is normal to the axial direction A. In general, the turbofan engine 110 includes, in serial flow relationship, a fan assembly 114, a compressor section 121, a combustion section 126, and a turbine section 127. The compressor section 121, the combustion section 126, and the turbine section 127 are substantially enclosed within a core cowl 118 that is substantially tubular and defines a core inlet 120 having an annular shape that is annular about the longitudinal centerline axis 112. As schematically shown in FIG. 1, the compressor section 121 includes a booster or a low-pressure (LP) compressor 122 followed downstream by a high-pressure (HP) compressor 124. The combustion section 126 is downstream of the compressor section 121 and includes a combustor. The turbine section 127 is downstream of the combustion section 126 and includes a high-pressure (HP) turbine 128 followed downstream by a low-pressure (LP) turbine 130, also referred to as a power turbine. The turbofan engine 110 also includes a core exhaust nozzle 132 that is downstream of the turbine section 127. The turbofan engine 110 further includes a high-pressure (HP) shaft 134, also referred to as a high-speed shaft, that drivingly connects the HP turbine 128 to the HP compressor 124. The HP turbine 128 and the HP compressor 124 rotate in unison through the HP shaft 134. The turbofan engine 110 includes a low-pressure (LP) shaft 136, also referred to as a low-speed shaft, that drivingly connects the LP turbine 130 to the LP compressor 122. The LP turbine 130 and the LP compressor 122 rotate in unison through the LP shaft 136. The compressor section 121, the combustion section 126, the turbine section 127, and the core exhaust nozzle 132 together define a core air flow path.

In FIG. 1, the fan assembly 114 includes a fan 138 (e.g., a variable pitch fan) having a plurality of fan blades 140 coupled to a fan disk 142 in a spaced apart manner. As depicted in FIG. 1, the fan blades 140 extend outwardly from the fan disk 142 generally along the radial direction R from a fan root 141 to a fan tip 143. Each fan blade 140 is rotatable relative to the fan disk 142 about a pitch axis P by virtue of the fan blades 140 being operatively coupled to a fan actuation system 144 configured to collectively vary the pitch of the fan blades 140 in unison, as detailed further below. The fan actuation system 144 is disposed within a fan hub 148. The fan blades 140, the fan disk 142, and the fan actuation system 144 are together rotatable about the longitudinal centerline axis 112 via a fan shaft 145 that is powered by the LP shaft 136 across a power gearbox, also referred to as a gearbox assembly 146.

The gearbox assembly 146 is shown schematically in FIG. 1. The gearbox assembly 146 includes a plurality of gears for adjusting the rotational speed of the fan shaft 145 and, thus, the fan 138 relative to the LP shaft 136. The gearbox assembly 146 has a gear ratio in a range from 3.5:1 to 5:1 for a ducted engine (e.g., the turbofan engine 110). The LP shaft 136, the gearbox assembly 146, and the fan shaft 145 are disposed in an in-line configuration such that the LP shaft 136, the gearbox assembly 146, and the fan shaft 145 are coaxial and are each disposed about the longitudinal centerline axis 112. The in-line configuration helps to reduce the space needed within the turbofan engine 110 for the gearbox assembly 146 and allows a greater amount of torque to be transferred from the LP shaft 136 to the fan shaft 145 through the gearbox assembly 146 as compared to turboprop engines in which the gearbox assembly is typically disposed in a stepped configuration and is not coaxial with the LP shaft and the fan shaft.

The fan disk 142 is covered by a fan hub 148 that rotates and is aerodynamically contoured to promote an airflow through the plurality of fan blades 140. In addition, the fan assembly 114 includes an annular fan casing or a nacelle 150 that circumferentially surrounds the fan 138 and at least a portion of the core cowl 118. In this way, the turbofan engine 110 is a ducted engine. The nacelle 150 is supported relative to the core cowl 118 by a plurality of fan guide vanes 152, also referred to as outlet guide vanes, that is spaced circumferentially about the nacelle 150. Moreover, a downstream section 154 of the nacelle 150 extends over an outer portion of the core cowl 118 to define a bypass airflow passage 156 therebetween.

During operation of the turbofan engine 110, a volume of air 158 enters the turbofan engine 110 through an inlet 160 of the nacelle 150 or the fan assembly 114. As the volume of air 158 passes across the fan blades 140, a first portion of air, referred to as bypass air 162, is directed or routed into the bypass airflow passage 156, and a second portion of air, referred to as core air 164, is directed or is routed into the upstream section of the core air flow path, or, more specifically, into the core inlet 120 of the LP compressor 122. The ratio between the bypass air 162 and the core air 164 is commonly known as a bypass ratio. The pressure of the core air 164 is then increased by the LP compressor 122 to form compressed air 165, and the compressed air 165 is routed through the HP compressor 124 and into the combustion section 126, where the compressed air 165 is mixed with fuel and burned to generate combustion gases 166.

The combustion gases 166 are routed into the HP turbine 128 and expanded through the HP turbine 128 where a portion of thermal energy and kinetic energy from the combustion gases 166 is extracted via one or more stages of HP turbine stator vanes 168 that are coupled to the core cowl 118 and HP turbine rotor blades 170 that are coupled to the HP shaft 134. This causes the HP shaft 134 to rotate, thereby supporting operation of the HP compressor 124 (e.g., a self-sustaining cycle). In this way, the combustion gases 166 do work in the HP turbine 128 to cause the HP turbine rotor blades 170 (and the HP shaft 134) to rotate at a sufficient rate to maintain the compression ratio of the HP compressor 124 (e.g., self-sustaining cycle). The combustion gases 166 are then routed into the LP turbine 130 and expanded through the LP turbine 130. Here, a second portion of the thermal energy and the kinetic energy is extracted from the combustion gases 166 via one or more stages of LP turbine stator vanes 172 that are coupled to the core cowl 118 and LP turbine blades 174 that are coupled to the LP shaft 136. This causes the LP shaft 136 to rotate, thereby supporting operation of the LP compressor 122 and rotation of the fan 138 via the gearbox assembly 146 (e.g., a self-sustaining cycle). In this way, the combustion gases 166 do work in the LP turbine 130 to cause the LP turbine blades 174 (and the LP shaft 136) to rotate.

The combustion gases 166 are subsequently routed through the core exhaust nozzle 132 to provide propulsive thrust at a thrust level of the turbofan engine 110. The thrust level of the turbofan engine 110 includes a cruise thrust level defined by a cruise Mach number M_{cruise} that is the Mach number of the turbofan engine 110 at cruise conditions, or mid-level power conditions. Simultaneously, the bypass air 162 is directed through the bypass airflow passage 156 before being exhausted from a fan exhaust nozzle 176 of the turbofan engine 110, also providing propulsive thrust. The HP turbine 128, the LP turbine 130, and the core exhaust nozzle 132 at least partially define a hot gas path 178 for routing the combustion gases 166 through the turbofan engine 110.

The turbofan engine 110 depicted in FIG. 1 is by way of example only. In other aspects, the turbofan engine 110 may have other suitable configurations. In other aspects, any other suitable number or configuration of compressors, turbines, shafts, or a combination thereof may be provided. The turbofan engine 110 may also be a direct drive engine, which does not have a power gearbox. The fan speed is the same as the LP shaft speed for a direct drive engine. In still other aspects, aspects of the present disclosure may be incorporated into other suitable turbofan engines, such as, for example, propfan (e.g., unducted fan) engines.

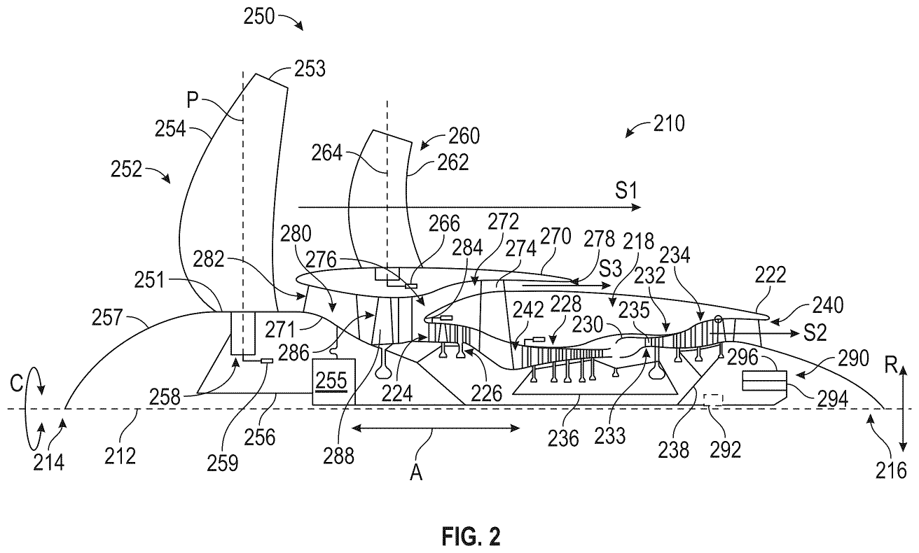

FIG. 2 shows a schematic view of an unducted, three-stream, turbofan engine 210 for an aircraft, that may incorporate one or more aspects of the present disclosure. In this way, the turbofan engine 210 is an unducted fan engine or an open fan engine. The turbofan engine 210 is a “three-stream engine” in that its architecture provides three distinct streams (labeled S1, S2, and S3) of thrust-producing airflow during operation, as detailed further below.

As shown in FIG. 2, the turbofan engine 210 defines an axial direction A, a radial direction R, and a circumferential direction C. Moreover, the turbofan engine 210 defines a longitudinal centerline axis 212 that extends along the axial direction A. In general, the axial direction A extends parallel to the longitudinal centerline axis 212, the radial direction R extends outward from, and inward to, the longitudinal centerline axis 212 in a direction orthogonal to the axial direction A, and the circumferential direction C extends three hundred sixty degrees (360°) around the longitudinal centerline axis 212. The turbofan engine 210 extends between a forward end 214 and an aft end 216, e.g., along the axial direction A.

The turbofan engine 210 includes a fan assembly 250, a compressor section, a combustion section, a turbine section, and an exhaust section. Particularly, as shown in FIG. 2, the turbofan engine 210 includes an engine core 218 and a core cowl 222 that annularly surrounds the compressor section, the combustion section, and the turbine section. The core cowl 222 define a core inlet 224 having an annular shape that is annular about the longitudinal centerline axis 212. The core cowl 222 further encloses and supports a low-pressure (LP) compressor 226 (also referred to as a booster) for pressurizing the air that enters the turbofan engine 210 through the core inlet 224. A high-pressure (HP) compressor 228 receives pressurized air from the LP compressor 226 and further increases the pressure of the air. The pressurized air flows downstream to a combustor 230 where fuel is injected into the pressurized air and ignited to raise the temperature and the energy level of the pressurized air, thereby generating combustion gases.

The combustion gases flow from the combustor 230 downstream to a high-pressure (HP) turbine 232. The HP turbine 232 drives the HP compressor 228 through a first shaft, also referred to as a high-pressure (HP) shaft 236 (also referred to as a “high-speed shaft”). In this regard, the HP turbine 232 is drivingly coupled with the HP compressor 228. Together, the HP compressor 228, the combustor 230, and the HP turbine 232 define the engine core 218. The combustion gases then flow to a power turbine or a low-pressure (LP) turbine 234. The LP turbine 234 drives the LP compressor 226 and components of the fan assembly 250 through a second shaft, also referred to as a low-pressure (LP) shaft 238 (also referred to as a “low-speed shaft”). In this regard, the LP turbine 234 is drivingly coupled with the LP compressor 226 and components of the fan assembly 250. The LP shaft 238 is coaxial with the HP shaft 236 in FIG. 2. After driving each of the HP turbine 232 and the LP turbine 234, the combustion gases exit the turbofan engine 210 through a core exhaust nozzle 240. The turbofan engine 210 defines a core flowpath, also referred to as a core duct 242, that extends between the core inlet 224 and the core exhaust nozzle 240. The core duct 242 is an annular duct positioned generally inward of the core cowl 222 along the radial direction R.

The fan assembly 250 includes a fan 252, also referred to as a primary fan. In FIG. 2, the fan 252 is an open rotor fan, also referred to as an unducted fan. However, in other aspects, the fan 252 may be ducted, e.g., by a fan casing or a nacelle circumferentially surrounding the fan 252, similar to the aspect of FIG. 1. The fan 252 includes a plurality of fan blades 254 (only one shown in FIG. 2) that extends in the radial direction R from a fan root 251 to a fan tip 253. The plurality of fan blades 254 is rotatable about the longitudinal centerline axis 212 via a fan shaft 256. As shown in FIG. 2, the fan shaft 256 is coupled with the LP shaft 238 via a speed reduction gearbox or a power gearbox, also referred to as a gearbox assembly 255, e.g., in an indirect-drive configuration.

The gearbox assembly 255 is shown schematically in FIG. 2. The gearbox assembly 255 includes a plurality of gears for adjusting the rotational speed of the fan shaft 256 and, thus, the fan 252 relative to the LP shaft 238 to a more efficient rotational fan speed. The gearbox assembly may have a gear ratio of 4:1 to 14:1, or 6:1 to 14:1, or 4:1 to 12:1, or 7:1 to 12:1, or 4:1 to 10:1, or 5:1 to 9:1, or 6:1 to 9:1, and may be configured in an epicyclic star or a planet gear configuration. Preferably, the gearbox assembly has a gear ratio of 4:1 to 10:1 or 6:1 to 14:1 for an unducted fan engine (e.g., the turbofan engine 210). The gearbox may be a single stage gearbox or a compound gearbox (e.g., having a plurality of stages). The LP shaft 238, the gearbox assembly 255, and the fan shaft 256 are disposed in an in-line configuration such that the LP shaft 238, the gearbox assembly 255, and the fan shaft 256 are coaxial and are each disposed about the longitudinal centerline axis 212.

The fan blades 254 can be arranged in equal spacing around the longitudinal centerline axis 212. Each fan blade 254 extends outwardly from a disk (not shown in FIG. 2) generally along the radial direction R. The disk is covered by a fan hub 257 that is rotatable and aerodynamically contoured to promote an airflow through the plurality of fan blades 254. Each fan blade 254 has a root and a tip, and a span defined therebetween. Each of the plurality of fan blades 254 defines a pitch axis P. In FIG. 2, each of the plurality of fan blades 254 of the fan 252 is rotatable about their respective pitch axis P, e.g., in unison with one another. A fan actuation system (FAS) 258 controls one or more actuators 259 to pitch the fan blades 254 about their respective pitch axis P. The FAS 258 is disposed within the fan hub 257.

The fan assembly 250 further includes a fan guide vane array 260 that includes a plurality of fan guide vanes 262 (only one shown in FIG. 2) disposed around the longitudinal centerline axis 212. In FIG. 2, the plurality of fan guide vanes 262 is not rotatable about the longitudinal centerline axis 212. Each of the plurality of fan guide vanes 262 has a root and a tip, and a span defined therebetween. The plurality of fan guide vanes 262 can be unshrouded as shown in FIG. 2 or can be shrouded, e.g., by an annular shroud spaced outward from the tips of the fan guide vanes 262 along the radial direction R. Each of the plurality of fan guide vanes 262 defines a vane pitch axis 264. In FIG. 2, each of the plurality of fan guide vanes 262 of the fan guide vane array 260 is rotatable about their respective vane pitch axis 264, e.g., in unison with one another. One or more actuators 266 are controlled to pitch the plurality of fan guide vanes 262 about their respective vane pitch axis 264. In other aspects, each of the plurality of fan guide vanes 262 is fixed or is unable to be pitched about the vane pitch axis 264. The plurality of fan guide vanes 262 is mounted to a fan cowl 270. The fan cowl 270 includes a fan frame 271 that supports the fan assembly 250.

The fan cowl 270 annularly encases at least a portion of the core cowl 222 and is generally positioned outward of the core cowl 222 along the radial direction R. Particularly, a downstream section of the fan cowl 270 extends over a forward portion of the core cowl 222 to define a fan flowpath, also referred to as a fan duct 272. Incoming air enters through the fan duct 272 through a fan duct inlet 276 and exits through a fan exhaust nozzle 278 to produce propulsive thrust. The fan duct 272 is an annular duct positioned generally outward of the core duct 242 along the radial direction R. The fan cowl 270 and the core cowl 222 are connected together and supported by a plurality of struts 274 (only one shown in FIG. 2) that extends substantially radially and are circumferentially spaced about the longitudinal centerline axis 212. The plurality of struts 274 is each aerodynamically contoured to direct air flowing thereby. Other struts, in addition to the plurality of struts 274, can be used to connect and to support the fan cowl 270 and the core cowl 222.

The turbofan engine 210 also defines or includes an inlet duct 280. The inlet duct 280 extends between an engine inlet 282 and the core inlet 224 and the fan duct inlet 276. The engine inlet 282 is defined generally at the forward end of the fan cowl 270 and is positioned between the fan 252 and the fan guide vane array 260 along the axial direction A. The inlet duct 280 is an annular duct that is positioned inward of the fan cowl 270 along the radial direction R. Air flowing downstream along the inlet duct 280 is split, not necessarily evenly, into the core duct 242 and the fan duct 272 by a splitter 284 of the core cowl 222. The inlet duct 280 is wider than the core duct 242 along the radial direction R. The inlet duct 280 is also wider than the fan duct 272 along the radial direction R.

The fan assembly 250 also includes a mid-fan 286. The mid-fan 286 includes a plurality of mid-fan blades 288 (only one shown in FIG. 2). The plurality of mid-fan blades 288 is rotatable, e.g., about the longitudinal centerline axis 212. The mid-fan 286 is drivingly coupled with the LP turbine 234 via the LP shaft 238. The plurality of mid-fan blades 288 can be arranged in equal circumferential spacing about the longitudinal centerline axis 212. The plurality of mid-fan blades 288 is annularly surrounded (e.g., ducted) by the fan cowl 270. In this regard, the mid-fan 286 is positioned inward of the fan cowl 270 along the radial direction R. The mid-fan 286 is positioned within the inlet duct 280 upstream of both the core duct 242 and the fan duct 272. A ratio of a span of a fan blade 254 to that of a mid-fan blade 288 (a span is measured from a root to tip of the respective blade) is greater than 2 and less than 10, to achieve the desired benefits of the third stream (S3), particularly, the additional thrust it offers to the engine, which can enable a smaller diameter fan blade 254 (benefits engine installation).

Accordingly, air flowing through the inlet duct 280 flows across the plurality of mid-fan blades 288 and is accelerated downstream thereof. At least a portion of the air accelerated by the mid-fan blades 288 flows into the fan duct 272 and is ultimately exhausted through the fan exhaust nozzle 278 to produce propulsive thrust. Also, at least a portion of the air accelerated by the plurality of mid-fan blades 288 flows into the core duct 242 and is ultimately exhausted through the core exhaust nozzle 240 to produce propulsive thrust. Generally, the mid-fan 286 is a compression device positioned downstream of the engine inlet 282. The mid-fan 286 is operable to accelerate air into the fan duct 272, also referred to as a secondary bypass passage.

During operation of the turbofan engine 210, an initial airflow or an incoming airflow passes through the fan blades 254 of the fan 252 and splits into a first airflow and a second airflow. The first airflow bypasses the engine inlet 282 and flows generally along the axial direction A outward of the fan cowl 270 along the radial direction R. The first airflow accelerated by the fan blades 254 passes through the fan guide vanes 262 and continues downstream thereafter to produce a primary propulsion stream or a first thrust stream S1. A majority of the net thrust produced by the turbofan engine 210 is produced by the first thrust stream S1. The second airflow enters the inlet duct 280 through the engine inlet 282.

The second airflow flowing downstream through the inlet duct 280 flows through the plurality of mid-fan blades 288 of the mid-fan 286 and is consequently compressed. The second airflow flowing downstream of the mid-fan blades 288 is split by the splitter 284 located at the forward end of the core cowl 222. Particularly, a portion of the second airflow flowing downstream of the mid-fan 286 flows into the core duct 242 through the core inlet 224. The portion of the second airflow that flows into the core duct 242 is progressively compressed by the LP compressor 226 and the HP compressor 228 and is ultimately discharged into the combustion section. The discharged pressurized air stream flows downstream to the combustor 230 where fuel is introduced to generate combustion gases or products.

The combustor 230 defines an annular combustion chamber that is generally coaxial with the longitudinal centerline axis 212. The combustor 230 receives pressurized air from the HP compressor 228 via a pressure compressor discharge outlet. A portion of the pressurized air flows into a mixer. Fuel is injected by a fuel nozzle (omitted for clarity) to mix with the pressurized air thereby forming a fuel-air mixture that is provided to the combustion chamber for combustion. Ignition of the fuel-air mixture is accomplished by one or more igniters (omitted for clarity), and the resulting combustion gases flow along the axial direction A toward, and into, a first stage turbine nozzle 233 of the HP turbine 232. The first stage turbine nozzle 233 is defined by an annular flow channel that includes a plurality of radially extending, circumferentially spaced nozzle vanes 235 that turn the combustion gases so that the combustion gases flow angularly and impinge upon first stage turbine blades of the HP turbine 232. The combustion gases exit the HP turbine 232 and flow through the LP turbine 234 and exit the core duct 242 through the core exhaust nozzle 240 to produce a core air stream, also referred to as a second thrust stream S2. As noted above, the HP turbine 232 drives the HP compressor 228 via the HP shaft 236, and the LP turbine 234 drives the LP compressor 226, the fan 252, and the mid-fan 286 via the LP shaft 238.

The other portion of the second airflow flowing downstream of the mid-fan 286 is split by the splitter 284 into the fan duct 272. The air enters the fan duct 272 through the fan duct inlet 276. The air flows generally along the axial direction A through the fan duct 272 and is ultimately exhausted from the fan duct 272 through the fan exhaust nozzle 278 to produce a third stream, also referred to as a third thrust stream S3.

The third thrust stream S3 is a secondary air stream that increases fluid energy to produce a minority of total propulsion system thrust. In some aspects, a pressure ratio of the third stream is higher than that of the primary propulsion stream (e.g., a bypass or a propeller driven propulsion stream). The thrust may be produced through a dedicated nozzle or through mixing of the secondary air stream with the primary propulsion stream or a core air stream, e.g., into a common nozzle. In certain aspects, an operating temperature of the secondary air stream is less than a maximum compressor discharge temperature for the engine. Furthermore, aspects of the third stream (e.g., airstream properties, mixing properties, or exhaust properties), and thereby a percent contribution to total thrust, are passively adjusted during engine operation or can be modified purposefully through the use of engine control features (such as fuel flow, electric machine power, variable stators, variable inlet guide vanes, valves, variable exhaust geometry, or fluidic features) to adjust or to improve overall system performance across a broad range of potential operating conditions.

The turbofan engine 210 depicted in FIG. 2 is by way of example only. In other aspects, the turbofan engine 210 may have other suitable configurations. For example, the fan 252 can be ducted by a fan casing or a nacelle such that a bypass passage is defined between the fan casing and the fan cowl 270. Moreover, in other aspects, any other suitable number or configuration of compressors, turbines, shafts, or a combination thereof may be provided. Further, aspects of the present disclosure may be incorporated into any other suitable turbofan engine, such as, for example, turbofan engines defining two streams (e.g., a bypass stream and a core air stream).

Further, in FIG. 2, the turbofan engine 210 includes an electric machine 290 (e.g., a motor-generator) operably coupled with a rotating component thereof. In this regard, the turbofan engine 210 is a hybrid-electric propulsion machine. Particularly, as shown in FIG. 2, the electric machine 290 is operatively coupled with the LP shaft 238. The electric machine 290 can be mechanically connected to the LP shaft 238, either directly, or indirectly, e.g., by way of a gearbox assembly 292 (shown schematically in FIG. 2). Further, although the electric machine 290 is operatively coupled with the LP shaft 238 at an aft end of the LP shaft 238, the electric machine 290 can be coupled with the LP shaft 238 at any suitable location or can be coupled to other rotating components of the turbofan engine 210, such as the HP shaft 236 or the LP shaft 238. For instance, in some aspects, the electric machine 290 can be coupled with the LP shaft 238 and positioned forward of the mid-fan 286 along the axial direction A. In some aspects, the turbofan engine of FIG. 1 also includes an electric machine coupled to the LP shaft and located in the tail cone of the engine.

In some aspects, the electric machine 290 can be an electric motor operable to drive or to motor the LP shaft 238. In other aspects, the electric machine 290 can be an electric generator operable to convert mechanical energy into electrical energy. In this way, electrical power generated by the electric machine 290 can be directed to various engine systems or aircraft systems. In some aspects, the electric machine 290 can be a motor/generator with dual functionality. The electric machine 290 includes a rotor 294 and a stator 296. The rotor 294 is coupled to the LP shaft 238 and rotates with rotation of the LP shaft 238. In this way, the rotor 294 rotates with respect to the stator 296, thereby generating electrical power. Although the electric machine 290 has been described and illustrated in FIG. 2 as having a particular configuration, the present disclosure may apply to electric machines having alternative configurations. For instance, the rotor 294 or the stator 296 may have different configurations or may be arranged in a different manner than illustrated in FIG. 2.

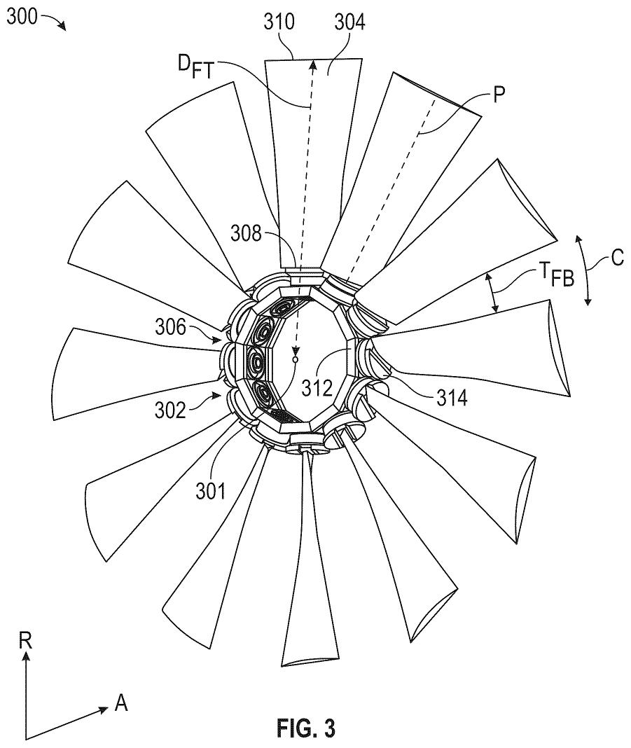

FIG. 3 shows a fan 300 having a fan actuation system 302, according to the present disclosure. The fan 300 can be utilized as the fan 138 of FIG. 1 or as the fan 252 of FIG. 2. The fan 300 includes a plurality of fan blades 304 that is coupled to a disk 306 and is spaced circumferentially about a longitudinal centerline axis 301 of the fan 300. The fan 300 includes a number of fan blades, and, in particular, includes ten to eighteen fan blades 304. In FIG. 3, the fan 300 includes twelve fan blades 304. Each fan blade 304 extends in the radial direction R along a span of the fan blade 304 and from a fan root 308 to a fan tip 310. Each fan blade 304 has a fan tip diameter D_{FT} that extends from the longitudinal centerline axis 301 to the fan tip 310 of each fan blade 304. While the fan tip diameter D_{FT} is detailed with respect to the plurality of fan blades 304, the fan tip diameter D_{FT} is a measurement of any of the fan blades detailed herein. The fan tip diameter D_{FT} is in a range from seven feet to fourteen feet (7 ft. to 14 ft.), as detailed further below. A tangential fan blade distance T_{FB} is defined in the circumferential direction C as a circumferential distance or a tangential distance between adjacent fan blades 304. As used herein, adjacent means two fan blades with no intervening fan blade therebetween.

The disk 306 includes a plurality of disk segments 312 that is rigidly coupled together or integrally molded together in a generally annular shape. One fan blade 304 is coupled to each disk segment 312 at a trunnion mechanism 314 of the fan actuation system 302. The trunnion mechanism 314 facilitates retaining the respective fan blade 304 on the disk 306 during rotation of the disk 306, while still rendering the respective fan blade 304 rotatable relative to the disk 306 about a pitch axis P of the fan blade 304. For example, the trunnion mechanism 314 provides a load path to the disk 306 for the centrifugal load generated by the fan blade 304 during rotation of the fan blade 304 about the longitudinal centerline axis 301. The trunnion mechanism 314 includes a plurality of bearings disposed within the disk segment 312 that allows the fan blade 304 to rotate about the pitch axis P.

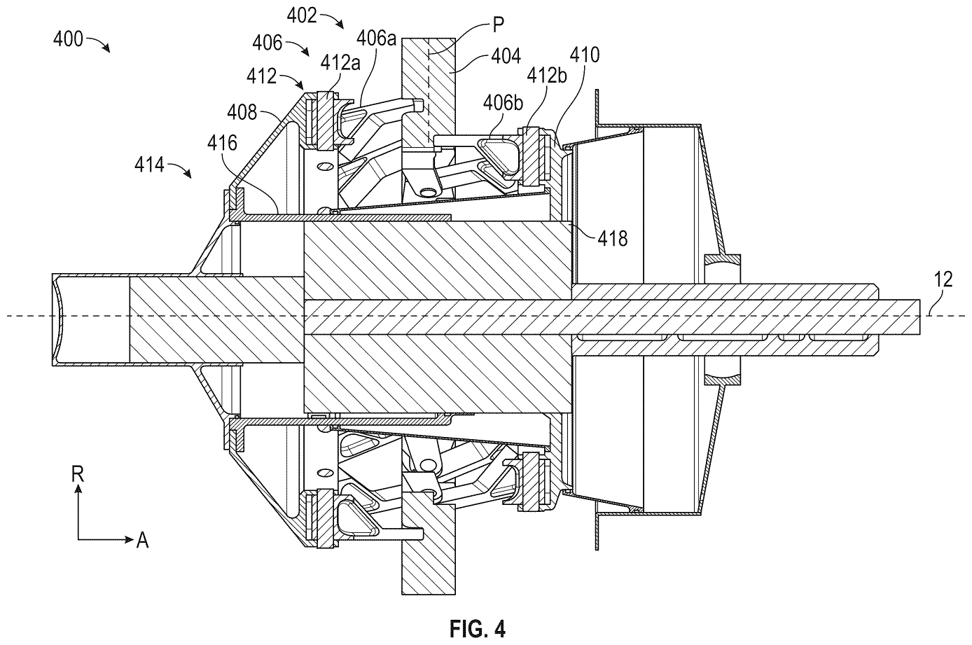

FIG. 4 is a schematic cross-sectional diagram of a fan actuation system 400 for a turbofan engine, taken along a longitudinal centerline axis 112 of the turbofan engine, according to the present disclosure. The fan actuation system 400 can be utilized for any of the fans detailed herein. The fan actuation system 400 includes a trunnion mechanism 402 and one or more actuators 414. The trunnion mechanism 402 includes a plurality of trunnions 404. Each fan blade of the fan is coupled to a respective trunnion 404. Each of the plurality of trunnions 404 is rotatable about a pitch axis P to pitch the fan blades of the fan. The trunnion mechanism 402 includes a plurality of trunnion links 406 that is coupled to the plurality of trunnions 404. For example, a respective trunnion link 406 is coupled to a respective trunnion 404. The plurality of trunnion links 406 includes a plurality of forward trunnion links 406a and a plurality of aft trunnion links 406b that are coupled to the plurality of trunnions 404. The plurality of forward trunnion links 406a is pivotably coupled to the plurality of trunnions 404.

The trunnion mechanism 402 includes a plurality of unison rings 408, 410 including a forward unison ring 408 positioned forward of the plurality of trunnions 404 and an aft unison ring 410 positioned aft of the plurality of trunnions 404. The forward unison ring 408 and the aft unison ring 410 couple the plurality of trunnions 404 together. The plurality of trunnion links 406 is coupled to the forward unison ring 408 or the aft unison ring 410 via a plurality of pins 412. The plurality of forward trunnion links 406a is pivotably coupled to the forward unison ring 408 by a plurality of forward pins 412a such that the plurality of trunnions 404 is coupled to the forward unison ring 408. For example, each forward trunnion link 406a extends forward from a respective trunnion 404 to the forward unison ring 408 and a respective forward pin 412a is disposed through the forward trunnion link 406a at the forward unison ring 408 to pivotably couple the forward trunnion link 406a to the forward unison ring 408. Each aft trunnion link 406b extends aftward from the respective trunnion 404 to the aft unison ring 410 and a respective aft pin 412b is disposed through the aft trunnion link 406b at the aft unison ring 410 to pivotably couple the aft trunnion link 406b to the aft unison ring 410. In this way, each of the plurality of trunnions 404 is pivotably coupled to the forward unison ring 408 and to the aft unison ring 410 such that the plurality of trunnions 404 can pivot about the pitch axis P in unison.

The one or more actuators 414 include a hydraulic cylinder 416 and a piston 418 disposed within the hydraulic cylinder 416. The hydraulic cylinder 416 and the piston 418 are movable along the axial direction A. In this way, the one or more actuators 414 are hydraulic linear actuators such that the hydraulic cylinder 416 and the piston 418 move linearly along the axial direction A (e.g., in opposite directions along the longitudinal centerline axis 112). The forward unison ring 408 is coupled to the hydraulic cylinder 416 such that the forward unison ring 408 moves when the hydraulic cylinder 416 moves. The aft unison ring 410 is coupled to the piston 418 such that aft unison ring 410 moves when the piston 418 moves.

In operation, the fan actuation system 400 moves the plurality of fan blades 140 (FIG. 1) between a first end position and a second end position. The first end position, referred to herein as a feather position, corresponds to a position in which the plurality of fan blades 140 produces the least (e.g., minimal) amount of resistance or drag. In some examples, this position corresponds to a position in which the plurality of fan blades 140 is aligned or substantially aligned (e.g., ±5°) with the flow of the volume of air (e.g., the volume of air 158 of FIG. 1). The second end position is a reverse position in which the plurality of fan blades 140 exceeds, for example, a plane that is transverse to the longitudinal centerline axis 112 (the direction of forward movement of the aircraft) by a certain degree (e.g., 30°) so as to assist with the braking of the aircraft. Therefore, in some examples, the angular stroke of the plurality of fan blades 140 between the feather position and the reverse position is, for example, approximately 120°. The plurality of fan blades 140 can be moved to any position or any angle between the feather position and the reverse position depending on the phase of flight to improve (e.g., optimize) efficiency of the turbofan engine 110 (FIG. 1). In some examples, one or more stops or limits are provided to prevent the plurality of fan blades 140 from being rotated beyond the two end positions. In other examples, the fan actuation system 400 can be configured to provide a greater stroke or a lesser stroke and/or the end positions may be different.

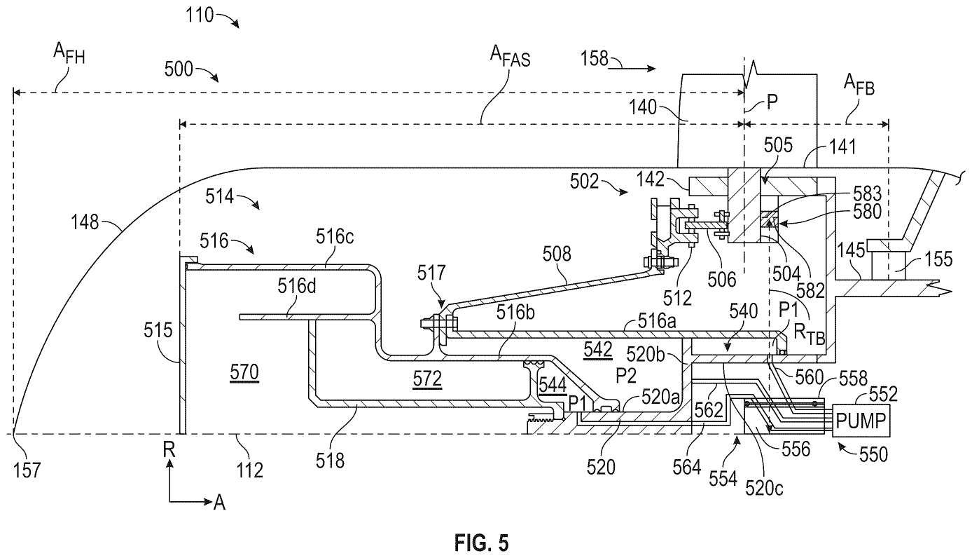

A hydraulic system supplies a hydraulic fluid (e.g., oil) to one or more hydraulic chambers of the one or more actuators 414 to move the hydraulic cylinder 416 and the piston 418 to pitch the plurality of fan blades 140. An exemplary hydraulic system and hydraulic chambers are detailed below with respect to FIG. 5. The plurality of trunnions 404 is disposed in FIG. 4 such that the plurality of fan blades 140 is in the first end position (e.g., the feather position). The pressure of the hydraulic fluid in the one or more hydraulic chambers can be increased to move the hydraulic cylinder 416 in a first direction and to move the piston 418 in a second direction such that the plurality of trunnions 404 move the plurality of fan blades 140 from the feather position towards the reverse position (e.g., the second end position). For example, the hydraulic cylinder 416 can move axially aftward (e.g., to the right in FIG. 4) and the piston 418 can move axially forward (e.g., to the left in FIG. 4) when the pressure of the hydraulic fluid is increased. To move the plurality of fan blades 140 from the reverse position to the feather position, the pressure of the hydraulic fluid in the one or more hydraulic chambers can be decreased to move the hydraulic cylinder 416 in the second direction (e.g., axially forward) and to move the piston 418 in the first direction (e.g., axially aftward).

As the hydraulic cylinder 416 moves axially along the axial direction A, the hydraulic cylinder 416 causes the forward unison ring 408 to move, thereby causing the plurality of forward trunnion links 406a to pivot and to pitch the plurality of trunnions 404, and, therefore, pitching the plurality of fan blades 140 about the pitch axis P. At the same time, movement of the piston 418 along the axial direction A causes the aft unison ring 410 to move, thereby, causing the plurality of aft trunnion links 406b to pivot in an opposite direction as the forward trunnion links 406a, and, therefore, pitching the plurality of fan blades 140 about the pitch axis P. In this way, the fan actuation system 400 translates linear motion of the one or more actuators 414 (e.g., along the axial direction A) into rotational motion of the plurality of fan blades 140. Such a configuration enables a compact and lightweight design of the fan actuation system 400. Further, each of the hydraulic cylinder 416 and the piston 418 provides only half of the force needed to actuate the plurality of trunnions 404 and provides a redundant path in the event that one of the hydraulic cylinder 416 or the piston 418 fails.

FIG. 5 is a schematic cross-sectional view of a fan actuation system 500 for a turbofan engine, according to another aspect. The fan actuation system 500 is shown as being utilized in the turbofan engine 110 but can be utilized in the turbofan engine 210. Only the top half of the fan actuation system 500 is shown in FIG. 5. However, the fan actuation system 500 is symmetrical about the longitudinal centerline axis 112. The fan actuation system 500 may also be referred to as a fan pitch actuation system (FPAS). The fan actuation system 500 controls the pitch (e.g., angle, orientation) of the plurality of fan blades 140 about the pitch axis P. In some examples, the fan actuation system 500 can move the fan blades 140 between a first end position and a second end position.

FIG. 5 shows the fan shaft 145 of the turbofan engine 110 (FIG. 1). The fan shaft 145 is coupled to, and driven by, the LP shaft 136 (FIG. 1). One or more fan bearings 155 support rotation of the fan shaft 145. The one or more fan bearings 155 can include roller bearings, tapered roller bearings, ball bearings, or the like. The one or more fan bearings 155 are disposed aft of the fan disk 142. As shown in FIG. 5, the fan disk 142 is coupled to (e.g., directly or indirectly), and driven by, the fan shaft 145. Each of the plurality of fan blades 140 is coupled to, and extends radially outward from, the fan disk 142. Therefore, as the fan shaft 145 is rotated (via the LP shaft 136), the fan shaft 145 rotates the fan disk 142, which rotates the plurality of fan blades 140 to generate thrust. The fan hub 148 (shown schematically in FIG. 5) includes a fan hub tip 157 that defines an axially forward-most point of the fan hub 148.

The fan actuation system 500 includes a trunnion mechanism 502 including a plurality of trunnions 504. Each fan blade 140 is coupled to a respective one of the plurality of trunnions 504. The plurality of trunnions 504 extends through an opening 505 in the fan disk 142. The plurality of trunnions 504 is rotatable in the opening 505. This enables the plurality of fan blades 140 to rotate about the pitch axis P. As such, the pitch of the plurality of fan blades 140 can be changed relative to the flow of the volume of air 158. In particular, the plurality of fan blades 140 can be rotated (e.g., pitched) to any position between the first end position (e.g., the feather position) and the second end position (e.g., the reverse position). In FIG. 5, the plurality of fan blades 140 is shown in the feather position. In the feather position, the plurality of fan blades 140 is substantially aligned with the flow of the volume of air 158, which reduces resistance or drag. The plurality of fan blades 140 is typically held in the feather position when the turbofan engine 110 (FIG. 1) is not operating.

The fan actuation system 500 includes a plurality of trunnion links 506 and a unison ring 508. The plurality of trunnion links 506 is pivotably coupled to the plurality of trunnions 504. For example, each trunnion link 506 is coupled to a respective trunnion 504 and to the unison ring 508. In this way, the unison ring 508 couples the plurality of trunnions 504 together. The plurality of trunnion links 506 is coupled to the unison ring 508 via a plurality of pins 512. In this way, the plurality of trunnions 504 is pivotably coupled to the unison ring 508 such that the plurality of trunnions 504, and, thus, the plurality of fan blades 140, can pivot about the pitch axis P in unison, as detailed further below.

The fan actuation system 500 includes one or more actuators 514 that include a hydraulic cylinder 516, a piston 518, and a piston retainer 520. The piston retainer 520 is coupled (e.g., bolted) to the fan shaft 145 such that the piston retainer 520 rotates with the fan shaft 145. Therefore, the piston retainer 520 is coupled (e.g., indirectly) to, and rotated by, the LP shaft 136 (FIG. 1). Also, the piston 518 is coupled to, and extends in a forward direction, from the piston retainer 520. Therefore, the piston 518 also rotates with the piston retainer 520 and the fan shaft 145. The hydraulic cylinder 516 also rotate with the piston retainer 520 and the piston 518 but is axially slidable relative to the piston retainer 520 and the piston 518, as disclosed in further detail herein. In some examples, the hydraulic cylinder 516 is disposed within the fan hub 148 (FIG. 1) of the turbofan engine 110 (FIG. 1).

In the illustrated example of FIG. 5, the piston retainer 520 has a first portion 520a (e.g., a post), a second portion 520b (e.g., a flange) that extends radially outward from the first portion 520a, and a third portion 520c (e.g., a shaft) that extends axially from the second portion 520b. The third portion 520c is coupled (e.g., bolted) to the fan shaft 145. The piston retainer 520 can be constructed as multiple parts coupled (e.g., welded) together or as a single unitary part or component (e.g., a monolithic structure). The piston 518 is coupled to, and extends forward from, the first portion 520a of the piston retainer 520.

The hydraulic cylinder 516 is disposed radially outward of (e.g., around, surrounding) the piston retainer 520 and the piston 518. The hydraulic cylinder 516 is keyed to the piston retainer 520. As such, the piston retainer 520 rotates the hydraulic cylinder 516. However, the hydraulic cylinder 516 is slidable along the piston retainer 520 in the axial direction A (left and right in FIG. 5). This movement is used to change the pitch of the plurality of fan blades 140. The hydraulic cylinder 516 is coupled to the unison ring 508 at a joint 517 such that the hydraulic cylinder 516 is coupled to the plurality of fan blades 140 via the trunnion mechanism 502. The fan actuation system 500 can be activated to move the hydraulic cylinder 516 axially (left or right in FIG. 5), which causes the plurality of trunnion links 506 to rotate the plurality of trunnions 504, which rotates the plurality of fan blades 140 about the pitch axis P. As such, movement of the hydraulic cylinder 516 causes all of the fan blades 140 to rotate (e.g., pitch) simultaneously. When the hydraulic cylinder 516 is moved in a first axial direction (the forward direction, or to the left in FIG. 5), the plurality of fan blades 140 is rotated to the feather position, and when the hydraulic cylinder 516 is moved in a second axial direction (the rearward direction, or to the right in FIG. 5), the plurality of fan blades 140 is rotated away from the feather position and toward the reverse position. However, in other examples, the fan actuation system 500 can be configured so that the movement of the hydraulic cylinder 516 is reversed.

The hydraulic cylinder 516 has a first portion 516a, a second portion 516b, a third portion 516c, and a fourth portion 516d. The first portion 516a extends generally in the axial direction A and is coupled to the unison ring 508 at the joint 517 (e.g., a bolted joint). The second portion 516b is disposed radially inward of the first portion 516a and is coupled to the first portion 516a and to the unison ring 508 at the joint 517. The third portion 516c extends forward from the joint 517 (e.g., from the first portion 516a, the second portion 516b, and the unison ring 508) and forms a pressurized pneumatic chamber 570, disclosed in further detail herein. The fourth portion 516d is coupled to, and extends axially within, the third portion 516c. The first portion 516a, the second portion 516b, the third portion 516c, and the fourth portion 516d form the hydraulic cylinder 516. In some examples, the first portion 516a, the second portion 516b, the third portion 516c, and the fourth portion 516d are separate parts or components that are coupled (e.g., welded, bolted) together. In other examples, one or more of the first portion 516a, the second portion 516b, the third portion 516c, and the fourth portion 516d can be constructed as a single unitary part or component (e.g., a monolithic structure). In some aspects, the hydraulic cylinder 516 and the unison ring 508 form a single unitary part or component.

The first portion 516a of the hydraulic cylinder 516 is sealingly engaged with (e.g., engaged with a seal to prevent fluid leakage) the third portion 520c of the piston retainer 520. The second portion 520b of the piston retainer 520 is sealingly engaged with the first portion 516a of the hydraulic cylinder 516. The second portion 516b of the hydraulic cylinder 516 is sealingly engaged with the first portion 520a of the piston retainer 520. The piston 518 is sealingly engaged with the second portion 516b and with the fourth portion 516d of the hydraulic cylinder 516.

The fan actuation system 500 includes one or more hydraulic chambers defined between the hydraulic cylinder 516, the piston 518, and the piston retainer 520. These hydraulic chamber(s) are used to control the position of the hydraulic cylinder 516, and, thus, to control the pitch of the plurality of fan blades 140. As shown in FIG. 5, the fan actuation system 500 includes a first hydraulic chamber 540, a second hydraulic chamber 542, and a third hydraulic chamber 544. The first hydraulic chamber 540 is formed or is defined between the first portion 516a of the hydraulic cylinder 516, the second portion 520b of the piston retainer 520, and the third portion 520c of the piston retainer 520. The second hydraulic chamber 542 is formed or is defined between the first portion 516a of the hydraulic cylinder 516, the second portion 516b of the hydraulic cylinder 516, the first portion 520a of the piston retainer 520, and the second portion 520b of the piston retainer 520. The third hydraulic chamber 544 is formed or is defined between second portion 516b of the hydraulic cylinder 516, an aft end of the piston 518, and the first portion 520a of the piston retainer 520. In this example, the first hydraulic chamber 540 and third hydraulic chamber 544 are provided with hydraulic fluid at a first pressure, referred to herein as P1, and the second hydraulic chamber 542 is provided with hydraulic fluid at a second pressure, referred to herein as P2. The first pressure P1 and the second pressure P2 can be any amount depending on the specific design. In some examples, the first pressure P1 and the second pressure P2 can be as high as one thousand pounds per square inch (1000 psi) or even higher. The first pressure P1 and the second pressure P2 can be increased or can be decreased to cause the hydraulic cylinder 516 to move axially forward or axially rearward, thus changing the pitch of the plurality of fan blades 140. For example, if the force acting on the hydraulic cylinder 516 from the first pressure P1 in the first hydraulic chamber 540 and the third hydraulic chamber 544 is greater than the force acting on the hydraulic cylinder 516 from the second pressure P2 in the second hydraulic chamber 542, the hydraulic cylinder 516 moves (e.g., slides) rearward (axially aftward, or to the right in FIG. 5) along the piston 518 and the piston retainer 520. Conversely, if the force acting on the hydraulic cylinder 516 from the first pressure P1 in the first hydraulic chamber 540 and the third hydraulic chamber 544 is less than the force acting on the hydraulic cylinder 516 from the second pressure P2 in the second hydraulic chamber 542, the hydraulic cylinder 516 moves (e.g., slides) axially forward (to the left in FIG. 5) along the piston 518 and the piston retainer 520. Therefore, the first hydraulic chamber 540 and the third hydraulic chamber 544 receive hydraulic fluid to move the hydraulic cylinder 516 in the rearward direction (e.g., aftward direction) while the second hydraulic chamber 542 receives hydraulic fluid to move the hydraulic cylinder 516 in the forward direction.

The fan actuation system 500 includes a hydraulic system 550 to provide hydraulic fluid, such as oil, to one or more of the hydraulic chambers 540, 542, 544 to control the movement of the hydraulic cylinder 516. The hydraulic system 550 includes a pump 552 to control the first pressure P1 and the second pressure P2. The pump 552 is activated to move the hydraulic fluid into, or out of, the hydraulic chambers 540, 542, 544 to increase or to decrease the first pressure P1 and the second pressure P2, and, therefore, to cause the hydraulic cylinder 516 to move forward or to move rearward. In the illustrated example, the hydraulic system 550 includes an oil transfer bearing 554. The oil transfer bearing 554 includes a fixed portion 556 (e.g., a shaft) with fluid passageways fluidly coupled to the pump 552. The fixed portion 556 is a static component and does not rotate or move axially. The oil transfer bearing 554 includes a sleeve 558 that is rotatable about the fixed portion 556. The hydraulic system 550 includes a first fluid line 560, a second fluid line 562, and a third fluid line 564 fluidly coupled between the oil transfer bearing 554 and the respective hydraulic chambers 540, 542, and 544. The first fluid line 560 is in fluid communication with the first hydraulic chamber 540, the second fluid line 562 is in fluid communication with the second hydraulic chamber 542, and the third fluid line 564 is in fluid communication with the third hydraulic chamber 544. The first fluid line 560, the second fluid line 562, and the third fluid line 564 are coupled to the sleeve 558. The sleeve 558 enables fluid communication among the first fluid line 560, the second fluid line 562, and the third fluid line 564, which are rotating with the fan actuation system 500, and the fixed portion 556 of the oil transfer bearing 554. Thus, the oil transfer bearing 554 enables the hydraulic fluid to be transferred between a stationary component and a rotating component. As disclosed above, the first hydraulic chamber 540 and the third hydraulic chamber 544 are provided with the hydraulic fluid at the same first pressure P1. The oil transfer bearing 554 fluidly couples the hydraulic fluid in the first fluid line 560 and the third fluid lines 564 such that the first hydraulic chamber 540 and the third hydraulic chamber 544 remain at the same first pressure P1.

To move the plurality of fan blades 140 away from the feather position and toward the reverse position, the pump 552 is activated to increase the first pressure P1 in the first hydraulic chamber 540 and the third hydraulic chamber 544 and to reduce the second pressure P2 in the second hydraulic chamber 542. As a result, the hydraulic cylinder 516 moves in the rearward direction (to the right in FIG. 5). The hydraulic cylinder 516 pushes the plurality of trunnion links 506 rearward (to the right in FIG. 5), which causes the plurality of fan blades 140 to rotate away from the feather position and toward the reverse position. In this way, the plurality of fan blades 140 can be moved between the feather position and the reverse position. When the desired position is reached, the pump 552 is deactivated or can otherwise balance the loads on the hydraulic cylinder 516 to maintain the current position. The pump 552 can further increase the first pressure P1 or decrease the second pressure P2 to further move the plurality of fan blades 140 toward the reverse position. Otherwise, to move the plurality of fan blades 140 back to the feather position, the pump 552 is activated to reduce the first pressure P1 in the first hydraulic chamber 540 and the third hydraulic chamber 544 or to increase the second pressure P2 in the second hydraulic chamber 542. Thus, the hydraulic system 550 is used to control the position of the hydraulic cylinder 516 for controlling the pitch of the plurality of fan blades 140 along the pitch axis P. The first pressure P1 being the same in the first hydraulic chamber 540 and the third hydraulic chambers 544 reduces the overall first pressure P1 required to control the hydraulic cylinder 516. In other examples, however, the first hydraulic chamber 540 and the third hydraulic chamber 544 can be pressurized at different pressures.

The pressurized pneumatic chamber 570 is formed or is defined by the third portion 516c of the hydraulic cylinder 516 and the piston 518. The pressurized pneumatic chamber 570 is filled with a pressurized gas. In some examples, the pressurized pneumatic chamber 570 contains pressurized nitrogen. In other examples, the pressurized pneumatic chamber 570 can be filled with another pressurized gas (e.g., air). The pressurized pneumatic chamber 570 is sealed. A such, the volume of the pressurized gas (e.g., nitrogen) in the pressurized pneumatic chamber 570 does not change. During manufacture or assembly of the fan actuation system 500, the pressurized pneumatic chamber 570 can be charged with gas (e.g., nitrogen) and then sealed. The pressurized pneumatic chamber 570 can be pressurized to any amount depending on the size of the pressurized pneumatic chamber 570 and on the size of the hydraulic chambers 540, 542, 544 and the desired biasing force. In some examples, the pressure in the pressurized pneumatic chamber 570 is in a range from seven hundred twenty pounds per square inch to nine hundred twenty pounds per square inch (720 psi to 920 psi). In other examples, however, the pressure may be less than, or greater than, these exemplary values.

The pressurized gas in the pressurized pneumatic chamber 570 generates a constant force or a constant load that biases the hydraulic cylinder 516 in the forward direction (to the left in FIG. 5), which corresponds to the feather position of the plurality of fan blades 140. This provides a failsafe to move the plurality of fan blades 140 to the feather position in an event of failure of the hydraulic system 550 or a shutdown of the turbofan engine 110. For example, if the hydraulic system 550 or the turbofan engine 110 fails or is shut down, the hydraulic system 550 is not able to provide pressurized hydraulic fluid to the hydraulic chambers 540, 542, and 544 to control or to maintain the position of the hydraulic cylinder 516. In such an instance, the force on the hydraulic cylinder 516 from the pressurized gas in the pressurized pneumatic chamber 570 overcomes the force on the hydraulic cylinder 516 from the first hydraulic chamber 540 and the third hydraulic chamber 544. As such, the hydraulic cylinder 516 moves in the forward direction (to the left in FIG. 5), which moves the plurality of fan blades 140 to the feather position shown in FIG. 5. As such, the pressurized pneumatic chamber 570 provides a passive system that moves the plurality of fan blades 140 to the feather position in the event of a failure or a deactivation of the hydraulic system 550, which may occur if the turbofan engine 110 fails or is shut down. Therefore, if one of the turbofan engines of an aircraft fails or is deactivated during flight, the fan actuation system 500 automatically moves the plurality of fan blades 140 to the feather position (FIG. 5). This is advantageous because, in the feather position, the plurality of fan blades 140 produces less resistance, which reduces drag on the turbofan engine 110 and on the aircraft. This also reduces or prevents the plurality of fan blades 140 from spinning (due to incoming airflow) the internal turbo-machinery parts of the turbofan engine 110.

The example pressurized pneumatic chamber 570 is advantageous because it has a high load capability due to the compressibility of the pneumatic gas (e.g., nitrogen). Further, the pressurized pneumatic chamber 570 enables a longer travel of the hydraulic cylinder 516 with relatively little change in load. Therefore, the pressurized pneumatic chamber 570 provides a relatively constant load throughout the stroke. Also, the volume and areas of the pressurized pneumatic chamber 570 and the piston 518 can be varied to optimize the load versus travel of the hydraulic cylinder 516.

Therefore, during normal operation of the fan actuation system 500, the first hydraulic chamber 540 and the third hydraulic chamber 544 act to bias the hydraulic cylinder 516 in the rearward direction, while the second hydraulic chamber 542 and the pressurized pneumatic chamber 570 act to bias the hydraulic cylinder 516 in the forward direction. The pressures in the hydraulic chambers 540, 542, and 544 and in the pressurized pneumatic chamber 570 can be controlled to substantially balance the forces and to maintain the hydraulic cylinder 516 in a desired position. In the illustrated example of FIG. 5, a chamber 572 is formed or is defined between the hydraulic cylinder 516 and the piston 518. The chamber 572 is vented to the atmosphere. As such, the chamber 572 does not provide a force in either direction. In this example, the pressurized pneumatic chamber 570 is forward of the piston retainer 520 and the piston 518. In some examples, this is beneficial because there is additional space forward of these components. In other examples, however, the pressurized pneumatic chamber 570 can be disposed rearward of the piston 518 and the piston retainer 520.

In the example of FIG. 5, the fan actuation system 500 is devoid of a pitch lock device and counterweights for reducing inertial loading associated with rotation of fan blades. In particular, in known fan actuation systems, a separate pitch lock device is required to hold the plurality of fan blades 140 once the plurality of fan blades 140 is in the feather position. Further, in known fan actuation systems, a counterweight is used to provide additional force to help pitch the fan blades. However, with the fan actuation system 500, the pressurized pneumatic chamber 570 provides a constant biasing force to hold the plurality of fan blades 140 in the feather position, which eliminates the need for a separate pitch lock device. Further, the hydraulic system 550 provides the first pressure P1 in both the first hydraulic chamber 540 and the third hydraulic chamber 544 to provide a higher pressure to pitch the fan blades 140, which eliminates the need for a counterweight. This reduces parts, complexity, weight, and costs of the fan actuation system 500.

Examples have been disclosed herein that improve the ability for the fan actuation system 500 to move the fan blades 140 to the feather position in the event of failure of the fan actuation system 500 or a shutdown of the turbofan engine 110. The example systems disclosed herein are passive and, thus, do not require complicated activation components or control systems. The example pressurized pneumatic chamber 570 is capable of handling high rotational speeds and a large variation in operating temperatures, such as encountered during use on aircraft. The examples disclosed herein also eliminate the need for a pitch lock device. As such, the example systems can result in fewer parts, less complexity, reduced weight, and lower costs compared to known systems. The fan actuation system 500 is particularly useful in turbofan engines (e.g., the turbofan engine 110 of FIG. 1 or the turbofan engine 210 of FIG. 2) in which the space for the fan actuation system 500 is smaller as compared to turboprop engines. Components of the fan actuation system 500 can be used in combination with any of the fan actuation systems disclosed herein.

The turbofan engine 110 also includes one or more thrust bearings, also referred to as one or more radial thrust (radial blade load) bearings 580, disposed between the trunnion 504 and the fan disk 142 such that the trunnion 504 rotates about the pitch axis P with respect to the fan disk 142. The one or more radial thrust bearings 580 transmit the load (the radial blade load) from the respective fan blade 140 to a static structure of the turbofan engine 110. In particular, the radial thrust bearings 580 include a plurality of rolling elements 582. The rolling elements 582 can include, for example, ball bearings, tapered roller bearings, or the like, for transmitting the radial blade load from the fan blade 140 to the static structure.

The one or more radial thrust bearings 580 are disposed radially at a thrust bearing radius R_{TB}. The thrust bearing radius R_{TB} is defined in the radial direction R from the longitudinal centerline axis 112 to a radial center 583 of the one or more radial thrust bearings 580. The radial center 583 is a center of the radial thrust bearings 580 in the radial direction R. Particularly, the radial center 583 is defined as a radial center of the rolling elements 582. The amount of space, or the volume, beneath the fan 138 that is available for the fan actuation system 500 is defined by the thrust bearing radius R_{TB}. The fan actuation system 500 needs to be accommodated radially below the one or more radial thrust bearings 580 and within the thrust bearing radius R_{TB}.

The turbofan engine 110 includes a fan hub axial length A_{FH}, a fan actuation system axial length A_{FAS}, and a fan bearing axial length A_{FB}. The fan hub axial length A_{FH} is an axial length, in the axial direction (e.g., parallel with the longitudinal centerline axis 112) from the fan hub tip 157 to the pitch axis P of the fan blades 140. The fan actuation system axial length A_{FAS} is an axial length, in the axial direction (e.g., parallel with the longitudinal centerline axis 112), from an axially forward-most surface 515 of the fan actuation system 500 to the pitch axis P of the fan blades 140. In FIG. 5, the axially forward-most surface 515 is defined by an axially forward-most surface of the actuators 514 (e.g., of the hydraulic cylinder 516). The fan actuation system axial length A_{FAS} is a maximum of 80% of the fan hub axial length A_{FH}. In this way, the fan actuation system 500 fits within the fan hub 148 such that the actuators 514 can move axially without contacting the fan hub 148. The fan bearing axial length A_{FB} is an axial length, in the axial direction (e.g., parallel with the longitudinal centerline axis 112) from the pitch axis P of the fan blades 140 to an axial center of the fan bearings 155.

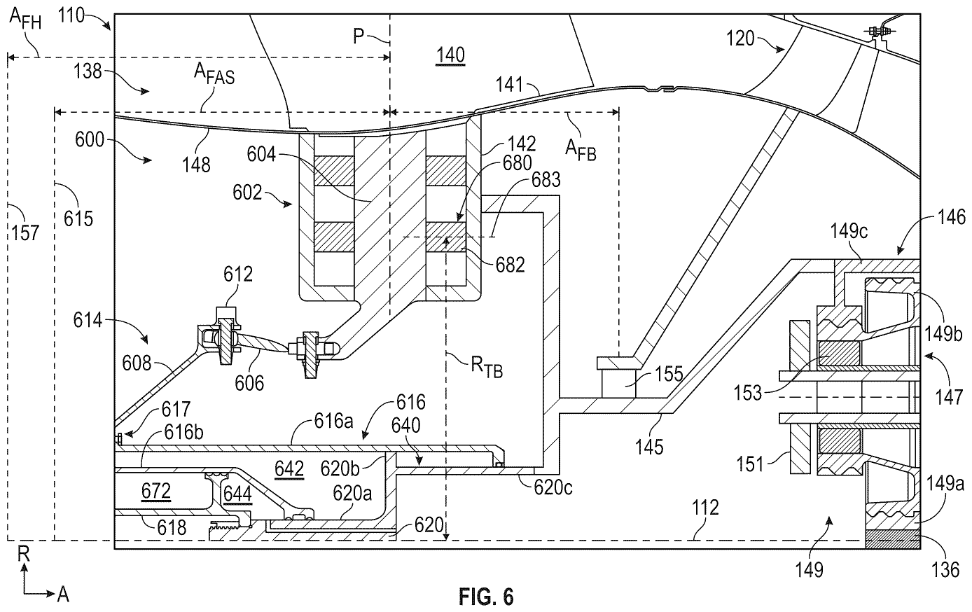

FIG. 6 is a schematic cross-sectional view of a fan actuation system 600 for the turbofan engine 110, taken along the longitudinal centerline axis 112 of the turbofan engine 110, according to the present disclosure. While the fan actuation system 600 is described as being utilized in the turbofan engine 110, the fan actuation system 600 can be utilized in the turbofan engine 210 of FIG. 2. The fan actuation system 600 is substantially similar to the fan actuation system 500 of FIG. 5. The same reference numerals will be used for components of the fan actuation system 600 that are the same as or similar to the components of the fan actuation system 500 discussed above. The description of these components above also applies to this aspect, and a detailed description of these components is omitted here.

The fan actuation system 600 includes a trunnion mechanism 602, a plurality of trunnions 604, a plurality of trunnion links 606, a unison ring 608, a plurality of pins 612, one or more actuators 614, a hydraulic cylinder 616, a joint 617, a piston 618, and a piston retainer 620. The hydraulic cylinder 616 has a first portion 616a and a second portion 616b. Although not shown in the view of FIG. 6, the hydraulic cylinder 616 also includes a third portion and a fourth portion similar to the third portion 516c and the fourth portion 516d of the hydraulic cylinder 516 of FIG. 5. The piston retainer 620 has a first portion 620a, a second portion 620b, and a third portion 620c. The fan actuation system 600 also includes a first hydraulic chamber 640, a second hydraulic chamber 642, a third hydraulic chamber 644, and a pressurized pneumatic chamber (not shown in the view of FIG. 6), and a chamber 672. The first hydraulic chamber 640 and the third hydraulic chamber 644 receive the hydraulic fluid at a first pressure P1, and the second hydraulic chamber 642 receives the hydraulic fluid at a second pressure P2, as detailed above with respect to FIG. 5. The fan actuation system 600 operates substantially similar as to the fan actuation system 500 of FIG. 5.

FIG. 6 shows one fan blade 140 of the fan 138, the core inlet 120, and the gearbox assembly 146. The gearbox assembly 146 includes a gear assembly 147 having a plurality of gears 149 including a first gear 149a, one or more second gears 149b secured by a planet carrier 151, and a third gear 149c. In FIG. 6, the first gear 149a is a sun gear, the one or more second gears 149b are planet gears, and the third gear 149c is a ring gear. The gear assembly 147 is an epicyclic gear assembly. When the gear assembly 147 is an epicyclic gear assembly, the one or more second gears 149b include a plurality of second gears 149b (e.g., two or more second gears 149b).

In the epicyclic gear assembly, the gear assembly 147 can be in a star arrangement or a rotating ring gear type gear assembly (e.g., the third gear 149c is rotating and the planet carrier 151 is fixed and stationary). In such an arrangement, the fan 138 is driven by the third gear 149c. For example, the third gear 149c is coupled to the fan shaft 145 such that rotation of the third gear 149c causes the fan shaft 145, and, thus, the fan 138, to rotate. In this way, the third gear 149c is an output of the gear assembly 147. However, other suitable types of gear assemblies may be employed. In one non-limiting aspect, the gear assembly 147 is a planetary arrangement, in which the third gear 149c is held fixed, with the planet carrier 151 allowed to rotate. In such an arrangement, the fan 138 is driven by the planet carrier 151. For example, the planet carrier 151 is coupled to the fan shaft 145 such that rotation of the planet carrier 151 causes the fan shaft 145, and, thus, the fan 138, to rotate. In this way, the one or more second gears 149b (e.g., via the planet carrier 151) are the output of the gear assembly 147. In another non-limiting aspect, the gear assembly 147 may be a differential gear assembly in which the third gear 149c and the planet carrier 151 are both allowed to rotate. While an epicyclic gear assembly is detailed herein, the gear assembly can include any type of gear assembly including, for example, a single stage gear assembly or a compound gear assembly (e.g., a gear assembly having a plurality of stages).

The plurality of gears 149 includes one or more gear bearings 153 disposed therein. For example, the one or more second gears 149b each includes one or more gear bearings 153 disposed therein. The one or more gear bearings 153 enable the plurality of gears 149 to rotate about the one or more gear bearings 153 such that the plurality of gears 149 rotates. The one or more gear bearings 153 can include any type of bearing for a gear, such as, for example, journal bearings, roller bearings, or the like. The gearbox assembly 146 can include a plurality of gear bearings that includes a forward gear bearing and an aft gear bearing. The one or more gear bearings 153 shown in the view of FIG. 6 are the forward gear bearing.

The first gear 149a is coupled to an input shaft of the turbofan engine 110. For example, the first gear 149a is coupled to the LP shaft 136 such that rotation of the LP shaft 136 causes the first gear 149a to rotate. Radially outward of the first gear 149a, and intermeshing therewith, is the one or more second gears 149b that are coupled together and supported by the planet carrier 151. The planet carrier 151 supports and constrains the one or more second gears 149b such that the each of the one or more second gears 149b is enabled to rotate about a corresponding axis of each second gear 149b without rotating about the periphery of the first gear 149a. Radially outwardly of the one or more second gears 149b, and intermeshing therewith, is the third gear 149c, which is an annular ring gear. The third gear 149c is coupled via an output shaft to the fan 138 and rotates to drive rotation of the fan 138 about the longitudinal centerline axis 112. For example, the fan shaft 145 is coupled to the third gear 149c.

The fan shaft 145 is coupled to the fan disk 142 such that rotation of the fan shaft 145 causes the plurality of fan blades 140 to rotate about the longitudinal centerline axis 112. The turbofan engine 110 also includes one or more radial thrust bearings 680, disposed between the trunnion 604 and the fan disk 142 such that the trunnion 604 rotates about the pitch axis P with respect to the fan disk 142. In particular, the radial thrust bearings 680 include a plurality of rolling elements 682.

The one or more radial thrust bearings 680 are disposed radially at the thrust bearing radius R_{TB} defined in the radial direction R from the longitudinal centerline axis 112 to a radial center 683 of the one or more radial thrust bearings 680, as discussed above. The fan actuation system axial length A_{FAS} is an axial length, in the axial direction (e.g., parallel with the longitudinal centerline axis 112), from an axially forward-most surface 615 (shown schematically in FIG. 6) of the fan actuation system 600 to the pitch axis P of the fan blades 140.

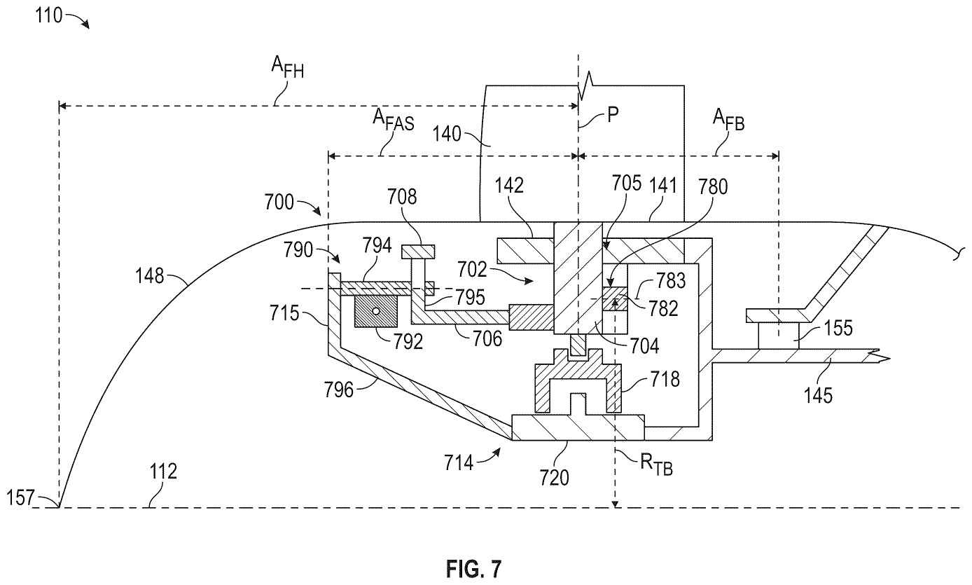

FIG. 7 is a schematic cross-sectional view of a fan actuation system 700 for the turbofan engine 110, taken along the longitudinal centerline axis 112 of the turbofan engine 110, according to the present disclosure. While the fan actuation system 700 is described as being utilized in the turbofan engine 110, the fan actuation system 700 can be utilized in the turbofan engine 210 of FIG. 2. The fan actuation system 700 is substantially similar to the fan actuation system 500 of FIG. 5. The same or similar reference numerals will be used for components of the fan actuation system 700 that are the same as or similar to the components of the fan actuation system 500 discussed above. The description of these components above also applies to this aspect, and a detailed description of these components is omitted here.

The fan actuation system 700 includes a trunnion mechanism 702, a plurality of trunnions 704, an opening 705, one or more trunnion links 706, a unison ring 708, one or more actuators 714, an axially forward-most surface 715, a piston 718, a piston retainer 720, and one or more radial thrust bearings 780. The piston retainer 720 is stationary (e.g., coupled to a static structure of the turbofan engine 110) and the piston 718 moves with respect to the piston retainer 720 to change a pitch of the fan blades 140. For example, the piston 718 can be coupled to a hydraulic cylinder that receives hydraulic fluid for moving the piston 718, as detailed above. The one or more trunnion links 706 include one or more ring gears that mesh with a corresponding gear of the trunnions 704.

The fan actuation system 700 also includes a counterweight assembly 790 including one or more counterweights 792. The counterweights 792 are axially spaced from the trunnions 704 to counter a centrifugal twisting moment of the fan blades 140. The counterweights 792 can be any high-density mass that can rotate about a counterweight centerline. The counterweights 792 can have offset masses that are movable relative to the counterweight centerline. In particular, the counterweights 792 are coupled to one or more counterweight shafts 794 that are drivingly coupled to the trunnion links 706 via one or more counterweight gears 795. The counterweight shafts 794 are supported by one or more counterweight support members 796 that are coupled to the piston retainer 720. In FIG. 7, the axially forward-most surface 715 is defined by an axially forward-most surface of the counterweight support member 796. In this way, the axially forward-most surface 715 is defined by the counterweight assembly 790.

As the trunnions 704 rotate, the trunnions 704 cause the trunnion links 706 to rotate with respect to the unison ring 708, and in turn, the trunnion links 706 cause the counterweight shafts 794 to rotate. As the trunnion links 706 and the counterweight shafts 794 rotate, the counterweights 792 rotate via the counterweight shafts 794. In this way, the counterweights 792 change position relative to the counterweight centerline. Thus, the counterweight assembly 790 counters a centrifugal twisting moment of the fan blades 140 to help rotate the fan blades 140 when the pitch of the fan blades 140 changes.

A mass of the counterweights 792 can be changed based on a length of the counterweight shafts 794. In particular, the counterweights 792 can have less mass with longer counterweight shafts 794 and can have more mass with shorter counterweight shafts 794. In this way, the axially further the counterweights 792 are disposed from the pitch axis P of the fan blades 140, the lesser mass the counterweights 792 can have, while still countering the centrifugal twisting moment of the fan blades 140 and helping to rotate the fan blades 140 when the pitch of the fan blades 140 changes. Accordingly, the mass of the counterweights 792 needed to pitch the fan blades 140 and counter the twisting moment is a function of the axial position of the counterweights 792 with respect to the pitch axis P.

The one or more radial thrust bearings 780 are disposed radially at the thrust bearing radius R_{TB} defined in the radial direction R from the longitudinal centerline axis 112 to a radial center 783 of a plurality of rolling elements 782 of the radial thrust bearings 780, as discussed above. The fan actuation system axial length A_{FAS} is an axial length, in the axial direction (e.g., parallel with the longitudinal centerline axis 112), from an axially forward-most surface 715 of the fan actuation system 700 to the pitch axis P of the fan blades 140.

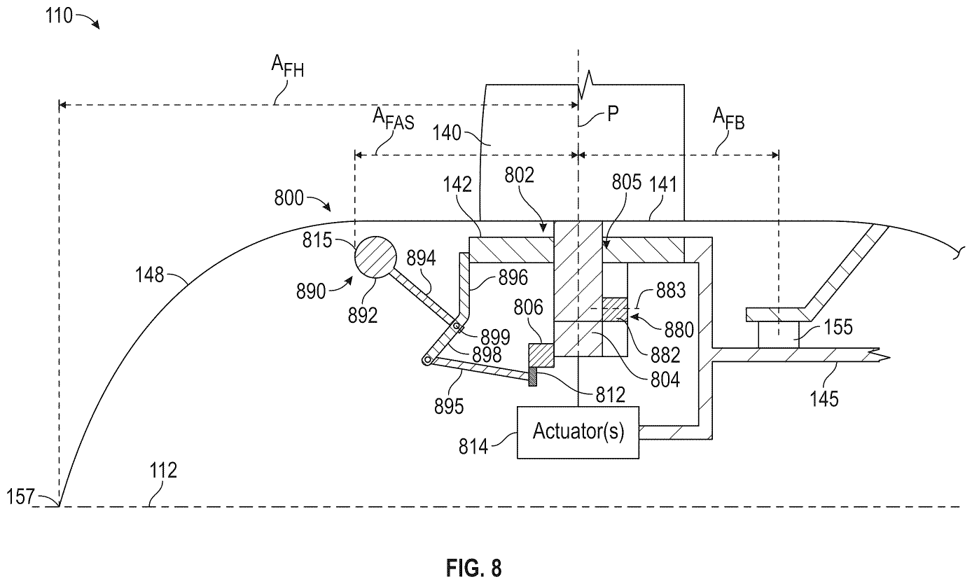

FIG. 8 is a schematic cross-sectional view of a fan actuation system 800 for the turbofan engine 110, taken along the longitudinal centerline axis 112 of the turbofan engine 110, according to the present disclosure. While the fan actuation system 800 is described as being utilized in the turbofan engine 110, the fan actuation system 800 can be utilized in the turbofan engine 210 of FIG. 2. The fan actuation system 800 is substantially similar to the fan actuation system 700 of FIG. 7. The same or similar reference numerals will be used for components of the fan actuation system 800 that are the same as or similar to the components of the fan actuation system 700 discussed above. The description of these components above also applies to this aspect, and a detailed description of these components is omitted here.

The fan actuation system 800 includes a trunnion mechanism 802, a plurality of trunnions 804, an opening 805, one or more trunnion links 806, a plurality of pins 812, one or more actuators 814 (shown schematically in FIG. 8), an axially forward-most surface 815, and one or more radial thrust bearings 880. The actuators 814 can include any of the actuators disclosed herein for changing a pitch of the fan blades 140. The one or more trunnion links 806 include arms that extend from the trunnions 804. The pins 812 extend through the arms and are coupled to a counterweight assembly 890.

The counterweight assembly 890 includes one or more counterweights 892, one or more counterweight shafts 894, and one or more counterweight support members 896. The one or more counterweight support members 896 are coupled to the fan disk 142 such that the counterweight assembly 890 rotates about the longitudinal centerline axis 112 with rotation of the fan 138. The counterweight assembly 890 also includes one or more link arms 895 and one or more lever arms 898. The one or more lever arms 898 are pivotably coupled to the counterweight support members 896 via a pivot 899. The link arms 895 are coupled to the trunnion links 806 via the pins 812 and are pivotably coupled to the lever arms 898. The counterweight shafts 894 are pivotably coupled to the lever arms 898 at the pivot 899.

In FIG. 8, the axially forward-most surface 815 is defined by an axially forward-most surface of the counterweights 892 at a maximum axial extent of the counterweights 892, as detailed further below. In this way, the axially forward-most surface 815 is defined by the counterweight assembly 890.

As the trunnions 804 rotate, the trunnions 804 cause the trunnion links 806 to rotate, and in turn, the trunnion links 806 cause the pins 812 to rotate, and, thus, cause the link arms 895 to pivot. As the link arms 895 pivot, the link arms 895 cause the lever arms 898 to pivot, and, thus, cause the counterweight shafts 894 to pivot about the pivot 899. In this way, the counterweight shafts 894 cause the counterweights 892 to travel along a partially circular arc radially outward away from the longitudinal centerline axis 112 or radially inward towards the longitudinal centerline axis 112. Thus, the counterweight assembly 890 counters a centrifugal twisting moment of the fan blades 140 to help rotate the fan blades 140 when the pitch of the fan blades 140 changes.

The one or more radial thrust bearings 880 are disposed radially at the thrust bearing radius R_{TB} defined in the radial direction R from the longitudinal centerline axis 112 to a radial center 883 of a plurality of rolling elements 882 of the radial thrust bearings 880, as discussed above. The fan actuation system axial length A_{FAS} is an axial length, in the axial direction (e.g., parallel with the longitudinal centerline axis 112), from an axially forward-most surface 815 of the fan actuation system 800 to the pitch axis P of the fan blades 140.

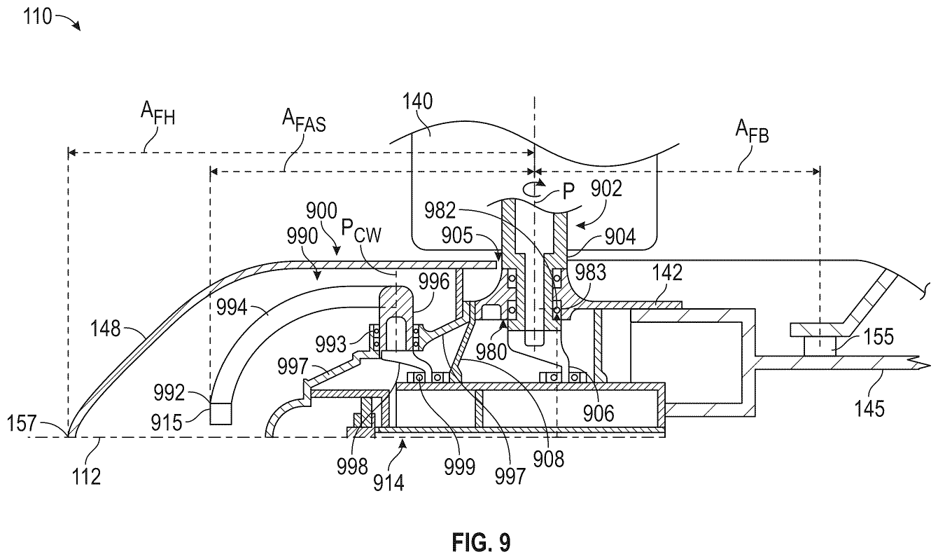

FIG. 9 is a schematic cross-sectional view of a fan actuation system 900 for the turbofan engine 110, taken along the longitudinal centerline axis 112 of the turbofan engine 110, according to the present disclosure. While the fan actuation system 900 is described as being utilized in the turbofan engine 110, the fan actuation system 900 can be utilized in the turbofan engine 210 of FIG. 2. The fan actuation system 900 is substantially similar to the fan actuation system 700 of FIG. 7. The same or similar reference numerals will be used for components of the fan actuation system 900 that are the same as or similar to the components of the fan actuation system 700 discussed above. The description of these components above also applies to this aspect, and a detailed description of these components is omitted here.

The fan actuation system 900 includes a trunnion mechanism 902, a plurality of trunnions 904, an opening 905, one or more trunnion links 906, a unison ring 908, one or more actuators 914, an axially forward-most surface 915, and one or more radial thrust bearings 980. The actuators 914 can include any of the actuators disclosed herein for changing a pitch of the fan blades 140. The one or more trunnion links 906 and the unison ring 908 couple the trunnions 904 to the actuators 914 such that movement of the actuators 914 causes the trunnions 904 to rotate, thus, causing the fan blades 140 to rotate about the pitch axis P.

The counterweight assembly 990 includes one or more counterweights 992, one or more counterweight shafts 994, one or more counterweight support members 996, and one or more lever arms 998. In FIG. 9, the counterweight shafts 994 are counterweight levers and the counterweight support members 996 are counterweight trunnions.

The counterweight assembly 990 includes a counterweight hub 997 that may be connected to the fan disk 142, such that rotation of the fan disk 142 about the longitudinal centerline axis 112 drives rotation of the counterweight hub 997 about the longitudinal centerline axis 112. The counterweight shafts 994 are rotationally connected to the counterweight hub 997. For example, each of the counterweight shafts 994 may be mounted to the counterweight hub 997 via one or more counterweight bearings 993 that provide the ability for the counterweight shafts 994 to rotate about a counterweight lever rotational axis P_{CW}. The counterweight bearings 993 may be any type of bearing (e.g., tapered roller bearings, spherical roller bearings, cylindrical roller bearings, needle roller bearings, thrust ball bearings, angular contact roller bearings, deep groove ball bearings, etc.), and are not limited to any particular type of bearing Each of the counterweight support members 996 are rotational about a counterweight lever rotational axis P_{CW} that extends through a respective counterweight support member 996 and extends radially (i.e., in the radial direction R) from the longitudinal centerline axis 112.

Each counterweight shaft 994 is a cantilever arm having a first end connected to a respective counterweight support member 996 and a second end offset from the respective counterweight lever rotational axis P_{CW}. A respective counterweight 992 is connected to the second end of the counterweight shaft 994. Each counterweight 992 has a counterweight center-of-gravity that is utilized in locating the counterweight 992 within the counterweight assembly 990.

The one or more counterweight support members 996 are coupled to the fan disk 142 such that the counterweight assembly 990 rotates about the longitudinal centerline axis 112 with rotation of the fan 138. The counterweight assembly 990 also includes one or more lever arms 998 that are rotationally connected to the actuators 914 via one or more lever bearings 999. The lever arms 998 are connected to the counterweight support members 996 such that axial translation of the actuators 914 along the longitudinal centerline axis 112 drives the lever arms 998 and the counterweight support members 996 about the respective counterweight lever rotational axis P_{CW} so as to rotate the counterweight shafts 994. In FIG. 9, the counterweight shafts 994 are at a ninety-degree rotated position.

In FIG. 9, the axially forward-most surface 915 is defined by an axially forward-most surface of the counterweights 992 at a maximum axial extent of the counterweights 992 (e.g., at the ninety-degree rotated position). In this way, the axially forward-most surface 915 is defined by the counterweight assembly 990.

As the actuators 914 move axially, the actuators 914 cause the trunnions 904 and the counterweight support members 996 to rotate. In turn, the counterweight support members 996 cause the counterweight shafts 994 to rotate about the counterweight lever rotational axis P_{CW}, and, thus, cause the counterweights 992 to rotate. In particular, the counterweight shafts 994, and the counterweights 992, rotate in to or out of the page between the ninety-degree rotated position that defines a maximum axial extent of the counterweights 992 and a zero-degree rotated position that defines a minimum axial extend of the counterweights 992. Thus, the counterweight assembly 990 counters a centrifugal twisting moment of the fan blades 140 to help rotate the fan blades 140 when the pitch of the fan blades 140 changes.

The one or more radial thrust bearings 980 are disposed radially at the thrust bearing radius R_{TB} defined in the radial direction R from the longitudinal centerline axis 112 to a radial center 983 of a plurality of rolling elements 982 of the radial thrust bearings 980, as discussed above. The fan actuation system axial length A_{FAS} is an axial length, in the axial direction (e.g., parallel with the longitudinal centerline axis 112), from an axially forward-most surface 915 of the fan actuation system 900 to the pitch axis P of the fan blades 140.

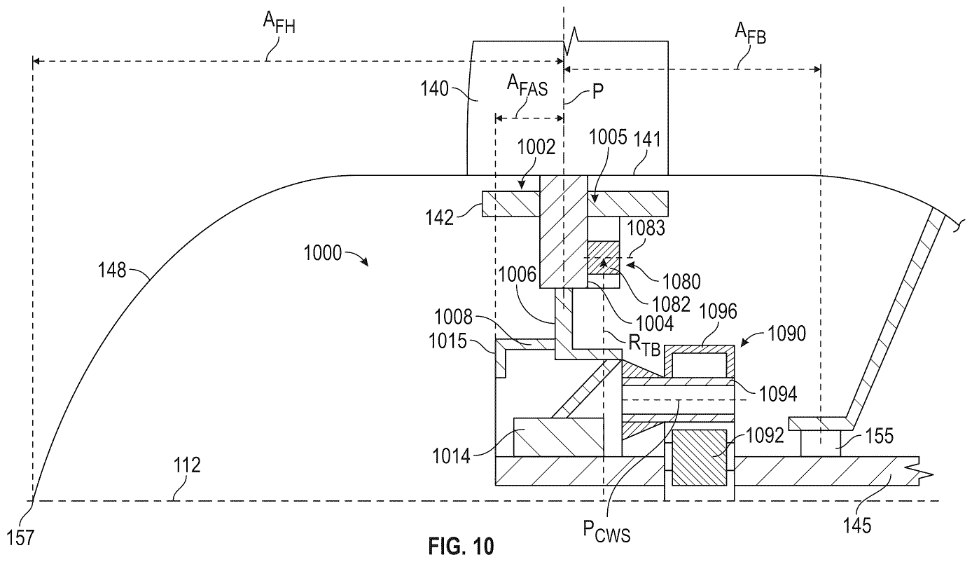

FIG. 10 is a schematic cross-sectional view of a fan actuation system 1000 for the turbofan engine 110, taken along the longitudinal centerline axis 112 of the turbofan engine 110, according to the present disclosure. While the fan actuation system 1000 is described as being utilized in the turbofan engine 110, the fan actuation system 1000 can be utilized in the turbofan engine 210 of FIG. 2. The fan actuation system 1000 is substantially similar to the fan actuation system 500 of FIG. 5. The same or similar reference numerals will be used for components of the fan actuation system 1000 that are the same as or similar to the components of the fan actuation system 500 discussed above. The description of these components above also applies to this aspect, and a detailed description of these components is omitted here.

The fan actuation system 1000 includes a trunnion mechanism 1002, a plurality of trunnions 1004, an opening 1005, one or more trunnion links 1006, a unison ring 1008, one or more actuators 1014, an axially forward-most surface 1015, one or more radial thrust bearings 1080, and a counterweight assembly 1090. The actuators 1014 can include any of the actuators disclosed herein for changing a pitch of the fan blades 140. The one or more trunnion links 1006 and the unison ring 1008 couple the trunnions 1004 to the actuators 1014 such that movement of the actuators 1014 causes the trunnions 1004 to rotate, thus, causing the fan blades 140 to rotate about the pitch axis P. In FIG. 10, the axially forward-most surface 1015 is defined by an axially forward-most surface of the unison ring 1008.

The counterweight assembly 1090 includes one or more counterweights 1092, one or more counterweight shafts 1094, and one or more counterweight support members 1096. The one or more counterweight support members 1096 are coupled to the fan disk 142 via the unison ring 1008 such that the counterweight assembly 1090 rotates about the longitudinal centerline axis 112 with rotation of the fan 138. The counterweights 1092 are positioned axially aft of the fan blades 140, particularly, axially aft of the pitch axis P. For example, the counterweights 1092 are positioned axially between the pitch axis P and the fan bearings 155.

The counterweight support members 1096 act as a carrier for the counterweight shafts 1094. The counterweight shafts 1094 are aligned generally parallel to the longitudinal centerline axis 112 and pass through the counterweight support members 1096. The counterweight shafts 1094 are rotatably connected (e.g., via one or more gears) at a first end to the unison ring 1008. The counterweights 1092 are connected to a second end of the counterweight shafts 1094. The counterweight shafts 1094, and the counterweights 1092, are rotatable relative to the counterweight support members 1096, about a respective counterweight shaft axis P_{CWS}.

All of the counterweight shafts 1094 are meshed via one or more gears with the unison ring 1008. Thus connected, the movement of the fan blades 140, unison ring 1008, and the counterweights 1092 are linked together such that rotary motion of the unison ring 1008, for example, caused by the actuators 1014, will cause a simultaneous change in the pitch angle of all of the fan blades 140, and of the angular orientation of the counterweights 1092. The unison ring 1008 transmits forces between the fan blades 140 and the counterweights 1092. In this way, the counterweight shafts 1094 cause the counterweights 1092 to travel along a partially circular arc radially outward away from the longitudinal centerline axis 112 or radially inward towards the longitudinal centerline axis 112, and axially closer to, or axially further from, the pitch axis P. Thus, the counterweight assembly 1090 counters a centrifugal twisting moment of the fan blades 140 to help rotate the fan blades 140 when the pitch of the fan blades 140 changes.

The one or more radial thrust bearings 1080 are disposed radially at the thrust bearing radius R_{TB} defined in the radial direction R from the longitudinal centerline axis 112 to a radial center 1083 of a plurality of rolling elements 1082 of the radial thrust bearings 1080, as discussed above. The fan actuation system axial length A_{FAS} is an axial length, in the axial direction (e.g., parallel with the longitudinal centerline axis 112), from an axially forward-most surface 1015 of the fan actuation system 1000 to the pitch axis P of the fan blades 140.

As mentioned earlier, the inventors sought to address the problem implementing a variable pitch actuation system within the more limited packaging space available in a turbofan engine and while accounting for the significantly higher loading environment and more numerous blades relative to a turboprop engine. By way of testing various engine architectures the inventors experimented with different configurations of the pitch actuation system, fine and coarse pitch actuators, hydraulic actuators, and bearing placement that could sustain the higher loading associated with more numerous blades, higher disk loading, and Mach speed sufficient to satisfy operational and safety requirements in the event of, e.g., loss of hydraulic pressure. Additionally, while it was possible to arrive at such a system after experiments and testing, there was a challenge to determine how to fit the system within a comparatively more limited space of a turbofan engine.

During the course of evaluating the different embodiments as set forth herein, with the goal of providing the necessary force to pitch the fan blades, taking due account for the number of blades, accounting for loss in fluid pressure or generally lost power conditions, aerodynamic performance, cooling, aeromechanics, and disc loading/fan blade loading, etc., the inventors had discovered there was indeed much less space available for this system to operate as required for the engine's pitch actuation system. After evaluating several different architectures of pitch change mechanisms (with and without counterweight, oil transfer devices, fine and coarse pitch system, torque transfer load path for pitching blades and delivery of shaft power from gearbox, etc.—both for a ducted engine and an open fan engine—it was discovered, unexpectedly, that there is relationships among the number of fan blades, the fan tip diameter D_{FT}, the cruise Mach number, and the thrust bearing radius R_{TB}, and an axial length L_{AXIAL} capable of differentiating an architecture that satisfies operational and packaging requirements from an architecture that does not satisfy these requirements. These relationships moreover are capable of uniquely identifying a finite and readily ascertainable number of embodiments suitable for a particular architecture that accounts for the size and the loading requirements needed to pitch the fan blades without overly sacrificing the aerodynamic performance, cooling aeromechanics, and load margins on the fan blades. For example, the cruise Mach number was not expected to be a significant factor, but as discussed further below, the cruise Mach number was found to be a factor and particularly in conjunction with fan diameter at higher Mach numbers. The inventors submit that the relationships enable one to select a size for the fan pitch actuation system that can reduce the size and the weight of the fan pitch actuation system, while accounting for the factors discussed above. The inventors further submit that the relationships can help identify an improved fan efficiency, or penalties to efficiency by choosing one fan pitch actuation system architecture over another. A relationship is referred to as a fan actuation system (FAS) envelope, in relationship (1):

$$FAS envelope = \frac{{N}_{FB} \times {D}_{FT} \times {M}_{cruise}}{( \frac{{R}_{TB}}{{N}_{FB}} )} . \qquad ( 1 )$$

N_{FB} is the number of fan blades of the fan, D_{FT} is the fan tip diameter, M_{cruise} is the Mach number at cruise (mid-level power operation), and R_{TB} is the thrust bearing radius of the radial thrust bearings (any of the radial thrust bearings detailed herein). N_{FB}×D_{FT}×M_{cruise} is referred to as a loading envelope, and R_{TB}/N_{FB} is referred to as a spacing envelope. Accordingly, the FAS envelope is given by the loading envelope divided by the spacing envelope.

A second relationship is referred to as a fan actuation system length (FASL) envelope, in relationship (2):

$$FASL envelope = \frac{{N}_{FB} \times {D}_{FT}}{{L}_{AXIAL} ( \frac{{R}_{TB}}{{N}_{FB}} )} . \qquad ( 2 )$$

N_{FB} is the number of fan blades of the fan, D_{FT} is the fan tip diameter, R_{TB} is the thrust bearing radius of the radial thrust bearings, and L_{AXIAL} is an axial length, along the longitudinal centerline axis 112 from the fan hub tip 157 to the fan bearings 155. In particular, L_{AXIAL} is a summation of the fan hub axial length A_{FH} and the fan bearing axial length A_{FB}. N_{FB}×D_{FT} is referred to as a loading envelope, and L_{AXIAL}×(R_{TB}/N_{FB}) is referred to as a spacing envelope. Accordingly, the FASL envelope is given by the loading envelope divided by the spacing envelope.

As discussed further below, the inventors identified a range for the FAS envelope and the FASL envelope that enables a fan actuation system design for different turbofan engine architectures that accounts for the integrity/reliability of load paths needed to pitch the fan blades within the space constraints imposed by a turbofan engine (vs. a turboprop's space constraints). Fan pitch actuation system architectures that fall within this range are believed to satisfy packaging requirements for a turbofan engine, while those architectures that do not fall within the FAS envelope range or the FASL envelope range are believed to not satisfy the packaging requirements, which indicate that the system would be unacceptably large and not result in an aircraft engine that met aero efficiency and weight requirements (i.e., an undesirable engine architecture). Using these unique relationships, the size of the fan actuation system can be selected to achieve a more compact fan pitch actuation system for a turbofan engine. Using the FAS envelope or the FASL envelope as a guide, a fan pitch actuation system can be developed that takes into account the loading associated with pitching of the fan blades based on the size of the fan blades, the number of fan blades, the size of thrust bearing, the cruise Mach number, or the axial length, which factors were found—as a result of the extensive number of architectures considered for different thrust class engines, some successful and some not successful—to largely define the packaging size needed to accommodate a pitch actuation system capable of handling the fan loading environment.

Table 1 represents exemplary embodiments 1 to 14 and their corresponding FAS envelope and FASL envelope values for various turbofan engines at various cruise Mach numbers. Embodiments 1 to 14 may represent the turbofan engine 110 of FIG. 1 (e.g., ducted engine) or the turbofan engine 210 of FIG. 2 (e.g., unducted fan engine) and can be applied to any of the pitch actuation systems detailed herein. In particular, embodiments 7, 9, and 13 are ducted engines (e.g., such as the turbofan engine 110 of FIG. 1), and embodiments 1 to 6, 8, 10 to 12, and 14 are unducted fan engines (e.g., such as the turbofan engine 210 of FIG. 2). In Table 1, the FAS envelope values were determined based on relationship (1) described above, the FASL envelope values were determined based on relationship (2) described above, and using fan tip diameters D_{FT}, thrust bearing radiuses R_{TB}, and axial lengths L_{AXIAL} in inches.

TABLE 1

| | | D_{FT} | R_{TB} | A_{FH} | A_{FB} | | FAS | FASL |
|---|---|---|---|---|---|---|---|---|
| Emb. | N_{FB} | (in.) | (in.) | (in.) | (in.) | M_{cruise} | Envelope | Envelope |
| 1 | 12 | 156.0 | 26.9 | 60.60 | 21.60 | 0.8 | 668 | 10.2 |
| 2 | 14 | 156.0 | 24.9 | 60.60 | 20.98 | 0.8 | 982 | 15.1 |
| 3 | 14 | 154.0 | 24.7 | 59.82 | 20.92 | 0.8 | 978 | 15.1 |
| 4 | 14 | 153.8 | 24.3 | 59.75 | 20.79 | 0.8 | 992 | 15.4 |
| 5 | 14 | 164.3 | 24.6 | 63.82 | 20.89 | 0.8 | 1047 | 15.5 |
| 6 | 14 | 110.4 | 19.5 | 42.89 | 19.31 | 0.8 | 888 | 17.8 |
| 7 | 12 | 88.7 | 19.0 | 34.46 | 19.15 | 0.9 | 605 | 12.5 |
| 8 | 10 | 120.0 | 14.8 | 46.62 | 17.85 | 0.9 | 730 | 12.6 |
| 9 | 10 | 84.0 | 14.0 | 32.63 | 17.61 | 0.75 | 450 | 11.9 |
| 10 | 18 | 168.0 | 27.0 | 65.26 | 21.63 | 0.9 | 1814 | 23.2 |
| 11 | 10 | 120 | 14.0 | 46.62 | 17.61 | 0.8 | 686 | 13.3 |
| 12 | 14 | 168.0 | 19.0 | 65.26 | 19.15 | 0.88 | 1525 | 20.5 |
| 13 | 10 | 84.0 | 19.0 | 32.63 | 19.15 | 0.8 | 354 | 8.5 |
| 14 | 14 | 120.0 | 27.0 | 46.62 | 21.63 | 0.88 | 767 | 12.8 |
| 15 | 14 | 180.0 | 19.0 | 69.92 | 19.15 | 0.92 | 1708 | 20.8 |

The FAS envelope and the FASL envelope are only valid for an engine with fan blades N_{FB} in a range from ten to eighteen for a ducted engine, and from ten to sixteen for an open fan engine. In some aspects, the number of fan blades N_{FB} is in ten to fourteen for an open fan engine. The number of fan blades N_{FB} affects the volume (e.g., amount of space) circumscribed by the fan blades. Increasing the number of fan blades N_{FB} increases the amount of airflow that the fan can produce for a particular fan tip diameter and fan rotation speed, but a higher N_{FB} also reduces the tangential distance T_{FB} between fan blades at the fan hub, which impacts the available space for pitch actuation of each individual blade, referring to the space needed per blade for pitch levers, gearing, oil transfer devices, related mechanisms for pitching fan blades and size of load bearing parts of the trunnion and related supporting structure capable of carrying the fan blade loads. This space is at a premium because with an increased number of fan blades the loading capability per blade needs to be satisfied within a smaller space compared to an engine with fewer blades (e.g., such as a turboprop engine). The FAS envelope values and the FASL envelope values account for the number of fan blades NEB selected to increase the amount of airflow but without imposing an unrealistically narrow tangential fan blade distance T_{FB} between adjacent fan blades in order to fit within the desired packaging envelope.

The FAS envelope and the FASL envelope are only valid for a fan tip diameter D_{FT} in a range from eighty-four inches to one hundred ninety-two inches (84.0 in. to 192.0 in.). In some aspects, the FAS envelope and the FASL envelope are valid for a fan tip diameter D_{FT} in a range from eighty-four inches to one hundred eighty inches (84.0 in. to 180.0 in.). In some aspects, the FAS envelope and the FASL envelope are valid for a fan tip diameter D_{FT} in a range from eighty-four inches to one hundred sixty-eight inches (84.0 in. to 168.0 in.). The fan tip diameter D_{FT} also affects the volume needed for supporting the fan blades during operation. Increasing the fan tip diameter D_{FT} increases the fan tip speed for a given rotational speed and therefore the load that needs to get reacted at the trunnion, and torque needed in the pitching mechanism for pitching the blade. The radial spacing between blades and within the volume circumscribed by the fan blades (e.g., within the space circumscribed by the radial thrust bearings) decreases, thereby decreasing the volume beneath the fan and providing less space for the load bearing structure that can react the blade loads. Furthermore, as the bearing radius R_{TB} is extended out, the structure supporting the blade at its root needs to be capable of sustaining higher loads because the blade is disposed further from the fan rotation axis. The more robust root results in a larger fan disk, further providing less space underneath the fan for the fan actuation system. In view of these weight and size considerations, as well as the ability to install such fan blades and fans without resulting in unacceptable aero efficiency penalties, the inventors determined that a fan tip diameter D_{FT} should be less than one hundred ninety-two inches (192.0 in.). In some aspects, the fan tip diameter D_{FT} should be less than one hundred eighty inches (180.0 in.). In some aspects, the fan tip diameter D_{FT} should be less than one hundred sixty-eight inches (168.0 in.). The fan tip diameter D_{FT} may therefore be limited as it impacts the space available for a pitch actuation system suitable for carrying fan blade loads. The size of the fan blades in ducted engines is limited by the duct (e.g., the nacelle). In embodiments for a ducted engine (e.g., the turbofan engine 110 of FIG. 1), the fan tip diameter D_{FT} is in a range from eighty-four inches to one hundred twenty inches (84.0 in. to 120.0 in.). In embodiments for an open fan engine (e.g., the turbofan engine 210 of FIG. 2), the fan tip diameter D_{FT} is in a range from one hundred twenty inches to one hundred ninety-two inches (120.0 in. to 192.0 in.). In some aspects for an open fan engine (e.g., the turbofan engine 210 of FIG. 2), the fan tip diameter D_{FT} is in a range from one hundred twenty inches to one hundred eighty inches (120.0 in. to 180.0 in.). In some aspects for an open fan engine (e.g., the turbofan engine 210 of FIG. 2), the fan tip diameter D_{FT} is in a range from one hundred twenty inches to one hundred sixty-eight inches (120.0 in. to 168.0 in.).

The FAS envelope and the FASL envelope are only valid for a thrust bearing radius R_{TB} in a range from ten inches to twenty-seven inches (10 in. to 27 in.). In some aspects, the thrust bearing radius R_{TB} is in a range from twelve inches to twenty-seven inches (12 in. to 27 in.). In some aspects, the thrust bearing radius R_{TB} is in a range from fourteen inches to twenty-seven inches (14 in. to 27 in.). The thrust bearing radius R_{TB} defines the amount of space, or the volume available for the fan actuation system. Increasing the thrust bearing radius R_{TB} provides more space for the fan actuation system but sacrifices aerodynamic performance by making the fan hub radius ratio (i.e., the ratio of the fan hub radius to the fan blade radius) larger. Decreasing the thrust bearing radius R_{TB} reduces the fan hub radius ratio and reduces the size of the turbofan engine but provides less space to carry the loads from the fan blades. The thrust bearing radius R_{TB} reflects the need for adequately accommodating the diameter needed for packaging the fan actuation system but without overly sacrificing aerodynamic performance of the turbofan engine. In embodiments for a ducted engine (e.g., the turbofan engine 110 of FIG. 1), the thrust bearing radius R_{TB} is in a range from twelve inches to nineteen inches (12 in. to 19 in.). In some aspects for a ducted engine, the thrust bearing radius R_{TB} is in a range from fourteen inches to nineteen inches (14 in. to 19 in.). In embodiments for an open fan engine (e.g., the turbofan engine 210 of FIG. 2), the thrust bearing radius R_{TB} is in a range from ten inches to twenty-seven inches (10 in. to 27 in.). In some aspects for an open fan engine (e.g., the turbofan engine 210 of FIG. 2), the thrust bearing radius R_{TB} is in a range from twelve inches to twenty-seven inches (12 in. to 27 in.). In some aspects for an open fan engine, the thrust bearing radius R_{TB} is in a range from nineteen inches to twenty-seven inches (19 in. to 27 in).

The FAS envelope and the FASL envelope are valid for a cruise Mach number M_{cruise} in a range from 0.7 to 0.92. In some aspects, the FAS envelope and the FASL envelope are valid for a cruise Mach number M_{cruise} in a range from 0.7 to 0.9. As mentioned above, turbofan engines operate at higher cruise speeds than turboprop engines. At higher cruise speeds, the aerodynamic loads on fan blades increase, thereby requiring more torque for actuating blades in pitch. This means a larger actuation system is needed to handle the higher reaction loads resulting when a torque is applied in flight to change the blade pitch, to move the blade to a feathered position, or coarse/fine pitch changes. The cruise Mach number M_{cruise} reflects this higher loading environment when pitching fan blades. In some aspects, the cruise Mach number M_{cruise} in a range from 0.75 to 0.9. In some aspects, the cruise Mach number M_{cruise} is in a range from 0.8 to 0.88.

The FAS envelope and the FASL envelope are only valid for a fan hub axial length A_{FH} of twenty-five inches to eighty-five inches (25 in. to 85 in.). In some aspects, the FAS envelope and the FASL envelope are only valid for a fan hub axial length A_{FH} of twenty-five inches to seventy-five inches (25 in. to 75 in.). In some aspects, the FAS envelope and the FASL envelope are only valid for a fan hub axial length A_{FH} of forty inches to eighty-five inches (40 in. to 85 in.). The fan hub axial length A_{FH} defines the amount of axial space, or the volume available for the fan actuation system, forward of the pitch axis P of the fan blades 140. Increasing the fan hub axial length A_{FH} provides more space for the fan actuation system but increases the overall weight of the turbofan engine. Decreasing the fan hub axial length A_{FH} reduces the fan performance and the pressure distribution to the fan due to a smaller axial length for the aerodynamic flow lines into the fan hub but provides less axial space to fit the fan actuation system within the fan hub 148. The fan hub axial length A_{FH} reflects the need for aerodynamic performance for the fan and adequately accommodating the axial length needed for packaging the fan actuation system but without overly sacrificing aerodynamic performance of the turbofan engine and allowing for a more efficient fan actuation system. In embodiments for a ducted engine (e.g., the turbofan engine 110 of FIG. 1), the fan hub axial length A_{FH} is in a range from twenty-five inches to forty inches (25 in. to 40 in.). In some aspects for an open fan engine (e.g., the turbofan engine 210 of FIG. 2), the fan hub axial length A_{FH} is in a range from twenty-five inches to seventy-five inches (25 in. to 75 in). In some aspects for an open fan engine (e.g., the turbofan engine 210 of FIG. 2), the fan hub axial length A_{FH} is in a range from forty inches to eighty-five inches (40 in. to 85 in). In this way, the fan hub axial length A_{FH} is greater for open fan engines as compared to ducted fan engines as more space is needed due to the longer fan blades of the open fan engines as compared to the ducted engines.

The FAS envelope and the FASL envelope are only valid for a fan bearing axial length A_{FB} of ten inches to twenty-three inches (10 in. to 23 in.). In some aspects, the FAS envelope and the FASL envelope are only valid for a fan bearing axial length A_{FB} of sixteen inches to twenty-three inches (16 in. to 23 in.). The fan bearing axial length A_{FB} defines the amount of axial space, or the volume available for the fan actuation system, aft of the pitch axis P of the fan blades 140. Increasing the fan bearing axial length A_{FB} provides more space for the fan actuation system but increases the overall weight of the engine and increases loads on the bearings. Decreasing the fan bearing axial length A_{FB} decreases overall engine weight and reduces loads on the bearings but provides less axial space to fit the fan actuation system within the fan hub 148. The fan bearing axial length A_{FB} reflects the need for adequately accommodating the axial length needed for packaging the fan actuation system while minimizing the fan bearing axial length A_{FB} to reduce loads on the bearings and reduce overall weight of the engine. In embodiments for a ducted engine (e.g., the turbofan engine 110 of FIG. 1), the fan hub axial length A_{FH} is in a range from seventeen inches to twenty inches (17 in. to 20 in.). In embodiments for an open fan engine (e.g., the turbofan engine 210 of FIG. 2), the fan hub axial length A_{FH} is in a range from ten inches to twenty-three inches (10 in. to 23 in). In some aspects for an open fan engine (e.g., the turbofan engine 210 of FIG. 2), the fan hub axial length A_{FH} is in a range from sixteen inches to twenty-three inches (16 in. to 23 in).

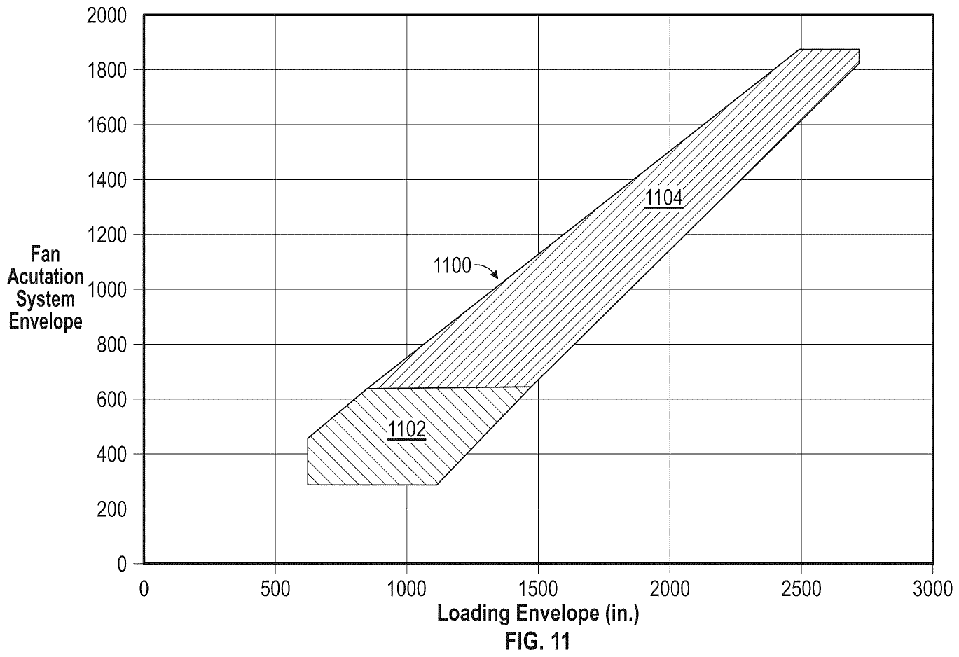

FIG. 11 represents, in graph form, the FAS envelope as a function of the loading envelope (N_{FB}×D_{FT}×M_{cruise}). An area 1100 represents the boundaries of the FAS envelope. The FAS envelope is in a range from three hundred to one thousand eight hundred sixty (300 to 1860) for a loading envelope in a range from five hundred eighty-eight inches to two thousand seven hundred twenty-two inches (588 in. to 2722 in.). Table 1 and FIG. 11 show that the FAS envelope increases as the loading envelope increases. In this way, the FAS envelope increases as the number of fan blades N_{FB}, the fan tip diameter D_{FT}, or the cruise Mach number M_{cruise} increase. The range of the FAS envelope identifies the specific architectures that can accommodate the fan pitch actuation system, accounting for both the mechanisms and structural load paths needed to pitch the fan blades under an aerodynamic loading, but without exceeding the volume available for packaging the pitch actuation system within the limited space of a turbofan engine.

A first area 1102 represents the boundaries of the FAS envelope for ducted engines, such as, for example, the turbofan engine 110 of FIG. 1. A second area 1104 represents the boundaries of the FAS envelope for unducted fan engines, such as, for example, the turbofan engine 210 of FIG. 2. Ducted engines tend to have more limited space for the fan actuation system due to the presence of a fan casing, fan duct, or outer nacelle. On the other hand, the fan actuation system of ducted engines are expected to experience lower loads associated with supporting fan blades and pitching fan blades due to the fan blades having a smaller diameter compared to an open fan engine. The FAS envelope, represented by the first area 1102, is in a range from three hundred to six hundred sixty (300 to 660) for ducted engines. The FAS envelope, represented by the second area 1104, is in a range from six hundred sixty to one thousand eight hundred sixty (660 to 1860) and, preferably, in a range from six hundred sixty to one thousand twenty (660 to 1020) and includes open fan engines.

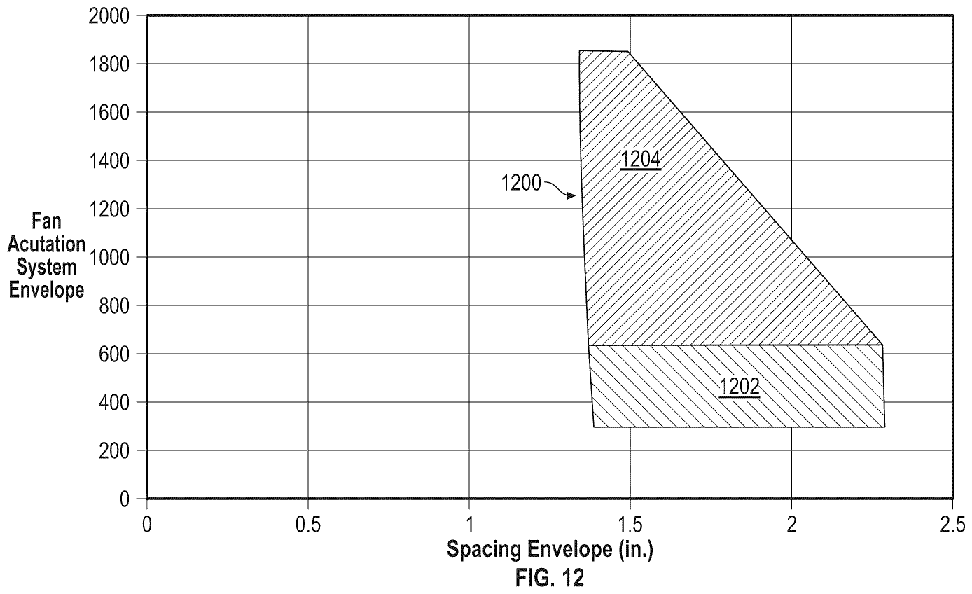

FIG. 12 represents, in graph form, the FAS envelope as a function of the spacing envelope (R_{TB}/N_{FB}). An area 1200 represents the boundaries of the FAS envelope. The FAS envelope is in a range from three hundred to one thousand eight hundred sixty (300 to 1860) for a spacing envelope in a range from one point three five inches to two point two five inches (1.35 in. to 2.25 in.). Table 1 and FIG. 12 show that the FAS envelope decreases as the spacing envelope increases. In this way, the FAS envelope decreases as the thrust bearing radius R_{TB} increases or the number of fan blades N_{FB} decreases. A first area 1202 represents the boundaries of the FAS envelope for ducted engines and is in a range from three hundred to six hundred sixty (300 to 660) for ducted engines, as detailed above. A second area 1204 represents the boundaries of the FAS envelope for unducted fan engines and is in a range from six hundred sixty to one thousand eight hundred sixty (660 to 1860) and, preferably, in a range from six hundred sixty to one thousand twenty (660 to 1020), as detailed above.

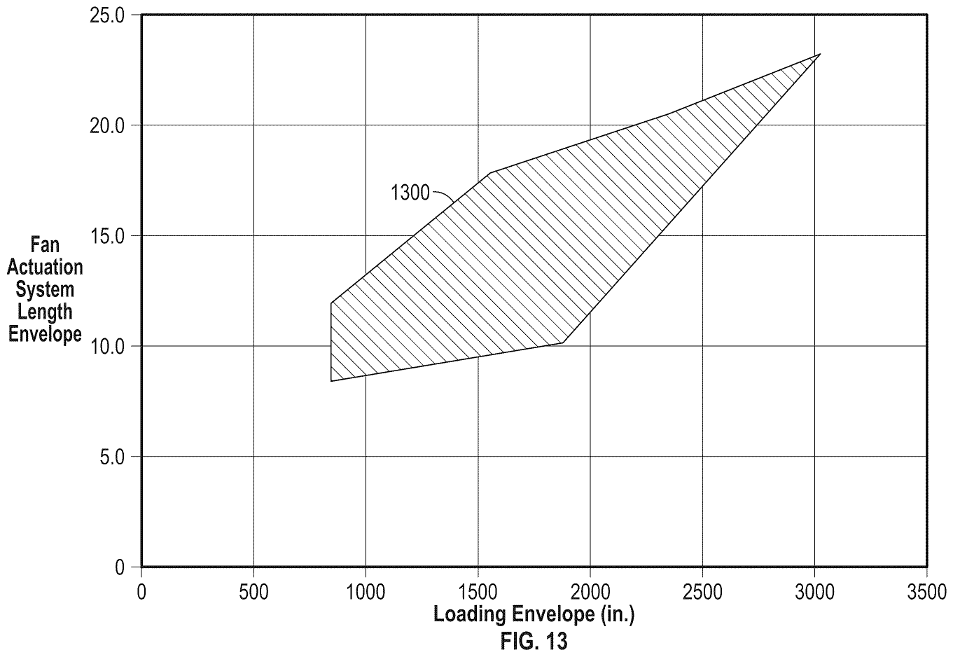

FIG. 13 represents, in graph form, the FASL envelope as a function of the loading envelope (N_{FB}×D_{FT}). An area 1300 represents the boundaries of the FASL envelope. The FASL envelope is in a range from eight point five to twenty-four (8.5 to 24) for a loading envelope in a range from eight hundred forty inches to three thousand twenty-four inches (840 in. to 3,024 in.). Table 1 and FIG. 13 show that the FASL envelope increases as the loading envelope increases. In this way, the FASL envelope increases as the number of fan blades N_{FB} or the fan tip diameter D_{FT} increase. The range of the FASL envelope identifies the specific architectures that can accommodate the fan pitch actuation system, accounting for both the mechanisms and structural load paths needed to pitch the fan blades under an aerodynamic loading, but without exceeding the volume available for packaging the pitch actuation system within the limited space of a turbofan engine. As mentioned above, ducted engines tend to have more limited space for the fan actuation system due to the presence of a fan casing, fan duct, or outer nacelle, while experiencing lower loads associated with supporting fan blades and pitching fan blades due to the fan blades having a smaller diameter compared to an open fan engine. For ducted engines, the FASL envelope is in a range from eight point five to thirteen (8.5 to 13).

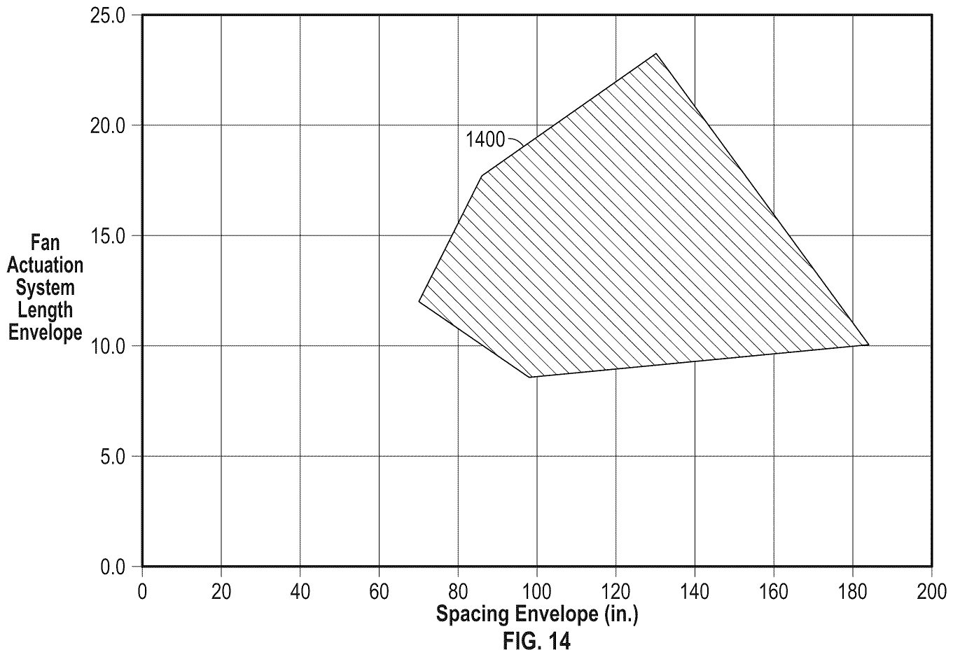

FIG. 14 represents, in graph form, the FASL envelope as a function of the spacing envelope L_{AXIAL}×(R_{TB}/N_{FB}). An area 1400 represents the boundaries of the FASL envelope. The FASL envelope is in a range from eight point five to twenty-four (8.5 to 24) for a spacing envelope in a range from seventy square inches to one hundred eighty-five square inches (70 in.² to 185 in.²). Table 1 and FIG. 14 show that the FASL envelope decreases as the spacing envelope increases. In this way, the FASL envelope decreases as the thrust bearing radius R_{TB} increases, or the number of fan blades N_{FB} or the axial length L_{AXIAL} decreases. As mentioned above, for ducted engines, the FASL envelope is in a range from eight point five to thirteen (8.5 to 13).

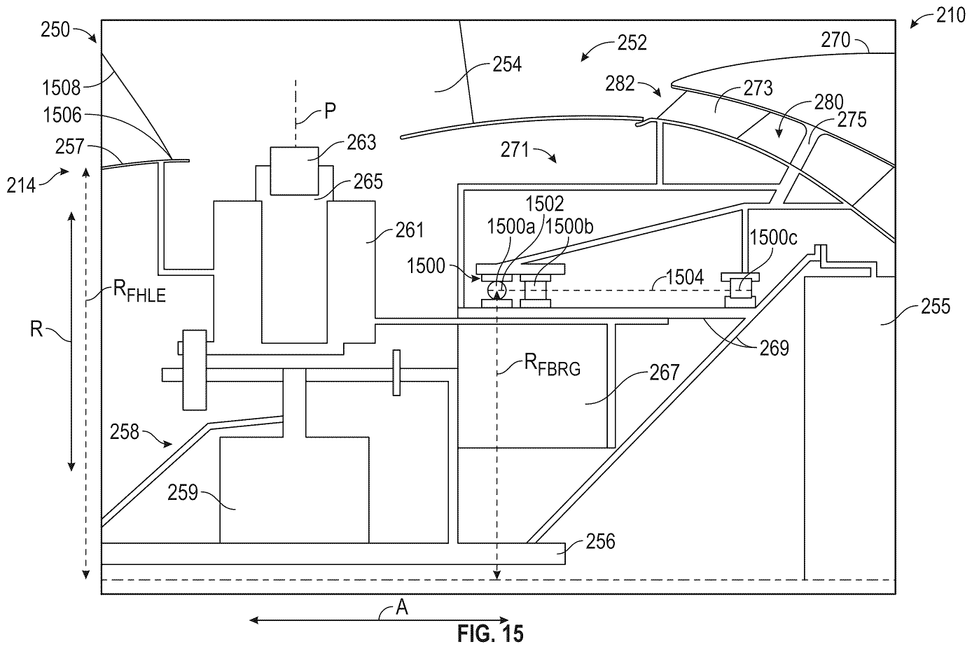

The FAS envelope and the FASL envelope herein provide a fan actuation system a low fan hub radius ratio (a ratio of the hub radius of the blades to the tip radius of the blades of the fan) and a high fan blade count. In one example, a low hub fan radius ratio is in a range from 0.22 to 0.30. This allows the fan diameter to be minimized to meet competing efficiency and installation requirements. To further enable a low fan hub radius ratio, the turbofan engine can include a relatively high fan bearing radius relative to the fan hub radius, as detailed further below with respect to FIGS. 15 to 20. Such a high fan bearing radius allows for a desired packaging of, e.g., the fan actuation system and the fan counterweights. The increased fan bearing radius allows the fan bearings to carry the forward thrust load of the turbofan engine while minimizing, e.g., any moments on the fan bearings in the event of a variation in a distribution of the forward thrust load on the fan bearings. In this way, the high fan bearing radius allows for a variable pitch fan (e.g., the inclusion of a fan actuation system) while maintaining a low fan hub radius ratio and a smaller outer casing, which provides for less drag and a larger frontal area for a given fan blade size.

FIG. 15 is a schematic view of the forward end 214 of the fan assembly 250 of the turbofan engine 210 of FIG. 2. As depicted in FIG. 15, each fan blade 254 defines a base 263 at an inner end along a radial direction R. Each fan blade 254 is coupled at the base 263 to a disk 261 via a trunnion mechanism 265. In FIG. 15, the base 263 is configured as a dovetail received within a correspondingly shaped dovetail slot of the trunnion mechanism 265. In other aspects, the base 263 may be attached to the trunnion mechanism 265 in any other suitable manner. For example, the base 263 may be attached to the trunnion mechanism 265 using a pinned connection, or any other suitable connection. In still other aspects, the base 263 may be formed integrally with the trunnion mechanism 265. Notably, the trunnion mechanism 265 facilitates rotation of a respective fan blade 254 about the pitch axis P of the respective fan blades 254. The fan assembly 250 can also include one or more fan counterweights 267 to balance the fan 252 during operation. Further, the disk 261 is attached to the gearbox assembly 255 through the fan shaft 256, which includes one or more individual structural members 269.

The fan assembly 250 includes a fan frame 271 that is connected to the fan cowl 270 through an inlet vane 273 and a strut 275. In this way, the fan frame 271 is a static or a stationary component that supports static components of the fan assembly 250. While the fan frame 271 is depicted as being connected to the fan cowl 270 through both the inlet vane 273 and the strut 275, the fan frame 271 can be connected to the fan cowl 270 through at least one of the inlet vane 273 or the strut 275.

The fan assembly 250 also includes one or more fan bearings 1500 for supporting rotation of the various rotating components of the fan assembly 250, such as the plurality of fan blades 254 via the fan shaft 256 and the disk 261. More particularly, the various rotating components of the fan assembly 250 rotate with respect to the fan frame 271 via the one or more fan bearings 1500. In FIG. 15, the one or more fan bearings 1500 includes a first fan bearing 1500a, a second fan bearing 1500b, and a third fan bearing 1500c. The first fan bearing 1500a is a ball bearing, the second fan bearing 1500b is a roller bearing, and the third fan bearing 1500c is a roller bearing. The first fan bearing 1500a is positioned forward of the second fan bearing 1500b and the third fan bearing 1500c. The fan bearings 1500 can include any other suitable number or type of bearings for supporting rotation of the plurality of fan blades 254. For example, the one or more fan bearings 1500 can include a pair (two) tapered roller bearings, or any other suitable bearings.

Referring still to FIG. 15, the one or more fan bearings 1500 are located axially aft of the disk 261 and the trunnion mechanisms 265 and radially outward of the one or more actuators 259 along the radial direction R and also outward of the one or more fan counterweights 267 along the radial direction R. In particular, the fan bearings 1500 are located axially between the disk 261 and the gearbox assembly 255. Such a configuration of the fan bearings 1500 allows for the actuators 259 to be axially aligned with the disk 261 and the trunnion mechanisms 265 along the axial direction A and radially inward of the disk 261 and the trunnion mechanisms 265 along the radial direction R. Moreover, such a configuration allows for the one or more fan counterweights 267 to be positioned adjacent to the one or more actuators 259.

As shown in FIG. 15, the one or more fan bearings 1500 define a fan bearing radius R_{FBRG} along the radial direction R. The fan bearing radius R_{FBRG} is defined as a distance along the radial direction R from the longitudinal centerline axis 212 of the turbofan engine 210 to a central axis or a center point of the one or more fan bearings 1500. More particularly, each of the first fan bearing 1500a, the second fan bearing 1500b, and the third fan bearing 1500c are radially aligned such that a center point 1502 of the first fan bearing 1500a and a central axis 1504 of the second fan bearing 1500b and the third fan bearing 1500c are each positioned at the same radial distance from the longitudinal centerline axis 212. In some aspects, one or more of the fan bearings 1500 may be stepped or otherwise positioned at different distances from the longitudinal centerline axis 212 along the radial direction R. In such aspects, the fan bearing radius R_{FBRG} refers to a radius of the innermost fan bearing 1500 along the radial direction R (i.e., a distance of the central point 1502 or the center axis 1504 of the innermost fan bearing 1500 along the radial direction R to the longitudinal centerline axis 212).

The fan hub 257 defines a fan hub leading edge radius R_{FHLE} along the radial direction R. The fan hub leading edge radius R_{FHLE} is defined as a radial distance of an outermost point of the fan hub 257 along the radial direction R to the longitudinal centerline axis 212 of the turbofan engine 210. In particular, the fan hub leading edge radius R_{FHLE} is a distance along the radial direction R from the longitudinal centerline axis 212 to a radially innermost point 1506 of a leading edge 1508 of the fan blades 254 (to the fan root 251 at the leading edge 1508. The fan hub leading edge radius R_{FHLE} is indicative of an overall size of a core portion of the fan assembly 250. Accordingly, the fan assembly 250 defines a fan bearing radius ratio R_{FHLE}:R_{FBRG} (i.e., a ratio of the fan hub leading edge radius R_{FHLE} to the fan bearing radius R_{FBRG}) in a range from 1.0 to 2.75. In some aspects, the fan bearing radius ratio is less than or equal to 2.75, such as less than or equal to 2.5, such as less than or equal to 2.0, such as less than or equal to 1.75. More particularly, the hub radius to fan bearing radius ratio R_{FHLE}:R_{FBRG} is greater than or equal to 1.0 and less than or equal to 1.5.

The plurality of fan blades 254 are rotatable about the axial direction A at a maximum rotational speed during operation of the fan assembly 250. The maximum rotational speed refers to a maximum speed at which the fan blades 254 are configured to rotate during a full power condition of the turbofan engine 210, such as when the turbofan engine 210 is generating a maximum takeoff thrust. The one or more fan bearings 1500 supporting rotation of the plurality of fan blades 254 may define a DN value during operation of the fan assembly 250 and rotation of the plurality of fan blades 254 at the maximum rotational speed of at least about 0.6 million. For example, in certain exemplary embodiments, the one or more fan bearings 1500 supporting rotation of the plurality of fan blades 254 may define a DN value during rotation of the plurality of fan blades 254 of at least 0.7 million, at least 0.8 million, at least 1 million, or at least 1.5 million. As used herein, the term “DN value” refers to a fan bearing speed quantifier calculated by multiplying a bore of the bearing in millimeters by a rotational speed in revolutions per minute (RPM). The bore of the one or more fan bearings 1500 supporting rotation of the plurality of fan blades 254 of the fan assembly 250 refers to a distance from the longitudinal centerline axis 112 to an inner race of the one or more fan bearings 1500.

Accordingly, in order to maintain the DN value of the one or more fan bearings 1500 below one or more of the above stated DN values, the fan assembly 250 may define a relatively low maximum rotational speed during operation. For example, in certain exemplary embodiments, the fan assembly 250 may define a maximum rotational speed in a range from 300 RPM to 8,500 RPM during operation. In some aspects, the maximum rotational speed is less than 8,500 RPM during operation. More specifically, in certain exemplary embodiments, the fan assembly 250 may define a maximum rotational speed of less than 8,000 RPM during operation, less than 7,500 rpm during operation, less than 7,000 RPM during operation, less than 6,500 rpm during operation, or less than 6,000 RPM during operation. In some aspects, the maximum rotational speed is in a range from 300 RPM to 1,100 RPM during operation.

As discussed above, inclusion of a relatively high fan bearing radius relative to a fan hub radius may allow for a desired packaging of, e.g., the fan actuation system and one or more fan counterweights in the fan assembly of the turbofan engine. Moreover, when the turbofan engine is an indirect drive turbofan engine (e.g., including a gearbox connecting a driveshaft and a fan shaft while reducing a rotational speed of the fan shaft relative to the driveshaft) the increased fan bearing radius may additionally provide for a more stable fan during operation. Specifically, with direct drive turbofan engine (e.g., without a gearbox), a forward thrust load generated by the fan during operation may be counteracted by a reverse thrust load generated by the turbine section of the turbofan engine (the turbine section being directly connected to the fan via a shaft in such a configuration). By contrast, within an indirect drive turbofan engine, such as the turbofan engine 110 depicted in FIG. 1 and the turbofan engine 210 in FIG. 2, the forward ball bearing (e.g., the first fan bearing 1500a) is required to carry substantially all of an amount of forward thrust generated by the fan during operation, as the gearbox assembly prevents the LP shaft from offsetting such forward thrust load of the fan with a reverse thrust load of the turbine section. Accordingly, the increased fan bearing radius allows the one or more fan bearings to carry the forward thrust load while minimizing, e.g., any moments on such one or more fan bearings in the event of a variation in a distribution of the forward thrust load on the one or more fan bearings.

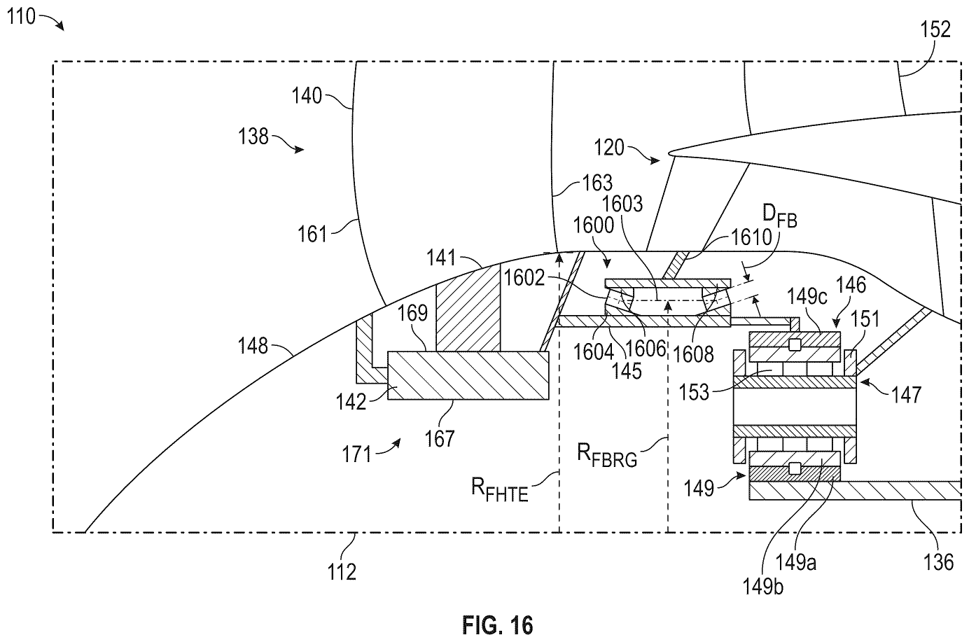

FIG. 16 is an enlarged, schematic, cross-sectional diagram of the turbofan engine 110 of FIG. 1 and having one or more fan bearings 1600, taken along the longitudinal centerline axis 112, according to the present disclosure. While FIG. 16 shows the turbofan engine 110 of FIG. 1, the fan bearings 1600 can also be implemented in the turbofan engine 210 of FIG. 2. FIG. 16 shows one fan blade 140 of the fan 138, the fan disk 142, the core inlet 120, and the gearbox assembly 146. Further, although not shown for clarity, the turbofan engine 110 can include any of the fan actuation systems disclosed herein.

The fan shaft 145 is coupled to the fan disk 142 such that rotation of the fan shaft 145 causes the plurality of fan blades 140 to rotate about the longitudinal centerline axis 112. Each of the fan blades 140 extends from a leading edge 161 and a trailing edge 163. The fan root 141 is at the fan hub 148. The fan disk 142 is defined between an inner surface 167 and an outer surface 169. The inner surface 167 is a radially-most inner surface of the fan disk 142 and the outer surface 169 is a radially-most outer surface of the fan disk 142. The fan disk 142 includes a disk bore 171 defined by the inner surface 167 of the fan disk 142. In particular, the disk bore 171 is defined from the longitudinal centerline axis 112 to the inner surface 167. The fan hub 148 includes a fan hub trailing edge radius R_{FHTE} that is defined in the radial direction from the longitudinal centerline axis 112 to the fan hub 148 at the trailing edge 163 of the fan blades 140.

The turbofan engine 110 also has a fan hub radius ratio that is defined as a ratio of the fan hub trailing edge radius R_{FHTE} to a fan tip radius of the fan blades 140 (e.g., the radius from the longitudinal centerline axis 112 to the fan tip 143 at the trailing edge 163 of the fan blades 140). The fan hub radius ratio is in a range from 0.1 to 0.4. Lower fan hub radius ratios result in lower core engine inlets. A lower fan hub radius and a lower core engine inlet radius result in a core engine with a lesser diameter (e.g., smaller core engine), and, thus, a reduced overall engine weight, as compared to turbofan engines with fan hub radius ratios greater than 0.4. In some aspects, the fan hub radius ratio is in a range from 0.15 to 0.32. In some aspects, the fan hub radius ratio is in a range from 0.2 to 0.35. In some aspects, the fan hub radius ratio is in a range from 0.2 to 0.3. The lower fan hub can also reduce the probability of foreign object damage (FOD), such as, for example, from bird strikes, in the core engine, as the fan tends to push the foreign objects radially outward by the centripetal force imparted to the foreign object by the spinning fan blades. A lower fan hub also improves aerodynamic efficiency of the fan. The lower fan hub radius ratios disclosed herein are enabled by the fan actuation system being characterized by the FASL as detailed above. In particular, the FASL enables a smaller fan actuation system to fit within a tighter packaging underneath the fan while ensuring the fan actuation system can provide an adequate force or torque to pitch the fan blades in the higher loading environment of a turbofan engine (as compared to a turboprop engine). In this way, if the fan actuation system has a FASL that falls within the ranges detailed above, the fan hub radius ratio can be made lower to achieve the improved aerodynamic efficiency of the fan in guiding the incoming airflow into the core inlet.

The fan bearings 1600 are radial thrust (radial shaft load) bearings that transmit a load (e.g., the radial shaft load) from the fan shaft 145 to a static structure of the turbofan engine 110. The fan bearings 1600 each includes one or more rolling elements 1602, an inner race 1604, and an outer race 1606. The fan bearings 1600 support rotation of the fan shaft 145. In FIG. 16, fan bearings 1600 include a forward fan bearing and an aft fan bearing. The rolling elements 1602 are tapered rolling elements that include tapered cylindrical bodies and are disposed between the inner race 1604 and the outer race 1606. In this way, the one or more fan bearings 1600 are roller bearings. The outer race 1606 of each of the fan bearings 1600 is connected to a fan bearing support member 1608. The fan bearing support member 1608 is connected to a fan bearing housing 1610 that is connected to a static component of the turbofan engine 110. The inner race 1604 is connected to the fan shaft 145. In this way, the fan bearings 1600 are connected to the static component and to the fan shaft 145 such that the inner race 1604, and the rolling elements 1602, rotates with respect to the outer race 1606, such that the fan bearings 1600 support rotation of the fan shaft 145.

The fan bearings 1600 are positioned aft, and radially outward, of the fan disk 142. In particular, the fan bearings 1600 are positioned entirely axially aft of the fan disk 142 and entirely radially outward of the fan disk 142 (e.g., radially outward of the outer surface 169 of the fan disk 142). In this way, the fan bearings 1600 are positioned radially outward of the disk bore 171 (e.g., of the inner surface 167) of the fan disk 142. The fan bearings 1600 are positioned axially between the fan disk 142 and the gearbox assembly 146. Further, the fan bearings 1600 are positioned radially outward of the gearbox assembly 146, particularly, radially outward of the third gear 149c.

The fan bearings 1600 have a fan bearing radius R_{FBRG} that is defined in the radial direction from the longitudinal centerline axis 112 to a radial center 1603 of the fan bearings 1600. Particularly, the radial center 1603 of the fan bearings 1600 is the radial center 1603 of the rolling elements 1602. The fan bearings 1600 also have a rolling element diameter D_{FB} of the rolling elements 1602 that is defined as a distance of a straight line passing from side to side of a respective rolling element 1602 through a center (e.g., the radial center 1603) of the respective rolling element 1602.

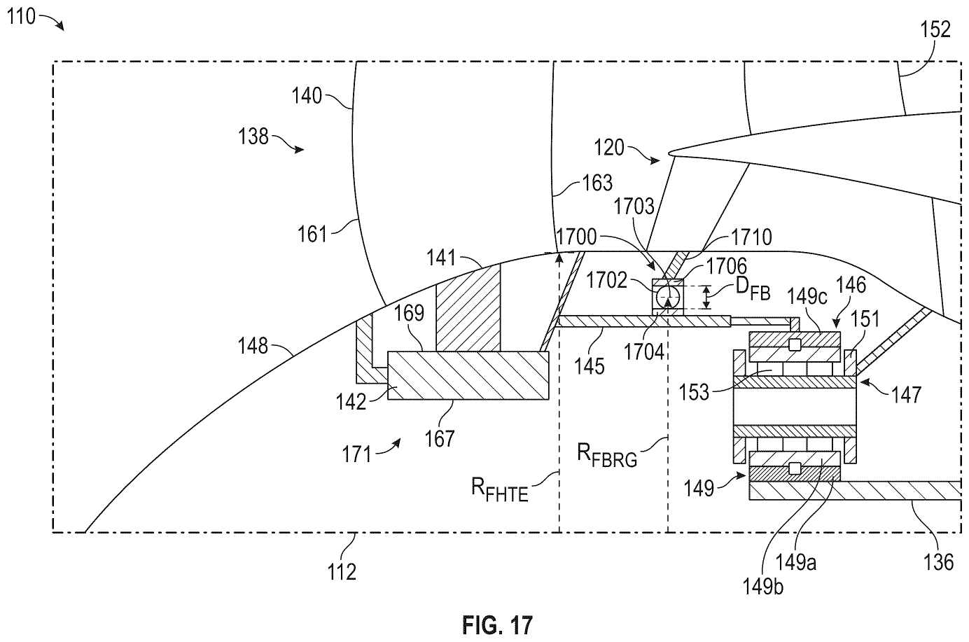

FIG. 17 is an enlarged, schematic, cross-sectional diagram of the turbofan engine 110 and having one or more fan bearings 1700, taken along the longitudinal centerline axis 112, according to another aspect. The fan bearings 1700 are substantially similar to the fan bearings 1600 of FIG. 16. The same reference numerals will be used for components of the fan bearings 1700 that are the same as or similar to the components of the fan bearings 1600 discussed above. The description of these components above also applies to this embodiment, and a detailed description of these components is omitted here.

The fan bearings 1700 each includes one or more rolling elements 1702, an inner race 1704, and an outer race 1706. The fan bearings 1700 support rotation of the fan shaft 145. The rolling elements 1702 are balls that are disposed between the inner race 1704 and the outer race 1706. In this way, the fan bearings 1700 are ball bearings. The turbofan engine 110 also includes a fan bearing housing 1710.

The fan bearings 1700 are positioned aft, and radially outward, of the fan disk 142. In particular, the fan bearings 1700 are positioned entirely axially aft of the fan disk 142 and entirely radially outward of the fan disk 142 (e.g., radially outward of the outer surface 169 of the fan disk 142). In this way, the fan bearings 1700 are positioned radially outward of the disk bore 171 (e.g., of the inner surface 167) of the fan disk 142. The fan bearings 1700 are positioned axially between the fan disk 142 and the gearbox assembly 146. Further, the fan bearings 1700 are positioned radially outward of the gearbox assembly 146, particularly, radially outward of the third gear 149c.

The fan bearings 1700 have a fan bearing radius R_{FBRG} that is defined in the radial direction from the longitudinal centerline axis 112 to a radial center 1703 of the fan bearings 1700 (e.g., of the rolling elements 1702). The fan bearings 1700 also have a rolling element diameter D_{FB} of the rolling elements 1702 that is defined as a distance of a straight line passing from side to side of a respective rolling element 1702 through a center (e.g., the radial center 1703) of the respective rolling element 1702.

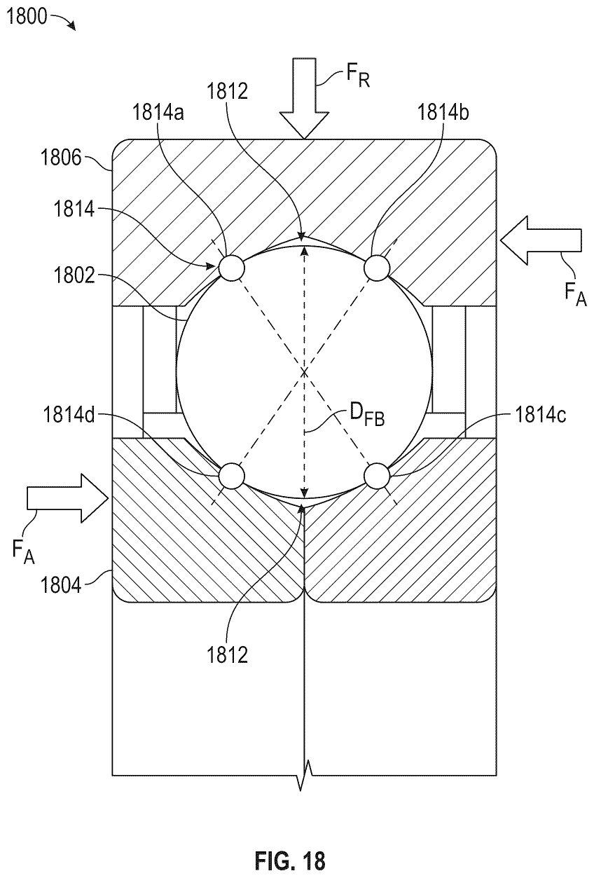

FIG. 18 is a schematic cross-sectional view of a fan bearing 1800 for the turbofan engine 110, according to another aspect. The fan bearing 1800 can be utilized as any of the fan bearings detailed herein. The fan bearing includes one or more rolling elements 1802, an inner race 1804, and an outer race 1806. In some embodiments, the inner race 1804 has a split ring configuration to facilitate easier mounting of the bearing and improved precision. In some embodiments, each of the inner race 1804 and the outer race 1806 defines a concavity having an arch 1812 to allow the rolling element 1802 to have four contact points 1814 with the inner race 1804 and the outer race 1806. In particular, the fan bearing 1800 has two contact points, including a first contact point 1814a and a second contact point 1814b, on the outer race 1806 and two contact points, including a third contact point 1814c and a fourth contact point 1814d, on the inner race 1804. In this way, the fan bearing 1800 is a four-point contact ball bearing. The four-point contact design allows the fan bearing 1800 to handle both radial loads FR and axial loads FA by transmitting the load between the second contact point 1814b and the fourth contact point 1814d, and between the first contact point 1814a and the third contact point 1814c.

In some embodiments, the fan bearing 1800 has a tight bearing configuration, i.e., there is minimal clearance between the rolling elements 1802 and the inner race 1804 and the outer race 1806. In particular, the clearance between the rolling elements 1802 and the inner race 1804 and the outer race 1806 is dimensioned to limit axial movement of the fan shaft 145 (FIG. 1) in relation to the gearbox assembly 146 (FIG. 1) to no greater than 0.010 inches or 10 mil. In some embodiments, the clearance between the rolling elements 1802 and the inner race 1804 and the outer race 1806 is dimensioned to limit axial movement of the fan shaft 145 to no greater than 0.007 inches or 7 mil. The fan bearing 1800 limits axial endplay, i.e., axial movement of the fan shaft 145 in relation to the gearbox assembly 146, thus protecting the gearbox assembly 146 from excessive stress and facilitating a reduction in size and extension of the life of the gearbox assembly 146.

The fan bearing 1800 is designed to withstand extreme conditions including high temperatures, high loads, and high rotational speeds. The materials used to construct the fan bearing 1800 are selected to maximize durability, temperature resistance, and fatigue life. In some embodiments, the fan bearing 1800 can be formed from steel, steel alloys, ceramic materials, cobalt and nickel-based superalloys, or polytetrafluoroethylene (PTFE) and phenolic resins. In addition, the fan bearing 1800 may include coatings, such as, for example, titanium nitride or other anti-friction coatings to further reduce wear and to minimize friction.

The fan bearings of FIGS. 15 to 18 are designed to address the problem of sizing the fan bearings to account for the stresses encountered from the fan shaft, while balancing for minimizing the space under the fan for the fan bearings and other fan components, as well as providing a required amount of thrust for a particular size of the turbofan engine. Additionally, the fan bearings address the challenge in reducing the inner radius of the engine flow path and lowering the fan hub radius ratio, while increasing the fan bearing radius.

Moving the fan bearings aft of the fan disk and increasing the fan bearing radius provide for a reduction in the inner radius of the flow path and the fan hub radius, without overly increasing the heat load on the fan bearings. Further, moving the fan bearings radially outward enables a greater number of rolling elements, which results in a reduced rolling element diameter.

The set of novel embodiments detailed herein include several different architectures of fan bearings and turbofan engines with various sizes and locations. A set of fan bearing designs, producing favorable results, can be characterized by a combination of the fan hub trailing edge radius, the fan bearing radius, the rolling element diameter, and the takeoff thrust, capable of differentiating an architecture that satisfies the operational requirements (e.g., fan bearings capable of handling the stresses from the fan shaft) and the packaging requirements (e.g., lowering the fan hub radius and the inner radius of the flow path) from an architecture that does not satisfy these requirements. As such, a finite and readily ascertainable number of embodiments of the fan bearings account for the operational requirements and the packaging requirements without overly increasing the fan bearing heat load. The novel designs are based on a size of the fan bearings, a size of the rolling elements, and a location of the fan bearings that can reduce the size and the weight of the turbofan engine, while accounting for the factors discussed above. These novel designs can be characterized as a fan bearing envelope (FBE), as set forth in expression (3):

$$FBE = ( \frac{{R}_{FBRG}}{{R}_{FHTE}} ) \times ( \frac{{D}_{FB}}{( \frac{{Thrust}_{TO}}{1000} )} ) . \qquad ( 3 )$$

In expression (3), R_{FBRG} is the fan bearing radius, R_{FHTE} is the fan hub trailing edge radius, D_{FB} is the rolling element diameter, and Thrust_{TO} is the takeoff thrust of the turbofan engine. The takeoff thrust Thrust_{TO} is a high-power operation (e.g., greater than 85% of the SLS maximum engine rated thrust) of the turbofan engine during a takeoff condition of the aircraft.

As discussed further below, the fan bearings include fan bearing designs for different turbofan engine architectures that accounts for handling the stresses from the fan shaft during operation, while reducing the fan hub radius, and, thus, providing for an improved specific flow through the fan and reducing the fan diameter required to achieve a certain thrust or reduces the fan pressure ratio and improves propulsive efficiency of the fan. These improved fan bearing designs can be characterized according to a defined range for the FBE.

Table 2 below represents exemplary embodiments 16 to 27 and their corresponding FBE values for various turbofan engines and fan bearings. Embodiments 16 to 27 may represent the turbofan engine 110 of FIG. 1 (e.g., ducted engine) or the turbofan engine 210 of FIG. 2 (e.g., unducted fan engine) and can be applied to any of the fan bearings detailed herein. In Table 2, the FBE values were determined based on expression (3) described above, and using fan hub trailing edge radius, fan bearing radius, fan bearing diameter values in millimeters and takeoff thrust values in kilo-Newtons. In particular, embodiments 16, 17, 22, 24, and 26 are tapered roller bearings (e.g., the fan bearings 1600 of FIG. 16). Embodiments 18 to 21, 23, 25, and 27 are ball bearings (e.g., the fan bearings 1700 of FIG. 17 or the fan bearing 1800 of FIG. 18).

TABLE 2

| | | | | | | Fan Bearing |
|---|---|---|---|---|---|---|
| | R_{FHTE} | R_{FBRG} | R_{FBRG}/ | D_{FB} | Thrust_{TO} | Envelope |
| Emb. | (mm) | (mm) | R_{FHTE} | (mm) | (kN) | (FBE) |
| 16 | 360.934 | 212.09 | 0.588 | 19.05 | 155.688 | 71.901 |
| 17 | 628.396 | 312.42 | 0.497 | 19.05 | 155.688 | 60.834 |
| 18 | 360.934 | 212.09 | 0.588 | 50.80 | 155.688 | 191.735 |
| 19 | 628.396 | 312.42 | 0.497 | 50.80 | 155.688 | 162.224 |
| 20 | 360.934 | 212.09 | 0.588 | 57.15 | 155.688 | 215.702 |
| 21 | 360.934 | 212.09 | 0.588 | 63.50 | 155.688 | 239.669 |
| 22 | 103.124 | 60.60 | 0.588 | 5.00 | 44.482 | 66.050 |
| 23 | 103.124 | 60.60 | 0.588 | 15.00 | 44.482 | 198.151 |
| 24 | 902.335 | 530.23 | 0.588 | 50.80 | 389.220 | 76.694 |
| 25 | 902.335 | 530.23 | 0.588 | 127.00 | 389.220 | 191.735 |
| 26 | 1191.082 | 699.90 | 0.588 | 63.50 | 513.770 | 72.627 |
| 27 | 1191.082 | 699.90 | 0.588 | 170.00 | 513.770 | 194.434 |

The fan bearing designs provide the aforementioned benefits including achieving a lower radius ratio (ratio of hub to fan tip radii) for a rated thrust, or a percentage thereof at takeoff. During the course of creating those designs it was determined what ranges would be suitable to achieve the desired results, while taking into account fan shaft stresses, packaging and accessibility, reliability and lubrication requirements for the engine. The values for terms used to compute an FBE value are strictly limited to certain ranges based on the various designs evaluated where those values had varied. Otherwise, the engine made will not produce the favorable results.

The FBE is only valid for a fan hub trailing edge radius R_{FHTE} in a range from ninety millimeters (90 mm) to one thousand two hundred millimeters (1,200 mm). In some embodiments, the fan hub trailing edge radius R_{FHTE} is in a range from one hundred millimeters (100 mm) to nine hundred millimeters (900 mm). The ranges of the fan hub trailing edge radius R_{FHTE} provide for a fan hub radius ratio that satisfies the operational requirements and the packaging requirements of a particular engine without overly increasing the fan bearing heat load. Values of the fan hub trailing edge radius R_{FHTE} outside of the ranges disclosed herein either have a fan hub radius ratio that is too small such that the fan bearings cannot be packaged under the fan disk or too great such that the aerodynamic efficiency of the fan is reduced.

The FBE is only valid for a fan bearing radius R_{FBRG} in a range from fifty millimeters (50 mm) to seven hundred millimeters (700 mm). In some embodiments, the fan bearing radius R_{FBRG} is in a range from sixty millimeters (60 mm) to five hundred fifty millimeters (550 mm). The ranges of the fan bearing radius R_{FBRG} provide for a lower fan hub radius ratio that satisfies the operational requirements and the packaging requirements of a particular engine without overly increasing the fan bearing heat load. Values of the fan bearing radius R_{FBRG} outside of the ranges disclosed herein either have a fan hub radius ratio that is too small such that the fan bearings cannot be packaged under the fan disk or too great such that the aerodynamic efficiency of the fan is reduced and the heat load on the fan bearings is increased so much that the fan bearings require a great amount of lubricant to cool the fan bearings. Thus, fan bearings having a fan bearing radius R_{FBRG} greater than seven hundred millimeters (700 mm) also result in a greater sized lubrication system, and, thus, results in a heavier turbofan engine.

The FBE is only valid for a radius ratio of the fan bearing radius to the fan hub trailing edge radius (R_{FBRG}/R_{FHTE}) in a range from 0.4 to 1.0. The range of R_{FBRG}/R_{FHTE} provides satisfies the operational requirements and the packaging requirements of a particular engine without overly increasing the fan bearing heat load. Values of the R_{FBRG}/R_{FHTE} outside of the ranges disclosed herein either have a fan hub radius ratio that is too small such that the fan bearings cannot be packaged under the fan disk or too great such that the aerodynamic efficiency of the fan is reduced. In particular, values of R_{FBRG}/R_{FHTE} greater than 1.0 provide for the fan bearings to be radially outward of the fan hub trailing edge, and, thus, reduce the radius of the core engine inlet. Values of R_{FBRG}/R_{FHTE} less than 0.4 provide for fan bearings that require larger rolling elements to account for the stresses, while also increasing the fan hub radius and the inner radius of the flow path.

The FBE is only valid for a rolling element diameter D_{FB} in a range from three millimeters (3 mm) to one hundred fifty millimeters (150 mm). In some embodiments, the rolling element diameter D_{FB} is in a range from five millimeters (5 mm) to one hundred twenty-seven millimeters (127 mm).

The FBE is only valid for a takeoff thrust Thrust_{TO} in a range from forty kilo-Newtons (40 kN) to five hundred twenty-five kilo-Newtons (525 kN). In some embodiments, the takeoff thrust Thrust_{TO} is in a range from forty-four kilo-Newtons (44 kN) to four hundred fifty kilo-Newtons (450 kN).

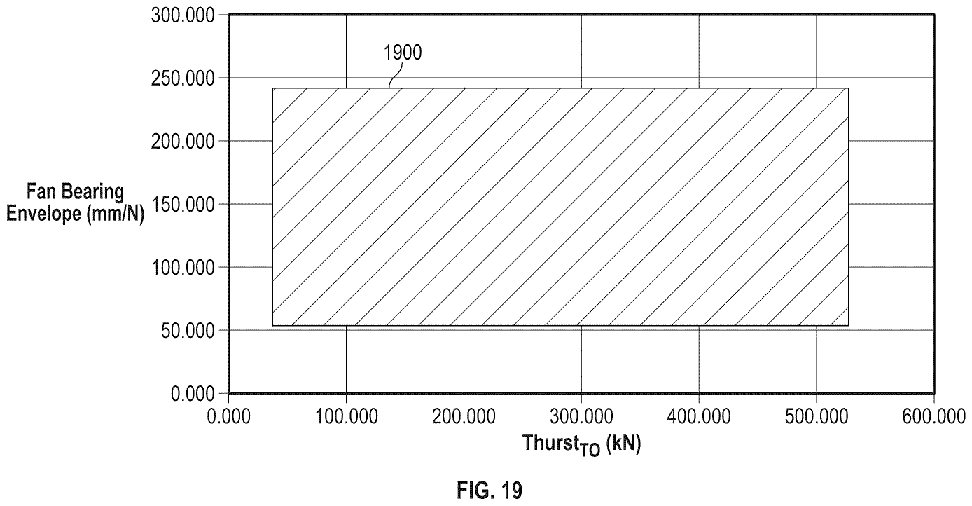

FIG. 19 represents, in graph form, the FBE as a function of the Thrust_{TO} of the turbofan engine, according to the present disclosure. An area 1900 represents the boundaries of the FBE. The FBE is in a range from fifty-four millimeters per Newton (54 mm/N) to two hundred forty millimeters per Newton (240 mm/N) for a takeoff thrust Thrust_{TO} in a range from forty kilo-Newtons (40 kN) to five hundred twenty-five kilo-Newtons (525 kN). The range of the FBE identifies the specific architectures (fan bearing sizing and location), rolling elements sizing, and takeoff thrusts, while accounting for the stresses from the fan shaft and the inner flow path radius and the fan hub radius. In particular, if the FBE is within the area 1900, then the fan bearing and the turbofan engine architecture are capable of handling the stresses from the fan shaft during operation, while reducing the fan hub radius, and, thus, providing for an improved specific flow through the fan and reducing the fan diameter required to achieve a certain thrust, or reduces the fan pressure ratio and improves propulsive efficiency of the fan. If the FBE is outside of the area 1900, then the fan bearings may become damaged or fail under the stresses from the fan shaft, or the fan hub radius (e.g., the inner radius of the flow path) is too great, such that the fan efficiency decreases or the specific flow through the fan is reduced for a certain thrust. Thus, the turbofan engine having an FBE within the area 1900 provides for an improved fan bearing architecture that is capable of handling the stresses from the fan shaft, while accounting for the fan hub radius to improve propulsive efficiency and specific flow for achieving a certain thrust.

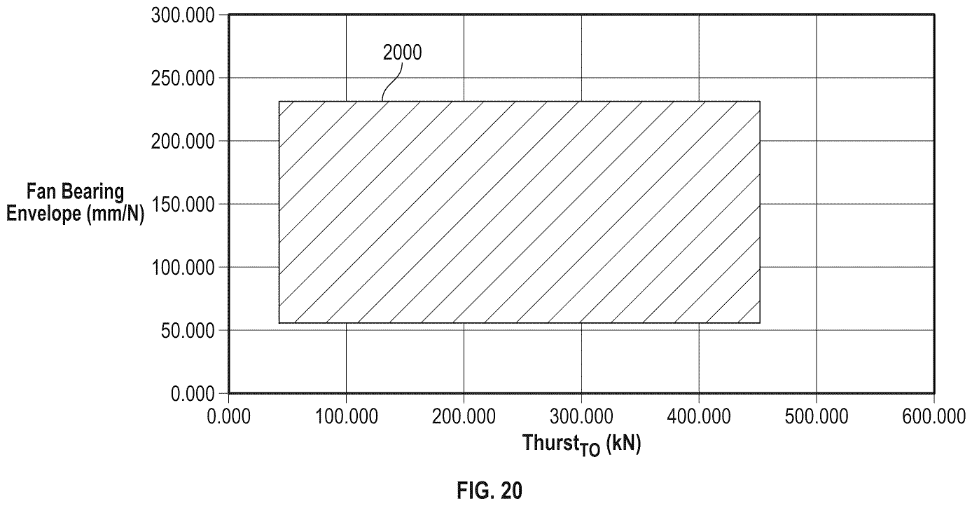

FIG. 20 represents, in graph form, the FBE as a function of the Thrust_{TO}, according to another aspect. An area 2000 represents the boundaries of the FBE. The FBE is in a range from fifty-eight millimeters per Newton (58 mm/N) to two hundred thirty millimeters per Newton (230 mm/N) for a takeoff thrust Thrust_{TO} in a range from forty-four kilo-Newtons (44 kN) to four hundred fifty kilo-Newtons (450 kN). The range of the FBE identifies the specific architectures (fan bearing sizing and location), rolling elements sizing, and takeoff thrusts, while accounting for the stresses from the fan shaft and the inner flow path radius and the fan hub radius. In particular, if the FBE is within the area 2000, then the fan bearing and the turbofan engine architecture are capable of handling the stresses from the fan shaft during operation, while reducing the fan hub radius, and, thus, providing for an improved specific flow through the fan and reducing the fan diameter required to achieve a certain thrust, or reduces the fan pressure ratio and improves propulsive efficiency of the fan. If the FBE is outside of the area 2000, then the fan bearings may become damaged or fail under the stresses from the fan shaft, or the fan hub radius (e.g., the inner radius of the flow path) is too great, such that the fan efficiency decreases or the specific flow through the fan is reduced for a certain thrust. Thus, the turbofan engine having an FBE within the area 2000 provides for an improved fan bearing architecture that is capable of handling the stresses from the fan shaft, while accounting for the fan hub radius to improve propulsive efficiency and specific flow for achieving a certain thrust.

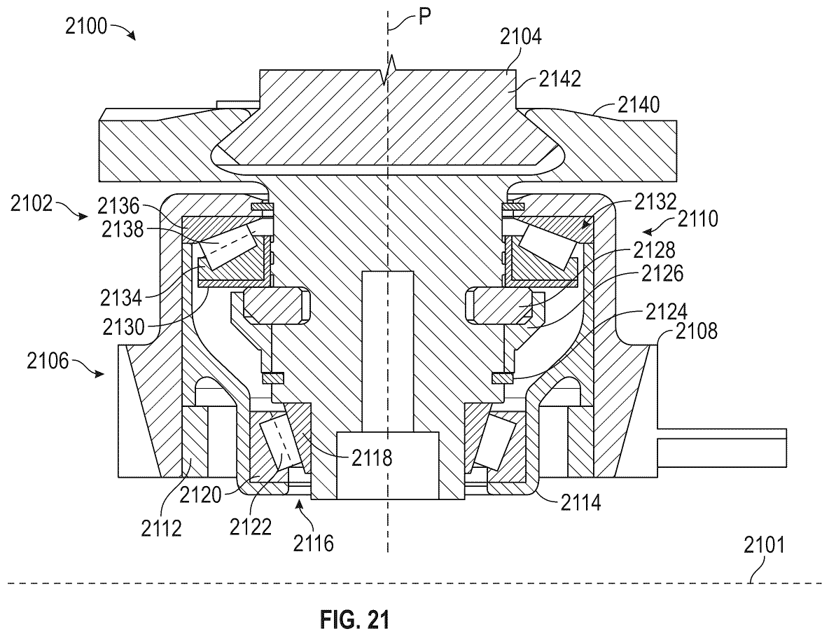

FIG. 21 is an enlarged schematic, cross-sectional view of a segment of a fan 2100 having a fan actuation system 2102, taken along a longitudinal centerline axis 2101 of the fan 2100, according to the present disclosure. The fan 2100 can be utilized as the fan 138 of FIG. 1 or as the fan 252 of FIG. 2. The fan 2100 includes a plurality of fan blades 2104 that is coupled to a disk 2106 and is spaced circumferentially about the longitudinal centerline axis 2101 of the fan 2100.

The disk 2106 includes a plurality of disk segments 2108 (only one shown in FIG. 21) that is rigidly coupled together or integrally molded together in a generally annular shape. One fan blade 2104 is coupled to each disk segment 2108 at a trunnion mechanism 2110 of the fan actuation system 2102. The trunnion mechanism 2110 facilitates retaining the respective fan blade 2104 on the disk 2106 during rotation of the disk 2106, while still rendering the respective fan blade 2104 rotatable relative to the disk 2106 about a pitch axis P of the fan blade 104. The trunnion mechanism 2110 includes a plurality of bearings disposed within the disk segment 2108 that allows the fan blade 2104 to rotate about the pitch axis P, as detailed above and below.

The trunnion mechanism 2110 extends through a respective disk segment 2108 and includes a coupling nut 2112, a lower bearing support 2114, a first radial thrust bearing 2116 (having, for example, an inner race 2118, an outer race 2120, and a plurality of rolling elements 2122), a snap ring 2124, a key hoop retainer 2126, a segmented key 2128, a bearing support 2130, a second radial thrust bearing 2132 (having, for example, an inner race 2134, an outer race 2136, and a plurality of rolling elements 2138), a trunnion 2140, and a base 2142 (e.g., a dovetail). The first radial thrust bearing 2116 and the second radial thrust bearing 2132 can include any type of roller bearings, including, for example, cylindrical roller radial thrust bearings, tapered roller radial thrust bearings, spherical roller radial thrust bearings (e.g., ball bearings), needle roller radial thrust bearings, or tapered roller needle radial thrust bearings. The coupling nut 2112 is threadedly engaged with the disk segment 2108 so as to sandwich the remaining components of the trunnion mechanism 2110 between the coupling nut 2112 and the disk segment 2108, thus, retaining the trunnion mechanism 2110 attached to the disk segment 2108.

The first radial thrust bearing 2116 is oriented at a different angle than the second radial thrust bearing 2132 (as measured from a rolling element longitudinal centerline axis 2150 of the plurality of rolling elements 2122 relative to the pitch axis P, and from a rolling element longitudinal centerline axis 2152 of the plurality of rolling elements 2138 relative to the pitch axis P). More specifically, the first radial thrust bearing 2116 and the second radial thrust bearing 2132 are preloaded against one another in a face-to-face (or duplex) arrangement, in which the rolling element longitudinal centerline axes 2150, 2152 are oriented substantially perpendicular to one another, as opposed to being arranged in tandem so as to be oriented substantially parallel to one another.

The centrifugal loads experienced closer to the pitch axis P are larger than the centrifugal loads experienced further away from the pitch axis P. As such, to facilitate making the trunnion mechanism 2110 more compact, the bearings of the trunnion mechanism 2110 are positioned closer to the pitch axis P. Such a configuration enables a greater number of trunnion mechanisms 2110 to be assembled on the disk 2106 and, thus, more fan blades 2104 to be coupled to the disk 2106 for a given diameter of the disk 2106. The trunnion mechanism 2110 herein is made more compact due to the first radial thrust bearing 2116 and the second radial thrust bearing 2132 being line contact bearings as compared to trunnion mechanisms that utilize angular point contact ball bearings. In this way, the trunnion mechanism 2110 is made more compact while being better able to withstand larger centrifugal loads associated with such a bearing placement without fracturing or plastically deforming. In particular, the first radial thrust bearing 2116 and the second radial thrust bearing 2132 being line contact bearings provide for larger contact surfaces, and, thus, can withstand larger centrifugal loads as compared to angular point contact ball bearings. Thus, line contact bearings (e.g., the first radial thrust bearing 2116 and the second radial thrust bearing 2132) can be spaced closer to the pitch axis P than angular point contact ball bearings.

In one aspect, the first radial thrust bearing 2116 and the second radial thrust bearing 2132 are a tapered roller bearings in which the rolling elements 2122 and the rolling elements 2138 are tapered. In one example, the first radial thrust bearing 2116 is fabricated from a steel material and has twenty rolling elements 2122 arranged at a 20° contact angle and a 3.6 inch pitch diameter, with each rolling element 2122 being 0.6 inches long and having a 0.525 inch minor diameter, a 0.585 inch major diameter, and a 6° taper angle. In the same example, the second radial thrust bearing 2132 is fabricated from a steel material and has 36 rolling elements 2138 arranged at a 65° contact angle and a 6 inch pitch diameter, with each rolling element 2138 being 0.8 inches long and having a 0.45 inch minor diameter, a 0.6 inch major diameter, and a 9° taper angle. In other aspects, the first radial thrust bearing 2116 and the second radial thrust bearing 2132 can be configured in any suitable manner that facilitates enabling the first radial thrust bearing 2116 and the second radial thrust bearing 2132 to function as described herein.

The first radial thrust bearing 2116 and the second radial thrust bearing 2132 facilitate providing a turbofan engine with a smaller variable pitch fan that can generate larger amounts of thrust. Particularly, the first radial thrust bearing 2116 and the second radial thrust bearing 2132 facilitate providing a turbofan engine with a variable pitch fan having a higher blade count and a lower blade length, while also providing the turbofan engine with a lower fan hub radius ratio. The first radial thrust bearing 2116 and the second radial thrust bearing 2132 further facilitate providing a trunnion mechanism that is more compact and is better able to withstand the higher centrifugal loads associated with higher blade counts, given that higher blade counts tend to yield a higher tip velocity and, therefore, a higher centrifugal loading. The first radial thrust bearing 2116 and the second radial thrust bearing 2132 further facilitate providing a smaller diameter disk for a variable pitch fan by providing the variable pitch fan with a fan counterweight device for the fan blades.

As mentioned above, as turbofan engines have less available space, the fan pitch actuation system supply lines cannot be routed around the gearbox assembly without making the available space larger, thus, affecting the other components of the turbofan engine.

The gear ratio of the gearbox assembly in turboprops is greater than the gear ratio of the gearbox assembly in turbofan engines due to the lower speeds of the propeller of the turboprop compared to the speeds of the fan of the turbofan engines. In particular, the turboprops require a greater reduction in speed from the turbo-engine to the propeller through the gearbox assembly as compared to turbofan engines. Typically, turboprops require a gear ratio of greater than 14:1, while turbofan engines require a gear ratio of less than 14:1. Turboprop gearboxes typically utilize planet gears with journal bearings in a planetary configuration in which the planet gears rotate about the centerline axis of the gearbox to achieve a clockwise rotation of the propeller. The gearboxes for turbofan engines cannot simply scale up the turboprop gearbox configurations due to the higher loads or higher torques of the turbofan engines as compared to the loads and torques of the turboprop engines. In particular, the planet gears would need to be smaller in a turbofan gearbox in the planetary configuration to achieve the lower gear ratios as compared to the planet gears of the turboprop gearbox. However, the smaller planet gears would be unable to handle the higher loads and the higher torques of the turbofan engine. Further, if the turbofan gearbox utilized journal bearings, the higher speeds through the gearbox would suck out the lubricant from the journal bearings, resulting in metal-to-metal contact between the planet gears and the planet pins.

Accordingly, the present disclosure provides for a double gearbox assembly that each includes a first stage gear assembly and a second stage gear assembly. The output of the first stage gear assembly is an input of the second stage gear assembly such that the first stage gear assembly drives the second stage gear assembly. Particularly, the first stage gear assembly of each of the gearbox assemblies is in a star configuration in which the planet gears are held stationary with respect to the centerline axis of the gearbox and the ring gear drives the output. The input and the output of the star configuration are both in the same direction (e.g., the counterclockwise direction).

The star configuration of the first stage gear assembly (stationary planet gears) allows the fan pitch actuation system supply lines to be routed through the gearbox assembly (through the planet carrier of the first stage gear assembly) to fit within the available space of the turbofan engine. The double gearbox assembly achieves a gear ratio less than or equal to 14:1 (e.g., 6:1 to 14:1) by using the star configuration, which allows for larger planet gears as compared to the planetary configuration of turboprop engines to withstand the higher loads and the higher torques as compared to turboprop engines. Further, a double gearbox assembly requires more axial space compared to a single gearbox assembly having only one stage of gears. In this way, there is less axial space under the fan for the fan actuation system. A turbine engine having a FAS value or a FASL value that falls within the ranges detailed herein accounts for the more limited axial space due to the longer double gearbox assembly. Accordingly, the gearbox assemblies disclosed herein enable the FAS and FASL envelopes detailed above to enable fan actuation systems able to achieve the necessary loads for adequately pitching the fan blades due the double gear assembly while fitting within the limited space the turbofan engine.

The double gearbox assemblies of the present disclosure also allow for an engine system for an aircraft to have two counter-rotating fans such that the first turbofan engine has a fan that rotates counterclockwise, and the second turbofan engine has a fan that rotates clockwise. To achieve the counter-rotating fans, the turbofan engines have a double gearbox assembly that each includes a first stage gear assembly and a second stage gear assembly. The second stage gear assembly of the first turbofan engine is in a star configuration such that the output of the second stage gear assembly is in the counterclockwise direction. In this way, the fan of the first turbofan engine rotates in the counterclockwise direction. The second stage gear assembly of the second turbofan engine is in a planetary configuration in which the planet gears rotate about the centerline axis of the gearbox and the ring gear is held stationary such that the output of the second stage gear assembly is in the clockwise direction.

Such an engine system provides for a symmetric configuration such that the fans eliminate the undesired change of the yaw of the aircraft. In this way, the fan of the second turbofan engine rotates in the clockwise direction. Thus, the turbofan engines are counter-rotating in which the fan of the first turbofan engine rotates in the counterclockwise direction and the fan of the second turbofan engine rotates in the clockwise direction. Such a configuration allows both turbofan engines to have the same input rotational direction (e.g., counterclockwise) while having different output rotational directions (e.g., counterclockwise on one engine and clockwise on the other engine). Further, the engine system of the present disclosure reduces the fuel burn and noise as compared to the asymmetric configuration.

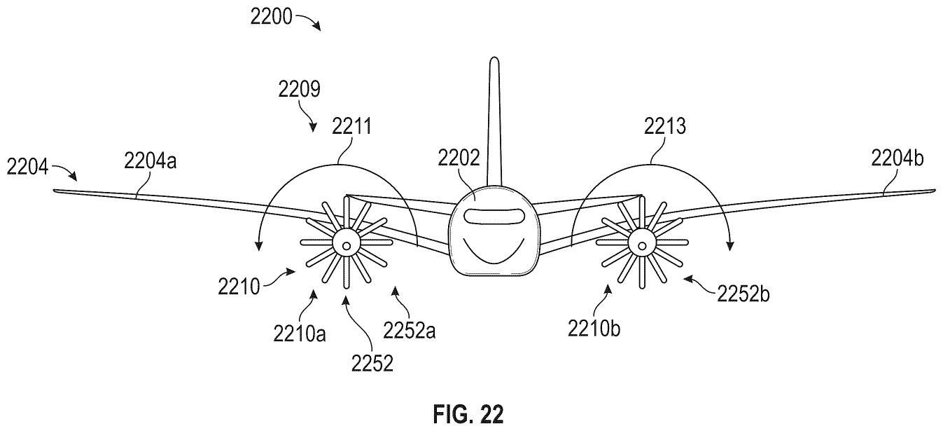

FIG. 22 is a front schematic view of an aircraft 2200 having an engine system 2209, according to the present disclosure. As shown in FIG. 22, the aircraft 2200 includes a fuselage 2202 and a plurality of wings 2204 coupled to the fuselage 2202. The plurality of wings 2204 includes a first wing 2204a and a second wing 2204b. The aircraft 2200 is exemplary only and can include any type of aircraft 2200 having the engine system 2209 detailed herein.

The engine system 2209 includes a plurality of turbofan engines 2210 including a first turbofan engine 2210a and a second turbofan engine 2210b. The plurality of turbofan engines 2210 is mounted to the aircraft 2200, particularly, mounted to the plurality of wings 2204. Specifically, the first turbofan engine 2210a is mounted to the first wing 2204a and the second turbofan engine 2210b is mounted to the second wing 2204b. The plurality of turbofan engines 2210 is suspended beneath the plurality of wings 2204 in an under-wing configuration. Alternatively, however, in other exemplary embodiments, any other suitable aircraft engine configuration may be provided (e.g., over-wing configuration).

The plurality of turbofan engines 2210 includes open-fan turbofan engines that each has a fan 2252 that is unducted. In this way, the plurality of turbofan engines 2210 does not include a fan casing or a nacelle that surrounds the fan 2252. An exemplary open-fan turbofan engine is detailed above with respect to FIG. 2. The first turbofan engine 2210a includes a first fan 2252a and the second turbofan engine 2210b includes a second fan 2252b. As detailed further below, the first turbofan engine 2210a is configured such that the first fan 2252a rotates in a first direction 2211 and the second turbofan engine 2210b is configured such that the second fan 2252b rotates in a second direction 2213. The second direction 2213 is opposite the first direction 2211. In particular, the first direction 2211 is a counterclockwise direction and the second direction 2213 is a clockwise direction. In the view of FIG. 22, the first turbofan engine 2210a is mounted on a left side of the aircraft 2200 and the second turbofan engine 2210b is mounted on a right side of the aircraft 2200. Thus, the first fan 2252a (counterclockwise rotation) and the second fan 2252b (clockwise rotation) rotate away from the fuselage 2202 in an up-up configuration. In some embodiments, the first fan 2252a rotates clockwise and the second fan 2252b rotates counterclockwise such that the first fan 2252a and the second fan 2252b rotate toward the fuselage 2202 in a down-down configuration.

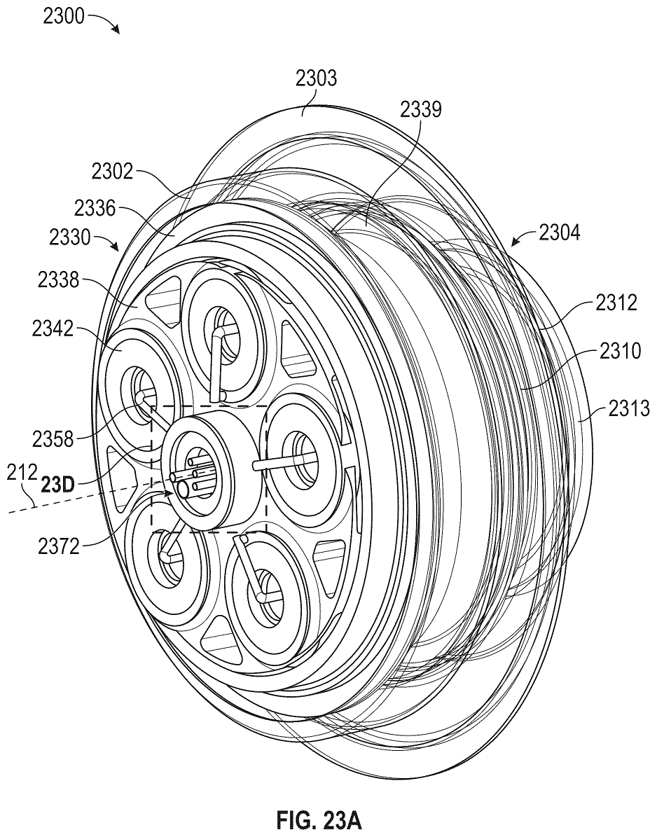

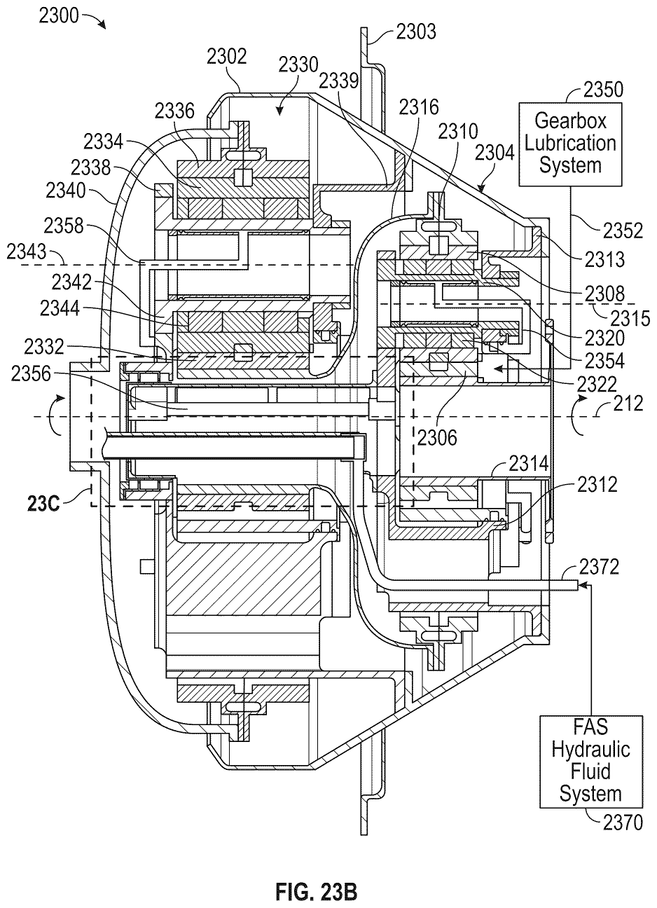

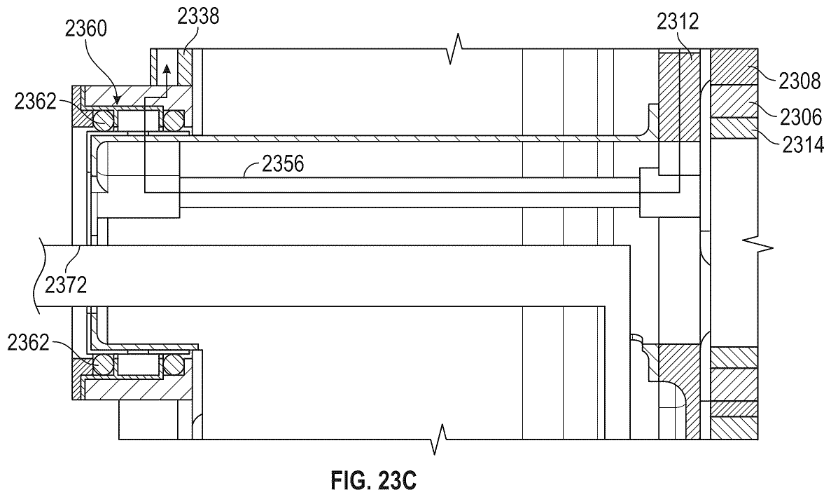

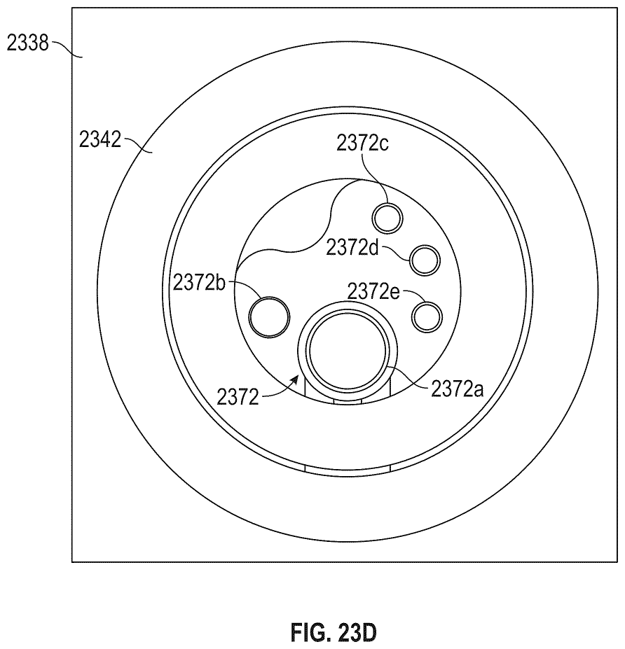

FIG. 23A is an elevational view showing a counterclockwise gearbox assembly 2300 for a turbofan engine, according to the present disclosure. FIG. 23B is a schematic cross-sectional view of the counterclockwise gearbox assembly 2300, taken along the longitudinal centerline axis 212 of the counterclockwise gearbox assembly 2300, according to the present disclosure. FIG. 23C is an enlarged schematic cross-sectional view of the counterclockwise gearbox assembly 2300, taken at detail 23C in FIG. 23B, according to the present disclosure. FIG. 23D is an enlarged schematic front view of the counterclockwise gearbox assembly 2300, taken at detail 23D in FIG. 23A, according to the present disclosure.

The counterclockwise gearbox assembly 2300 can be utilized as the gearbox assembly 255 of the turbofan engine 210 of FIG. 2. In particular, the counterclockwise gearbox assembly 2300 is utilized in the first turbofan engine 2210a of FIG. 22 for rotating the first fan 2252a in the first direction 2211 (counterclockwise direction).

The counterclockwise gearbox assembly 2300 has a counterclockwise rotational output (e.g., the output of the counterclockwise gearbox assembly 2300 rotates in the counterclockwise direction). The counterclockwise gearbox assembly 2300 includes a counterclockwise gearbox casing 2302 (shown transparent in FIG. 23A for clarity) having a counterclockwise gearbox coupling 2303 that couples the counterclockwise gearbox assembly 2300 to a static structure of the turbofan engine (e.g., the fan frame 271 of FIG. 2). The counterclockwise gearbox coupling 2303 is a flex mount that is a mounting structure that couples the gearbox assembly to the static structure of the turbofan engine. A flex mount allows displacement of the gearbox assembly with respect to the static structure in the axial direction A, the radial direction R, and/or the circumferential direction C.

The counterclockwise gearbox assembly 2300 is a double gearbox (DGB) assembly that includes a first stage gear assembly 2304 and a second stage gear assembly 2330. The first stage gear assembly 2304 and the second stage gear assembly 2330 are contained within the counterclockwise gearbox casing 2302. The first stage gear assembly 2304 and the second stage gear assembly 2330 are in a serial relationship such that the first stage gear assembly 2304 transfers power and torque to the second stage gear assembly 2330. In this way, the first stage gear assembly 2304 causes the second stage gear assembly 2330 to rotate as the first stage gear assembly 2304 rotates. As detailed further below, the first stage gear assembly 2304 is an epicyclic gear assembly in a star configuration and the second stage gear assembly 2330 is an epicyclic gear assembly in a star configuration. In this way, the input of the first stage gear assembly 2304 and the output of the second stage gear assembly 2330 both rotate in the counterclockwise direction. The counterclockwise gearbox assembly 2300 has a gear ratio in a range of 6:1 to 12:1, of 7:1 to 11:1, or of 8:1 to 10:1. Preferably, the counterclockwise gearbox assembly 2300 has a gear ratio of 8.57:1. The first stage gear assembly 2304 has a gear ratio in a range of 2:1 to 3.5:1. The second stage gear assembly 2330 has a gear ratio in a range of 2:1 to 3.5:1.

With reference to FIG. 23B, the first stage gear assembly 2304 is an epicyclic gear assembly and includes a first stage sun gear 2306, a plurality of first stage planet gears 2308 (only two of which are visible in FIG. 23B), and a first stage ring gear 2310. For clarity, only a portion of the gears is shown. The first stage sun gear 2306 has a first stage sun gear diameter. Each of the plurality of first stage planet gears 2308 has a first stage planet gear diameter. The first stage ring gear 2310 has a first stage ring gear diameter. The diameter of the gears is a pitch diameter of a pitch circle of the gears. The pitch circle is an imaginary circle that intersects the teeth of a gear at a point where the face of the teeth mesh with the face of the teeth of another gear. The first stage sun gear diameter is in a range of one hundred twelve millimeters (112 mm) to one hundred thirty-three millimeters (133 mm). The first stage planet gear diameter is in a range of one hundred fourteen millimeters (114 mm) to one hundred twenty-four millimeters (124 mm). The first stage ring gear diameter is in a range of three hundred forty-three millimeters (343 mm) to three hundred seventy-five millimeters (375 mm).

The plurality of first stage planet gears 2308 is contained and supported by a first stage planet carrier 2312 (shown schematically in FIG. 23B). The first stage gear assembly 2304 is a star configuration, in which the first stage planet carrier 2312 is held fixed, with the first stage ring gear 2310 allowed to rotate. For example, the first stage planet carrier 2312 is coupled to the counterclockwise gearbox casing 2302 (which is coupled to the static structure of the turbofan engine) via a first stage planet carrier coupling 2313.

The counterclockwise gearbox assembly 2300 includes an input shaft 2314, an interstage shaft 2316, and an output shaft 2340. In FIG. 23B, the first stage sun gear 2306 is coupled to the input shaft 2314. In some embodiments, the input shaft 2314 and the first stage sun gear 2306 are a single unitary component. The input shaft 2314 is coupled to the turbine section (FIG. 2) of the first turbofan engine 2210a (FIG. 22). For example, the input shaft 2314 can be coupled to, or can embody, the LP shaft 238 (FIG. 2). Radially outward of the first stage sun gear 2306, and intermeshing therewith, is the plurality of first stage planet gears 2308 that is coupled together and supported by the first stage planet carrier 2312. The first stage planet carrier 2312 supports the plurality of first stage planet gears 2308 such that the plurality of first stage planet gears 2308 is held fixed with respect to the longitudinal centerline axis 212, while enabling each first stage planet gear 2308 of the plurality of first stage planet gears 2308 to rotate about a first stage planet gear longitudinal axis 2315 of each first stage planet gear 2308. Radially outwardly of the plurality of first stage planet gears 2308, and intermeshing therewith, is the first stage ring gear 2310, which is an annular ring gear. In the star configuration, the interstage shaft 2316 is driven by the first stage ring gear 2310. The interstage shaft 2316 is an output of the first stage gear assembly 2304 and an input of the second stage gear assembly 2330. For example, the first stage ring gear 2310 is coupled to the second stage gear assembly 2330 via the interstage shaft 2316 such that rotation of the interstage shaft 2316 causes the second stage gear assembly 2330 to rotate. In this way, the first stage ring gear 2310 is an output of the first stage gear assembly 2304.

Each of the first stage planet gears 2308 includes a first stage planet pin 2320, about which a respective first stage planet gear 2308 rotates. For example, the first stage planet pin 2320 is disposed within a respective first stage planet gear 2308. Each of the first stage planet gears 2308 is supported by one or more first stage roller bearings 2322 disposed radially between the first stage planet pin 2320 and the first stage planet gear 2308. FIG. 23B shows the one or more first stage roller bearings 2322 include two first stage roller bearings 2322 that are spaced axially from each other. A respective first stage planet gear 2308, however, can include any number of first stage roller bearings 2322 for supporting rotation of the first stage planet gear 2308 about the first stage planet pin 2320. As detailed further below, a lubricant (e.g., oil) is supplied to the first stage gear assembly 2304 to lubricate the gears and the first stage roller bearings 2322.

The second stage gear assembly 2330 is an epicyclic gear assembly and includes a second stage sun gear 2332, a plurality of second stage planet gears 2334 (only two of which are visible in FIG. 23B), and a second stage ring gear 2336. For clarity, only a portion of the gears is shown. The second stage sun gear 2332 has a second stage sun gear diameter. Each of the plurality of second stage planet gears 2334 has a second stage planet gear diameter. The second stage ring gear 2336 has a second stage ring gear diameter. The second stage sun gear diameter is greater than the first stage sun gear diameter. The second stage gear assembly 2330 transfers a greater amount of torque than the first stage gear assembly 2304. Accordingly, the second stage planet gear diameter is greater than first stage planet gear diameter. The second stage ring gear diameter is greater than the first stage ring gear diameter. The second stage sun gear diameter is in a range of one hundred fifty-one millimeters (151 mm) to one hundred seventy-nine millimeters (179 mm). The second stage planet gear diameter is in a range of one hundred sixty-three millimeters (163 mm) to one hundred seventy-nine millimeters (179 mm). The second stage ring gear diameter is in a range of four hundred eighty-one millimeters (481 mm) to five hundred twenty-eight millimeters (528 mm).

The plurality of second stage planet gears 2334 is contained and supported by a second stage planet carrier 2338 (shown schematically in FIG. 23B). The second stage gear assembly 2330 is a star configuration, in which the second stage planet carrier 2338 is held fixed, with the second stage ring gear 2336 allowed to rotate. For example, the second stage planet carrier 2338 is coupled to the counterclockwise gearbox casing 2302 (which is coupled to the static structure of the turbofan engine) via a second stage planet carrier coupling 2339.

In FIG. 23B, the second stage sun gear 2332 is coupled to the interstage shaft 2316 such that the interstage shaft 2316 is an input of the second stage gear assembly 2330. In some embodiments, the interstage shaft 2316 and the second stage sun gear 2332 are a single unitary component. Radially outward of the second stage sun gear 2332, and intermeshing therewith, is the plurality of second stage planet gears 2334 that is coupled together and supported by the second stage planet carrier 2338. The second stage planet carrier 2338 supports the plurality of second stage planet gears 2334 such that the plurality of second stage planet gears 2334 is held fixed with respect to the longitudinal centerline axis 212, while enabling each second stage planet gear 2334 of the plurality of second stage planet gears 2334 to rotate about a second stage planet gear longitudinal axis 2343 of each second stage planet gear 2334. Radially outwardly of the plurality of second stage planet gears 2334, and intermeshing therewith, is the second stage ring gear 2336, which is an annular ring gear. In the star configuration, the output shaft 2340 is driven by the second stage ring gear 2336. For example, the second stage ring gear 2336 is coupled to the output shaft 2340 such that rotation of the second stage ring gear 2336 causes the output shaft 2340 to rotate. In this way, the second stage ring gear 2336 is an output of the second stage gear assembly 2330.

Each of the second stage planet gears 2334 includes a second stage planet pin 2342, about which a respective second stage planet gear 2334 rotates. For example, the second stage planet pin 2342 is disposed within a respective second stage planet gear 2334. Each of the second stage planet gears 2334 is supported by one or more second stage roller bearings 2344 disposed radially between the second stage planet pin 2342 and the second stage planet gear 2334. FIG. 23B shows the one or more second stage roller bearings 2344 include two second stage roller bearings 2344 that are spaced axially from each other. A respective second stage planet gear 2334, however, can include any number of second stage roller bearings 2344 for supporting rotation of the second stage planet gear 2334 about the second stage planet pin 2342. As detailed further below, the lubricant (e.g., oil) is supplied to the second stage gear assembly 2330 to lubricate the gears and the second stage roller bearings 2344.

The first turbofan engine 2210a (FIG. 22) includes a gearbox lubrication system 2350 for supplying the lubricant to the counterclockwise gearbox assembly 2300 to lubricate the gears and the roller bearings. The gearbox lubrication system 2350 includes one or more gearbox lubricant supply lines 2352 for supplying the lubricant to the first stage gear assembly 2304 and the second stage gear assembly 2330. The gearbox lubrication system 2350 can include one or more lubricant tanks for storing lubricant therein and one or more lubricant pumps for pumping the lubricant from the lubricant tanks to the counterclockwise gearbox assembly 2300 through the one or more gearbox lubricant supply lines 2352. The first stage gear assembly 2304 includes one or more first stage lubricant supply lines 2354 in fluid communication with the gearbox lubricant supply lines 2352. The one or more first stage lubricant supply lines 2354 extend through the plurality of first stage planet gears 2308 and are in fluid communication with the first stage planet gears 2308 and the one or more first stage roller bearings 2322. In particular, a respective one of the first stage lubricant supply lines 2354 extends through a respective first stage planet pin 2320 to supply the lubricant to the one or more first stage roller bearings 2322.

The gearbox lubrication system 2350 also includes an interstage lubricant supply line 2356 that extends from the first stage planet carrier 2312 to the second stage planet carrier 2338 through the interstage shaft 2316. The interstage lubricant supply line 2356 is in fluid communication with the gearbox lubricant supply lines 2352 such that the gearbox lubrication system 2350 supplies the lubricant to the second stage gear assembly 2330 through the interstage lubricant supply line 2356. The second stage gear assembly 2330 includes one or more second stage lubricant supply lines 2358 in fluid communication with the interstage lubricant supply line 2356. The one or more second stage lubricant supply lines 2358 extend through the plurality of second stage planet gears 2334 and are in fluid communication with the second stage planet gears 2334 and the one or more second stage roller bearings 2344. In particular, a respective one of the second stage lubricant supply lines 2358 extends through a respective second stage planet pin 2342 to supply the lubricant to the one or more second stage roller bearings 2344.

With reference to FIG. 23C, the gearbox lubrication system 2350 includes a lubricant distributor 2360 that is integrated with the second stage planet carrier 2338. The lubricant distributor 2360 is a flowpath within the second stage planet carrier 2338 that is in fluid communication with the interstage lubricant supply line 2356 and the one or more second stage lubricant supply lines 2358. In this way, the lubricant distributor 2360 directs the lubricant from the interstage lubricant supply line 2356 to each of the one or more second stage lubricant supply lines 2358. The lubricant distributor 2360 is an annular about the longitudinal centerline axis 212 and each of the one or more second stage lubricant supply lines 2358 is in fluid communication with the lubricant distributor 2360. The lubricant distributor 2360 includes one or more seals 2362 for sealing the lubricant distributor 2360 and preventing the lubricant from leaking out of the lubricant distributor 2360. The one or more seals 2362 can include O-rings, or the like.

With reference back to FIG. 23B, the first turbofan engine 2210a (FIG. 23) includes a fan actuation system (FAS) hydraulic fluid system 2370 for supplying hydraulic fluid (e.g., oil) to the FAS 258 (FIG. 2) for actuating the one or more actuators 259 (FIG. 2) to pitch the fan blades 254 (FIG. 2) about their respective pitch axis P. The FAS hydraulic fluid system 2370 includes one or more FAS hydraulic fluid supply lines 2372 for supplying the hydraulic fluid to the FAS 258. The FAS hydraulic fluid system 2370 can include one or more hydraulic fluid tanks for storing hydraulic fluid therein and one or more hydraulic fluid pumps for pressurizing and pumping the hydraulic fluid from the hydraulic fluid tanks to the FAS 258 through the one or more FAS hydraulic fluid supply lines 2372. The one or more FAS hydraulic fluid supply lines 2372 extend through first stage gear assembly 2304 and the second stage gear assembly 2330 and are in fluid communication with the one or more actuators 259 (FIG. 2) of the FAS 258 (FIG. 2) for supplying the hydraulic fluid to the one or more actuators 259 to actuate the actuators 259 and to change the pitch of the fan blades 254 (FIG. 2). In particular, the one or more FAS hydraulic fluid supply lines 2372 extend through the first stage planet carrier 2312, through the interstage shaft 2316, through the second stage sun gear 2332, and through the second stage planet carrier 2338. In this way, the one or more FAS hydraulic fluid supply lines 2372 extend through the counterclockwise gearbox assembly 2300 (e.g., through the counterclockwise gearbox casing 2302) from an input side of the counterclockwise gearbox assembly 2300 to an output side of the counterclockwise gearbox assembly 2300 and extend to the one or more actuators 259. The input side is an axial side of the counterclockwise gearbox assembly 2300 through which the input shaft 2314 extends, and the output side is an axial side of the counterclockwise gearbox assembly 2300 through which the output shaft 2340 extends.

With reference to FIG. 23D, the one or more FAS hydraulic fluid supply lines 2372 include a first FAS hydraulic fluid supply line 2372a, a second FAS hydraulic fluid supply line 2372b, a third FAS hydraulic fluid supply line 2372c, a fourth FAS hydraulic fluid supply line 2372d, and a fifth FAS hydraulic fluid supply line 2372e. While FIG. 23D shows five FAS hydraulic fluid supply lines 2372, the one or more FAS hydraulic fluid supply lines 2372 can include any number of FAS hydraulic fluid supply lines. The first FAS hydraulic fluid supply line 2372a is a coarse hydraulic fluid supply line for supplying the hydraulic fluid to the one or more actuators 259 (FIG. 2) to rotate the fan blades 254 (FIG. 2) about the pitch axis P (FIG. 2) towards the coarse pitch angle. The second FAS hydraulic fluid supply line 2372b is a fine hydraulic fluid supply line for supplying the hydraulic fluid to the one or more actuators 259 to rotate the fan blades 254 about the pitch axis P towards the fine pitch angle. The third FAS hydraulic fluid supply line 2372c is a feather lock (FLO) hydraulic fluid supply line for locking the fan blades 254 (FIG. 2) in a feather position. The fourth FAS hydraulic fluid supply line 2372d is a thrust reverse lock (TRLO) hydraulic fluid supply line for locking the fan blades 254 (FIG. 2) in a thrust reverse position to generate reverse thrust through the turbofan engine 210 (FIG. 2). The fifth FAS hydraulic fluid supply line 2372e is an auxiliary hydraulic fluid supply line for pressurizing a secondary coarse chamber of the FAS 258 (FIG. 2) for changing the pitch of the fan blades 254 (FIG. 2) towards the coarse pitch angle.

In operation, the input shaft 2314 (e.g., the LP shaft 238) rotates and transfers torque to the output shaft 2340 through the first stage gear assembly 2304 and the second stage gear assembly 2330. In particular, the input shaft 2314 transfers the torque to the first stage sun gear 2306, causing the first stage sun gear 2306 to rotate. The input shaft 2314 and the first stage sun gear 2306 rotate in the counterclockwise direction. The first stage sun gear 2306 transfers the torque to the plurality of first stage planet gears 2308 and drives the plurality of first stage planet gears 2308 such that each first stage planet gear 2308 rotates about the first stage planet gear longitudinal axis 2315. The plurality of first stage planet gears 2308 rotates in the clockwise direction (e.g., in a direction opposite of the first stage sun gear 2306). The first stage planet carrier 2312 holds the plurality of first stage planet gears 2308 stationary with respect to the longitudinal centerline axis 212. The plurality of first stage planet gears 2308 transfers the torque to the first stage ring gear 2310 and drives the first stage ring gear 2310 such that the first stage ring gear 2310 rotates, thereby causing the interstage shaft 2316 to rotate. The first stage ring gear 2310 (and the interstage shaft 2316) rotates in the clockwise direction such that the first stage ring gear 2310 rotates in the same direction as the first stage planet gears 2308 and in a different direction as the first stage sun gear 2306.

The first stage ring gear 2310 transfers the torque to the second stage sun gear 2332 through the interstage shaft 2316, causing the second stage sun gear 2332 to rotate. The second stage sun gear 2332 rotates in the clockwise direction. The second stage sun gear 2332 transfers the torque to the plurality of second stage planet gears 2334 and drives the plurality of second stage planet gears 2334 such that each second stage planet gear 2334 rotates about the second stage planet gear longitudinal axis 2343. The plurality of second stage planet gears 2334 rotates in the counterclockwise direction (e.g., in a direction opposite of the second stage sun gear 2332). The second stage planet carrier 2338 holds the plurality of second stage planet gears 2334 stationary with respect to the longitudinal centerline axis 212. The plurality of second stage planet gears 2334 transfers the torque to the second stage ring gear 2336 and drives the second stage ring gear 2336 such that the second stage ring gear 2336 rotates, thereby causing the output shaft 2340 to rotate. The second stage ring gear 2336 (and the output shaft 2340) rotates in the counterclockwise direction such that the second stage ring gear 2336 rotates in the same direction as the second stage planet gears 2334 and in a different direction as the second stage sun gear 2332. Thus, the first fan 2252a (coupled to the output shaft 2340) rotates in the counterclockwise direction.

As the counterclockwise gearbox assembly 2300 operates, the gearbox lubrication system 2350 supplies the lubricant to the first stage gear assembly 2304 through the one or more gearbox lubricant supply lines 2352. In particular, the one or more gearbox lubricant supply lines 2352 direct the lubricant to the one or more first stage lubricant supply lines 2354. The one or more first stage lubricant supply lines 2354 direct the lubricant to at least one of the one or more first stage roller bearings 2322 or the first stage gears (the first stage sun gear 2306, the plurality of first stage planet gears 2308, and the first stage ring gear 2310) to lubricate the one or more first stage roller bearings 2322 or the first stage gears. The one or more gearbox lubricant supply lines 2352 also direct the lubricant to the interstage lubricant supply line 2356. The interstage lubricant supply line 2356 directs the lubricant to the one or more second stage lubricant supply lines 2358 through the lubricant distributor 2360 (FIG. 23C). The one or more second stage lubricant supply lines 2358 direct the lubricant to at least one of the one or more second stage roller bearings 2344 or the second stage gears (the second stage sun gear 2332, the plurality of second stage planet gears 2334, and the second stage ring gear 2336) to lubricate the one or more second stage roller bearings 2344 or the first stage gears.

As the first turbofan engine 2210a operates, the FAS hydraulic fluid system 2370 supplies the hydraulic fluid to the FAS 258 (FIG. 2) to actuate the fan blades 254 (FIG. 2). In particular, the one or more FAS hydraulic fluid supply lines 2372 direct the hydraulic fluid to the one or more actuators 259 (FIG. 2) to rotate the fan blades 254 to change the pitch angle of the fan blades 254. For example, the first FAS hydraulic fluid supply line 2372a directs the hydraulic fluid to the one or more actuators 259 to rotate the fan blades 254 about the pitch axis P towards the coarse pitch angle. The second FAS hydraulic fluid supply line 2372b directs the hydraulic fluid to the one or more actuators 259 to rotate the fan blades 254 about the pitch axis P towards the fine pitch angle. The third FAS hydraulic fluid supply line 2372c directs the hydraulic fluid to the actuators 259. The fourth FAS hydraulic fluid supply line 2372d directs the hydraulic fluid to the actuators 259. The fifth FAS hydraulic fluid supply line 2372e directs the hydraulic fluid to the actuators 259.

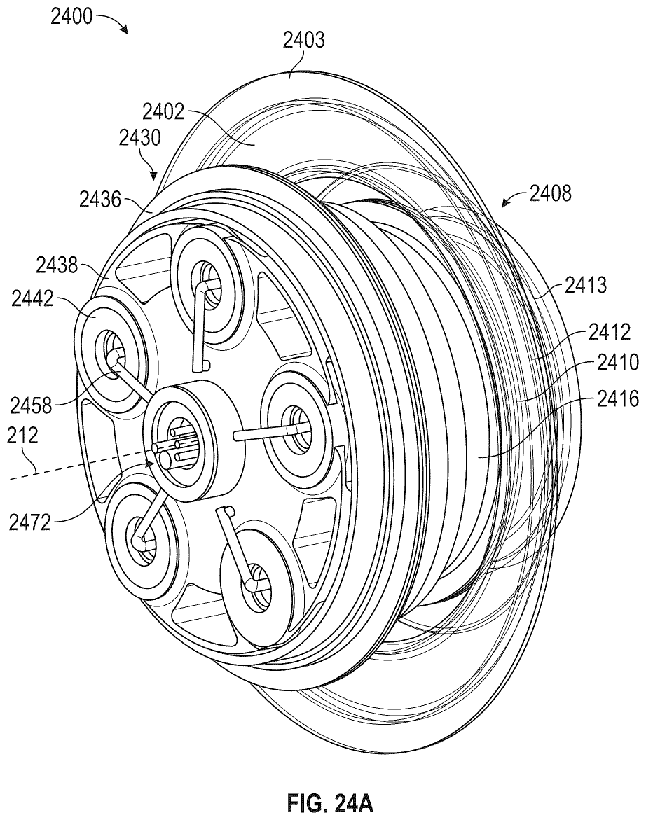

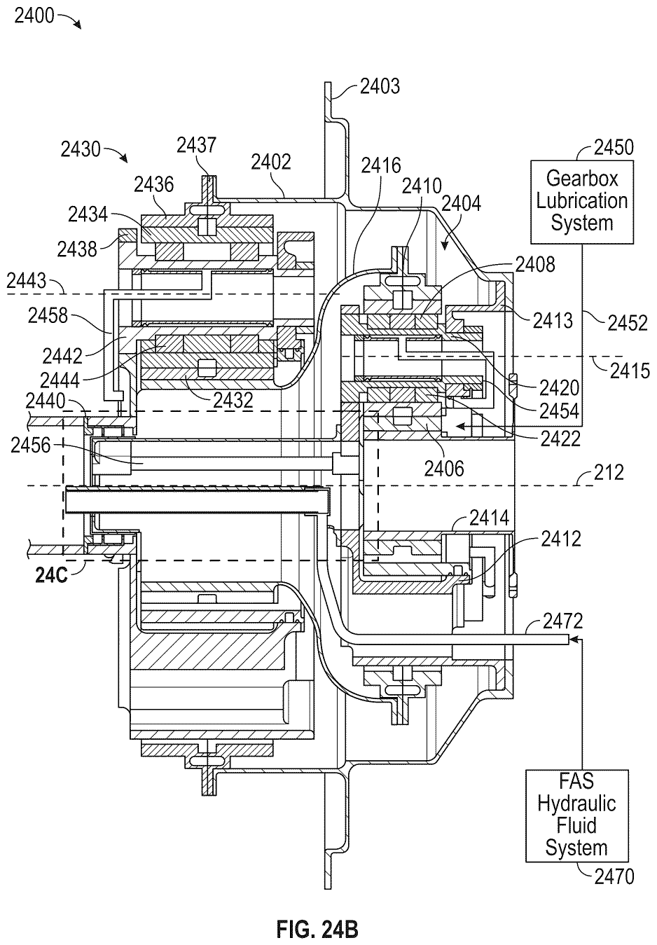

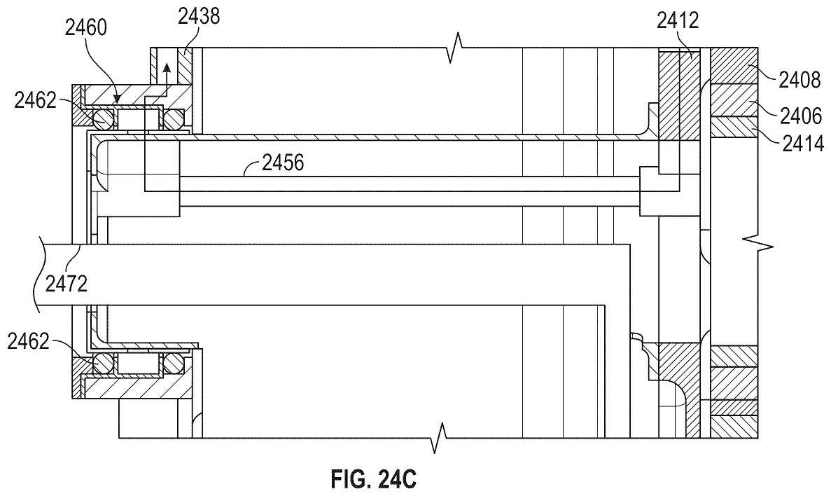

FIG. 24A is an elevational view showing a clockwise gearbox assembly 2400 for a turbofan engine, according to the present disclosure. FIG. 24B is a schematic cross-sectional view of the clockwise gearbox assembly 2400, taken along the longitudinal centerline axis 212 of the clockwise gearbox assembly 2400, according to the present disclosure. FIG. 24C is an enlarged schematic cross-sectional view of the clockwise gearbox assembly 2400, taken at detail 24C in FIG. 24B, according to the present disclosure.

The clockwise gearbox assembly 2400 can be utilized as the gearbox assembly 255 of the turbofan engine 210 of FIG. 2. In particular, the clockwise gearbox assembly 2400 is utilized in the second turbofan engine 2210b of FIG. 22 for rotating the second fan 2252b (FIG. 22) in the second direction 2213 (FIG. 2) (clockwise direction).

The clockwise gearbox assembly 2400 has a clockwise rotational output (e.g., the output of the clockwise gearbox assembly 2400 rotates in the clockwise direction). The clockwise gearbox assembly 2400 includes a clockwise gearbox casing 2402 (shown transparent in FIG. 24A for clarity) having a clockwise gearbox coupling 2403 that couples the clockwise gearbox assembly 2400 to a static structure of the turbofan engine (e.g., the fan frame 271). The clockwise gearbox coupling 2403 is a flex mount that is a mounting structure that couples the gearbox assembly to the static structure of the turbofan engine.

The clockwise gearbox assembly 2400 is a double gearbox (DGB) assembly that includes a first stage gear assembly 2404 and a second stage gear assembly 2430. The first stage gear assembly 2404 and the second stage gear assembly 2430 are contained within the clockwise gearbox casing 2402. The first stage gear assembly 2404 and the second stage gear assembly 2430 are in a serial relationship such that the first stage gear assembly 2404 transfers power and torque to the second stage gear assembly 2430. In this way, the first stage gear assembly 2404 causes the second stage gear assembly 2430 to rotate as the first stage gear assembly 2404 rotates. As detailed further below, the first stage gear assembly 2404 is an epicyclic gear assembly in a star configuration and the second stage gear assembly 2430 is an epicyclic gear assembly in a planetary configuration. In this way, the input of the first stage gear assembly 2404 rotates in the counterclockwise direction and the output of the first stage gear assembly rotates in the clockwise direction. The input of the second stage gear assembly 2430 rotates in the clockwise direction and the output of the second stage gear assembly 2430 rotates in the clockwise direction. The clockwise gearbox assembly 2400 has a gear ratio in a range of 6:1 to 12:1, of 7:1 to 11:1, or of 8:1 to 10:1. Preferably, the clockwise gearbox assembly 2400 has a gear ratio of 8.57:1. The first stage gear assembly 2404 has a gear ratio in a range of 2:1 to 3.5:1. The second stage gear assembly 2330 has a gear ratio in a range of 2:1 to 3.5:1.

With reference to FIG. 24B, the first stage gear assembly 2404 is an epicyclic gear assembly and includes a first stage sun gear 2406, a plurality of first stage planet gears 2408 (only two of which are visible in FIG. 24B), and a first stage ring gear 2410. For clarity, only a portion of the gears is shown. The first stage sun gear 2406 has a first stage sun gear diameter. Each of the plurality of first stage planet gears 2408 has a first stage planet gear diameter. The first stage ring gear 2410 has a first stage ring gear diameter. The diameter of the gears is a pitch diameter of a pitch circle of the gears. The pitch circle is an imaginary circle that intersects the teeth of a gear at a point where the face of the teeth mesh with the face of the teeth of another gear. The plurality of first stage planet gears 2408 is contained and supported by a first stage planet carrier 2412 (shown schematically in FIG. 24B). The first stage gear assembly 2404 is a star configuration, in which the first stage planet carrier 2412 is held fixed, with the first stage ring gear 2410 allowed to rotate. For example, the first stage planet carrier 2412 is coupled to the clockwise gearbox casing 2402 (which is coupled to the static structure of the turbofan engine) via a first stage planet carrier coupling 2413.

The clockwise gearbox assembly 2400 includes an input shaft 2414, an interstage shaft 2416, and an output shaft 2440. In FIG. 4B, the first stage sun gear 2406 is coupled to the input shaft 2414. In some embodiments, the input shaft 2414 and the first stage sun gear 2406 are a single unitary component. The input shaft 2414 is coupled to the turbine section (FIG. 2) of the second turbofan engine 2210b (FIG. 22). For example, the input shaft 2414 can be coupled to, or can embody, the LP shaft 238 (FIG. 2). Radially outward of the first stage sun gear 2406, and intermeshing therewith, is the plurality of first stage planet gears 2408 that is coupled together and supported by the first stage planet carrier 2412. The first stage planet carrier 2412 supports the plurality of first stage planet gears 2408 such that the plurality of first stage planet gears 2408 is held fixed with respect to the longitudinal centerline axis 212, while enabling each first stage planet gear 2408 of the plurality of first stage planet gears 2408 to rotate about a first stage planet gear longitudinal axis 2415 of each first stage planet gear 2408. Radially outwardly of the plurality of first stage planet gears 2408, and intermeshing therewith, is the first stage ring gear 2410, which is an annular ring gear. In the star configuration, the interstage shaft 2416 is driven by the first stage ring gear 2410. The interstage shaft 2416 is an output of the first stage gear assembly 2404 and an input of the second stage gear assembly 2430. For example, the first stage ring gear 2410 is coupled to the second stage gear assembly 2430 via the interstage shaft 2416 such that rotation of the interstage shaft 2416 causes the second stage gear assembly 2430 to rotate. In this way, the first stage ring gear 2410 is an output of the first stage gear assembly 2404.

Each of the first stage planet gears 2408 includes a first stage planet pin 2420, about which a respective first stage planet gear 2408 rotates. For example, the first stage planet pin 2420 is disposed within a respective first stage planet gear 2408. Each of the first stage planet gears 2408 is supported by one or more first stage roller bearings 2422 disposed radially between the first stage planet pin 2420 and the first stage planet gear 2408. FIG. 24B shows the one or more first stage roller bearings 2422 include two first stage roller bearings 2422 that are spaced axially from each other. A respective first stage planet gear 2408, however, can include any number of first stage roller bearings 2422 for supporting rotation of the first stage planet gear 2408 about the first stage planet pin 2420. As detailed further below, a lubricant (e.g., oil) is supplied to the first stage gear assembly 2404 to lubricate the gears and the first stage roller bearings 2422.

The second stage gear assembly 2430 is an epicyclic gear assembly and includes a second stage sun gear 2432, a plurality of second stage planet gears 2434 (only two of which are visible in FIG. 24B), and a second stage ring gear 2436. For clarity, only a portion of the gears is shown. The second stage sun gear 2432 has a second stage sun gear diameter. Each of the plurality of second stage planet gears 2434 has a second stage planet gear diameter. The second stage ring gear 2436 has a second stage ring gear diameter. The second stage sun gear diameter is greater than the first stage sun gear diameter. The second stage planet gear diameter is greater than first stage planet gear diameter. The second stage ring gear diameter is greater than the first stage ring gear diameter. The plurality of second stage planet gears 2434 is contained and supported by a second stage planet carrier 2438 (shown schematically in FIG. 24B). The second stage gear assembly 2430 is a planetary configuration, in which the second stage ring gear 2436 is held fixed, with the second stage planet carrier 2438 allowed to rotate. For example, the second stage ring gear 2436 is coupled to the clockwise gearbox casing 2402 (which is coupled to the static structure of the turbofan engine) via a second stage ring gear coupling 2437.

In FIG. 4B, the second stage sun gear 2432 is coupled to the interstage shaft 2416 such that the interstage shaft 2416 is an input of the second stage gear assembly 2430. In some embodiments, the interstage shaft 2416 and the second stage sun gear 2432 are a single unitary component. Radially outward of the second stage sun gear 2432, and intermeshing therewith, is the plurality of second stage planet gears 2434 that is coupled together and supported by the second stage planet carrier 2438. The second stage planet carrier 2438 supports the plurality of second stage planet gears 2434 such that the plurality of second stage planet gears 2434 rotate about the longitudinal centerline axis 212 (rotate around the second stage sun gear 2432), while enabling each second stage planet gear 2434 of the plurality of second stage planet gears 2434 to rotate about a second stage planet gear longitudinal axis 2443 of each second stage planet gear 2434. In the planetary configuration, the output shaft 2440 is driven by the second stage planet carrier 2438. For example, the second stage planet carrier 2438 is coupled to the output shaft 2440 such that rotation of the second stage planet carrier 2438 causes the output shaft 2440 to rotate. In this way, the second stage planet carrier 2438 (e.g., the plurality of second stage planet gears 2434) is an output of the second stage gear assembly 2430. Radially outwardly of the plurality of second stage planet gears 2434, and intermeshing therewith, is the second stage ring gear 2436, which is an annular ring gear.

Each of the second stage planet gears 2434 includes a second stage planet pin 2442, about which a respective second stage planet gear 2434 rotates. For example, the second stage planet pin 2442 is disposed within a respective second stage planet gear 2434. Each of the second stage planet gears 2434 is supported by one or more second stage roller bearings 2444 disposed radially between the second stage planet pin 2442 and the second stage planet gear 2434. FIG. 24B shows the one or more second stage roller bearings 2444 include two second stage roller bearings 2444 that are spaced axially from each other. A respective second stage planet gear 2434, however, can include any number of second stage roller bearings 2444 for supporting rotation of the second stage planet gear 2434 about the second stage planet pin 2442. As detailed further below, the lubricant (e.g., oil) is supplied to the second stage gear assembly 2430 to lubricate the gears and the second stage roller bearings 2444.

The second turbofan engine 2210b (FIG. 22) includes a gearbox lubrication system 2450 for supplying the lubricant to the clockwise gearbox assembly 2400 to lubricate the gears and the roller bearings. The gearbox lubrication system 2450 includes one or more gearbox lubricant supply lines 2452 for supplying the lubricant to the first stage gear assembly 2404 and the second stage gear assembly 2430. The gearbox lubrication system 2450 can include one or more lubricant tanks for storing lubricant therein and one or more lubricant pumps for pumping the lubricant from the lubricant tanks to the clockwise gearbox assembly 2400 through the one or more gearbox lubricant supply lines 2452. The first stage gear assembly 2404 includes one or more first stage lubricant supply lines 2454 in fluid communication with the gearbox lubricant supply lines 2452. The one or more first stage lubricant supply lines 2454 extend through the plurality of first stage planet gears 2408 and are in fluid communication with the first stage planet gears 2408 and the one or more first stage roller bearings 2422. In particular, a respective one of the first stage lubricant supply lines 2454 extends through a respective first stage planet pin 2420 to supply the lubricant to the one or more first stage roller bearings 2422.

The gearbox lubrication system 2450 also includes an interstage lubricant supply line 2456 that extends from the first stage planet carrier 2412 to the second stage planet carrier 2438 through the interstage shaft 2416. The interstage lubricant supply line 2456 is in fluid communication with the gearbox lubricant supply lines 2452 such that the gearbox lubrication system 2450 supplies the lubricant to the second stage gear assembly 2430 through the interstage lubricant supply line 2456. The second stage gear assembly 2430 includes one or more second stage lubricant supply lines 2458 in fluid communication with the interstage lubricant supply line 2456. The one or more second stage lubricant supply lines 2458 extend through the plurality of second stage planet gears 2434 and are in fluid communication with the second stage planet gears 2434 and the one or more second stage roller bearings 2444. In particular, a respective one of the second stage lubricant supply lines 2458 extends through a respective second stage planet pin 2442 to supply the lubricant to the one or more second stage roller bearings 2444.

With reference to FIG. 24C, the gearbox lubrication system 2450 includes a lubricant distributor 2460 that is integrated with the second stage planet carrier 2438. The lubricant distributor 2460 is an oil transfer bearing that includes a FAS line integrated with the second stage planet carrier 2438 and is in fluid communication with the interstage lubricant supply line 2456 and the one or more second stage lubricant supply lines 2458. In this way, the lubricant distributor 2460 directs the lubricant from the interstage lubricant supply line 2456 to each of the one or more second stage lubricant supply lines 2458 as the second stage planet carrier 2438 (and the one or more second stage lubricant supply lines 2458) rotates. The lubricant distributor 2460 is an annular about the longitudinal centerline axis 212 and each of the one or more second stage lubricant supply lines 2458 is in fluid communication with the lubricant distributor 2460. The lubricant distributor 2460 includes one or more seals 2462 for sealing the lubricant distributor 2460 and preventing the lubricant from leaking out of the lubricant distributor 2460. The one or more seals 2462 can include O-rings, or the like.

With reference back to FIG. 24B, the second turbofan engine 2210b includes a fan actuation system (FAS) hydraulic fluid system 2470 for supplying the hydraulic fluid to the FAS 258 (FIG. 2) for actuating the one or more actuators 259 (FIG. 2) to pitch the fan blades 254 (FIG. 2) about their respective pitch axis P. The FAS hydraulic fluid system 2470 includes one or more FAS hydraulic fluid supply lines 2472 for supplying the hydraulic fluid to the FAS 258. The one or more FAS hydraulic fluid supply lines 2472 can include the first, second, third, fourth, and fifth FAS hydraulic fluid supply lines detailed above with respect to FIG. 23D. The FAS hydraulic fluid system 2470 can include one or more hydraulic fluid tanks for storing hydraulic fluid therein and one or more hydraulic fluid pumps for pressurizing and pumping the lubricant from the hydraulic fluid tanks to the FAS 258 through the one or more FAS hydraulic fluid supply lines 2472. The one or more FAS hydraulic fluid supply lines 2472 extend through first stage gear assembly 2404 and the second stage gear assembly 2430 and are in fluid communication with the one or more actuators 259 of the FAS 258 for supplying the hydraulic fluid to the one or more actuators 259 to actuate the actuators 259 and to change the pitch of the fan blades 254. In particular, the one or more FAS hydraulic fluid supply lines 2472 extend through the first stage planet carrier 2412, through the interstage shaft 2416, through the second stage sun gear 2432, and through the second stage planet carrier 2438. In this way, the one or more FAS hydraulic fluid supply lines 2472 extend through the clockwise gearbox assembly 2400 (e.g., through the clockwise gearbox casing 2402) from an input side of the clockwise gearbox assembly 2400 to an output side of the clockwise gearbox assembly 2400 and extend to the one or more actuators 259. The input side is an axial side of the clockwise gearbox assembly 2400 through which the input shaft 2314 extends, and the output side is an axial side of the clockwise gearbox assembly 2400 through which the output shaft 2440 extends.

In operation, the input shaft 2414 (e.g., the LP shaft 238) rotates and transfers torque to the output shaft 2440 through the first stage gear assembly 2404 and the second stage gear assembly 2430. In particular, the input shaft 2414 transfers the torque to the first stage sun gear 2406, causing the first stage sun gear 2406 to rotate. The input shaft 2414 and the first stage sun gear 2406 rotate in the counterclockwise direction. The first stage sun gear 2406 transfers the torque to the plurality of first stage planet gears 2408 and drives the plurality of first stage planet gears 2408 such that each first stage planet gear 2408 rotates about the first stage planet gear longitudinal axis 2415. The plurality of first stage planet gears 2408 rotates in the clockwise direction (e.g., in a direction opposite of the first stage sun gear 2406). The first stage planet carrier 2412 holds the plurality of first stage planet gears 2408 stationary with respect to the longitudinal centerline axis 212. The plurality of first stage planet gears 2408 transfers the torque to the first stage ring gear 2410 and drives the first stage ring gear 2410 such that the first stage ring gear 2410 rotates, thereby causing the interstage shaft 2416 to rotate. The first stage ring gear 2410 (and the interstage shaft 2416) rotates in the clockwise direction such that the first stage ring gear 2410 rotates in a different direction as the first stage sun gear 2406.

The first stage ring gear 2410 transfers the torque to the second stage sun gear 2432 through the interstage shaft 2416, causing the second stage sun gear 2432 to rotate. The second stage sun gear 2432 rotates in the clockwise direction. The second stage sun gear 2432 transfers the torque to the plurality of second stage planet gears 2434 and the second stage planet carrier 2438 and drives the plurality of second stage planet gears 2434 such that each second stage planet gear 2434 rotates about the second stage planet gear longitudinal axis 2443. This also causes the second stage planet carrier 2438 to rotate about the longitudinal centerline axis 212 such that the plurality of second stage planet gears 2434 rotates about the longitudinal centerline axis 212. The plurality of second stage planet gears 2434 rotate in the counterclockwise direction about the second stage planet gear longitudinal axis 2443. At the same time, the plurality of second stage planet gears 2434 revolve around the second stage sun gear 2432 about the second stage ring gear 2436 in the clockwise direction. This causes the second stage planet carrier 2438 to rotate in the clockwise direction (e.g., in the same direction as the second stage sun gear 2432). The second stage ring gear 2436 applies a reaction torque against the plurality of second stage planet gears 2434 such that the plurality of second stage planet gears 2434 rotates about the second stage ring gear 2436 while the second stage ring gear 2436 remains stationary. The second stage planet carrier 2438 transfers the torque to the output shaft 2440 such that the output shaft 2440 rotates. The output shaft 2440 rotates in the clockwise direction such that the output shaft 2440 rotates in the same direction as the second stage sun gear 2432. Thus, the second fan 2252b (coupled to the output shaft 2440) rotates in the clockwise direction.

As the clockwise gearbox assembly 2400 operates, the gearbox lubrication system 2450 supplies the lubricant to the first stage gear assembly 2404 through the one or more gearbox lubricant supply lines 2452. In particular, the one or more gearbox lubricant supply lines 2452 direct the lubricant to the one or more first stage lubricant supply lines 2454. The one or more first stage lubricant supply lines 2454 direct the lubricant to at least one of the one or more first stage roller bearings 2422 or the first stage gears (the first stage sun gear 2406, the plurality of first stage planet gears 2408, and the first stage ring gear 2410) to lubricate the one or more first stage roller bearings 2422 or the first stage gears. The one or more gearbox lubricant supply lines 2452 also direct the lubricant to the interstage lubricant supply line 2456. The interstage lubricant supply line 2456 directs the lubricant to the one or more second stage lubricant supply lines 2458 through the lubricant distributor 2460 (FIG. 24C). The one or more second stage lubricant supply lines 2458 direct the lubricant to at least one of the one or more second stage roller bearings 2444 or the second stage gears (the second stage sun gear 2432, the plurality of second stage planet gears 2434, and the second stage ring gear 2436) to lubricate the one or more second stage roller bearings 2444 or the first stage gears.

As the second turbofan engine 2210b operates, the FAS hydraulic fluid system 2470 supplies the hydraulic fluid to the FAS 258 (FIG. 2) to actuate the fan blades 254 (FIG. 2). In particular, the one or more FAS hydraulic fluid supply lines 2472 direct the hydraulic fluid to the one or more actuators 259 (FIG. 2) to rotate the fan blades 254 to change the pitch angle of the fan blades 254, as detailed above with respect to FIGS. 23B and 23D.

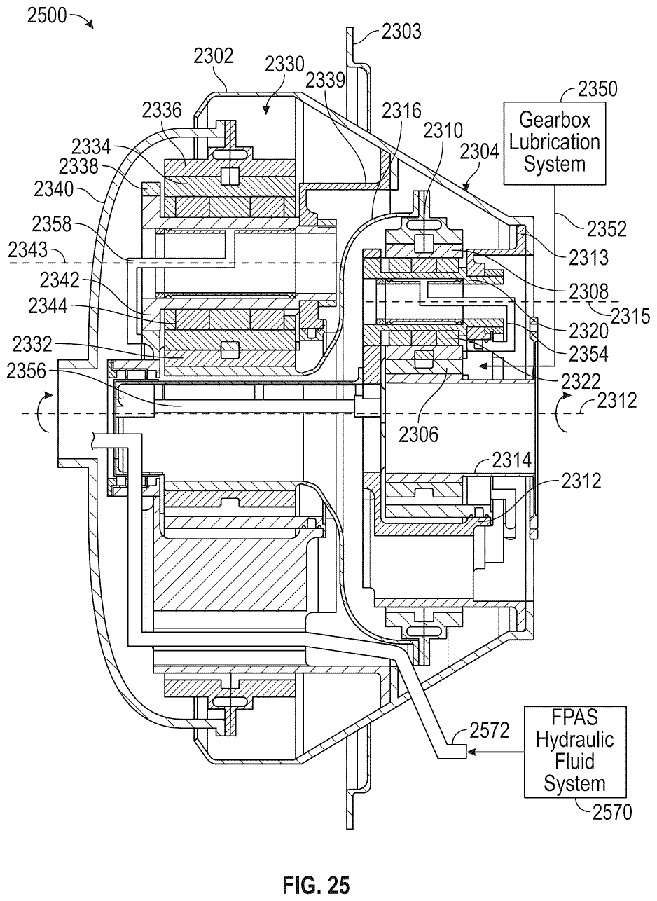

FIG. 25 is a schematic cross-sectional view of a counterclockwise gearbox assembly 2500, taken along a longitudinal centerline axis of the counterclockwise gearbox assembly, according to another embodiment. The counterclockwise gearbox assembly 2500 is substantially similar to the counterclockwise gearbox assembly 2300 of FIGS. 23A to 23C. The same reference numerals will be used for components of the counterclockwise gearbox assembly 2500 that are the same as or similar to the components of the counterclockwise gearbox assembly 2300 discussed above. The description of these components above also applies to this embodiment, and a detailed description of these components is omitted here.

The first turbofan engine 2210a (FIG. 22) includes a fan actuation system (FAS) hydraulic fluid system 2570 for supplying the hydraulic fluid to the FAS 258 (FIG. 2) for actuating the one or more actuators 259 (FIG. 2) to pitch the fan blades 254 (FIG. 2) about their respective pitch axis P. The FAS hydraulic fluid system 2570 includes one or more FAS hydraulic fluid supply lines 2572 for supplying the hydraulic fluid to the FAS 258. The one or more FAS hydraulic fluid supply lines 2572 extend through the counterclockwise gearbox casing 2302 and the second stage gear assembly 2330 and are in fluid communication with the one or more actuators 259 of the FAS 258 for supplying the hydraulic fluid to the one or more actuators 259 to actuate the actuators 259 and to change the pitch of the fan blades 254. In particular, the one or more FAS hydraulic fluid supply lines 2572 extend through the counterclockwise gearbox coupling 2303 of the counterclockwise gearbox casing 2302, and through the second stage planet carrier 2338. In this way, the one or more FAS hydraulic fluid supply lines 2572 extend through the counterclockwise gearbox assembly 2500 (e.g., through the counterclockwise gearbox casing 2302) from an input side of the counterclockwise gearbox assembly 2500 to an output side of the counterclockwise gearbox assembly 2500 and extend to the one or more actuators 259.

Accordingly, the double gearbox configuration of the present disclosure provides for reducing a radial envelope (radial extent) of the gearbox assembly as compared to gearbox assemblies that achieve a particular output rotational direction by other means, such as, for example, the use of idler gears. In this way, the double gearbox configuration of the present disclosure helps to maximize a size of the core flowpath of the turbine engine as compared to turbine engines without the benefit of the present disclosure. Further, the engine system of the present disclosure reduces the fuel burn and noise as compared to the asymmetric configuration. Further, the star configuration of the first stage gear assembly (stationary planet gears) allows the fan pitch actuation system supply lines to be routed through the gearbox assembly (through the planet carrier of the first stage gear assembly) to fit within the available space of the turbofan engine. Further, the gearbox assemblies achieve a gear ratio less than or equal to 14:1 (e.g., 6:1 to 14:1) by using the star configuration, which allows for larger planet gears as compared to the planetary configuration of turboprop engines to withstand the higher loads and the higher torques as compared to turboprop engines.

The turbofan engines of the engine system herein are counter-rotating in which the fan of the first turbofan engine rotates in the counterclockwise direction and the fan of the second turbofan engine rotates in the clockwise direction. Such a configuration allows both turbofan engines to have the same input rotational direction (e.g., counterclockwise) while having different output rotational directions (e.g., counterclockwise on one engine and clockwise on the other engine).

The gearbox assembly can also include idler gears to keep the gearbox assembly more compact so that the gearbox assembly can fit within the limited space underneath the fan. The idler gears allow for the sun gear, the planet gears, or the ring gear to be smaller, while maintaining the overall gear ratio and the torque and speed transfer between the low-pressure shaft and the fan shaft. Thus, the idler gears allow the gearbox assembly to fit within the limited space of turbofan engines while handling the higher loads of turbofan engines as compared to turboprop engines. The space requirements for the gearbox assembly with idler gears, however, competes with the space requirements of the fan actuation system. In particular, the idler gears add axial length to the gearbox assembly, thus, reducing the axial space available for the fan actuation system. Accordingly, a turbine engine having a FAS value or a FASL value within the ranges detailed herein accounts for the more limited axial space due to the longer gearbox assembly with idler gears. Accordingly, the gearbox assemblies disclosed herein enable the FAS and FASL envelopes detailed above to enable fan actuation systems able to achieve the necessary loads for adequately pitching the fan blades due to the inclusion of the idler gears while fitting within the limited space the turbofan engine.

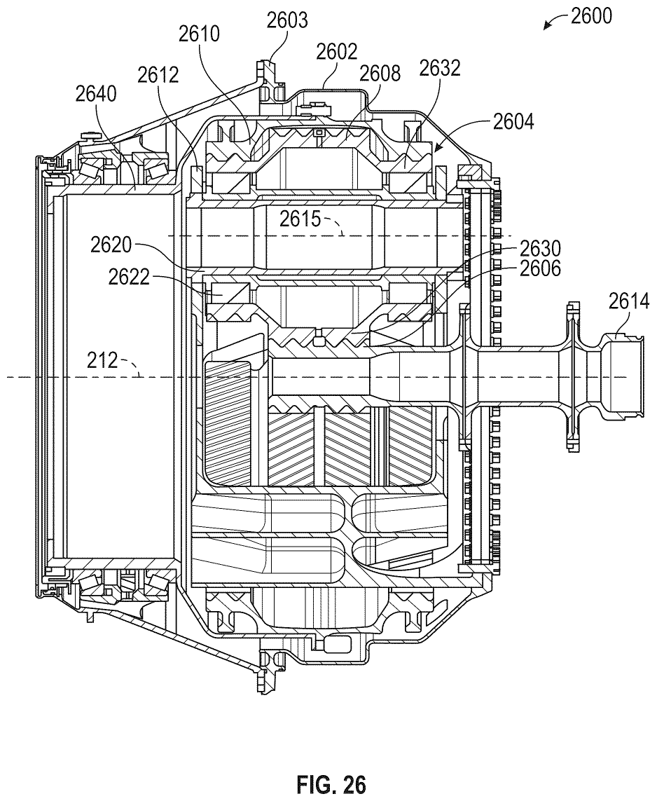

FIG. 26 is a schematic cross-sectional view of a counterclockwise gearbox assembly 2600, taken along the longitudinal centerline axis 212 of the counterclockwise gearbox assembly 2600, according to another embodiment.

The counterclockwise gearbox assembly 2600 can be utilized as the gearbox assembly 255 of the turbofan engine 210 of FIG. 2. In particular, the counterclockwise gearbox assembly 2600 is utilized in the first turbofan engine 2210a of FIG. 22 for rotating the first fan 2252a (FIG. 22) in the first direction 2211 (FIG. 2) (counterclockwise direction).

The counterclockwise gearbox assembly 2600 has a counterclockwise rotational output (e.g., the output of the counterclockwise gearbox assembly 2600 rotates in the counterclockwise direction). The counterclockwise gearbox assembly 2600 includes a counterclockwise gearbox casing 2602 shaving a counterclockwise gearbox coupling 2603 that couples the counterclockwise gearbox assembly 2600 to a static structure of the turbofan engine (e.g., the fan frame 271). The counterclockwise gearbox coupling 2603 is a flex mount that is a mounting structure that couples the gearbox assembly to the static structure of the turbofan engine.

The counterclockwise gearbox assembly 2600 is a single gearbox assembly that includes only one stage of gears. In particular, the counterclockwise gearbox assembly 2600 includes a gear assembly 2604 that is contained within the counterclockwise gearbox casing 2602. As detailed further below, the gear assembly 2604 is an epicyclic gear assembly in a star configuration. In this way, the input and the output of the gear assembly 2604 rotates in the counterclockwise direction. The counterclockwise gearbox assembly 2600 has a gear ratio in a range of 6:1 to 12:1, of 7:1 to 11:1, or of 8:1 to 10:1. Preferably, the counterclockwise gearbox assembly 2400 has a gear ratio of 8.57:1.

The gear assembly 2604 is an epicyclic gear assembly and includes a sun gear 2606, a plurality of planet gears 2608 (only two of which are visible in FIG. 26), and a ring gear 2610. For clarity, only a portion of the gears is shown. The plurality of planet gears 2608 is contained and supported by a planet carrier 2612 (shown schematically in FIG. 26). The gear assembly 2604 is a star configuration, in which the planet carrier 2612 is held fixed, with the ring gear 2610 allowed to rotate. For example, the planet carrier 2612 is coupled to the counterclockwise gearbox casing 2602 (which is coupled to the static structure of the turbofan engine) via a planet carrier coupling 2613.

The counterclockwise gearbox assembly 2600 includes an input shaft 2614 and an output shaft 2640. In FIG. 26, the sun gear 2606 is coupled to the input shaft 2614. In some embodiments, the input shaft 2614 and the sun gear 2606 are a single unitary component. The input shaft 2614 is coupled to the turbine section (FIG. 2) of the first turbofan engine 2210a (FIG. 22). For example, the input shaft 2614 can be coupled to, or can embody, the LP shaft 238 (FIG. 2). Radially outward of the sun gear 2606, and intermeshing therewith, is the plurality of planet gears 2608 that is coupled together and supported by the planet carrier 2612. The planet carrier 2612 supports the plurality of planet gears 2608 such that the plurality of planet gears 2608 is held fixed with respect to the longitudinal centerline axis 212, while enabling each planet gear 2608 of the plurality of planet gears 2608 to rotate about a planet gear longitudinal axis 2615 of each planet gear 2608. Radially outwardly of the plurality of planet gears 2608, and intermeshing therewith, is the ring gear 2610, which is an annular ring gear. In the star configuration, the output shaft 2640 is driven by the ring gear 2610.

Each of the planet gears 2608 includes a planet pin 2620, about which a respective planet gear 2608 rotates. For example, the planet pin 2620 is disposed within a respective planet gear 2608. Each of the planet gears 2608 is supported by one or more roller bearings 2622 disposed radially between the planet pin 2620 and the planet gear 2608. FIG. 26 shows the one or more roller bearings 2622 include two roller bearings 2622 that are spaced axially from each other. A respective planet gear 2608, however, can include any number of roller bearings 2622 for supporting rotation of the planet gear 2608 about the planet pin 2620. As detailed further below, a lubricant (e.g., oil) is supplied to the gear assembly 2604 to lubricate the gears and the roller bearings 2622. In some embodiments, the roller bearings 2622 can be formed from a ceramic material. In some embodiments, the roller bearings 2622 can be lubricated by under-race lubrication, in which lubrication is directed under the inner race and forced out through a plurality of holes in the inner race. In some embodiments, an inner supporting element of both sets of the roller bearings 2622 can be a solid unique element.

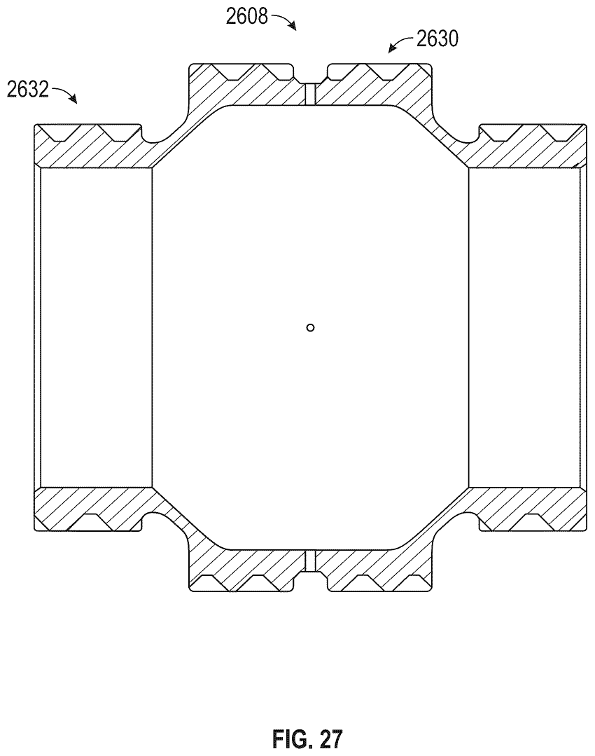

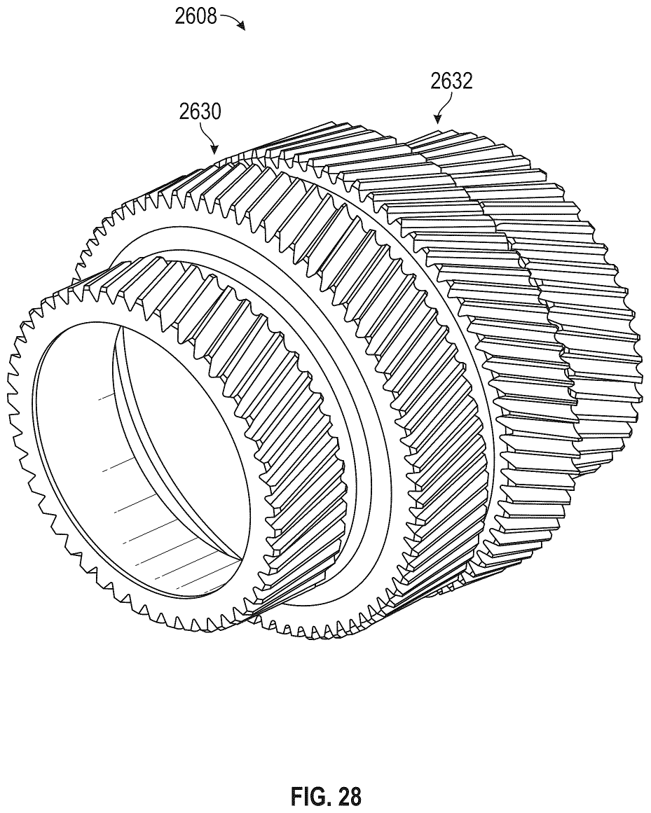

FIG. 27 is a cross-sectional view of a planet gear 2608 of the counterclockwise gearbox assembly 2600 isolated from the counterclockwise gearbox assembly 2600, according to the present disclosure. FIG. 28 is a schematic view of the planet gear 2608, according to the present disclosure.

As shown in FIGS. 26 to 28, each of the plurality of planet gears 2608 is a compound gear that includes a planet gear first stage 2630 and a planet gear second stage 2632 coupled together. The planet gear first stage 2630 includes a greater diameter than a diameter of the planet gear second stage 2632. In some embodiments, the diameter of the planet gear first stage 2630 is equal to or less than the diameter of the planet gear second stage 2632. The diameters of the planet gear first stage 2630 and the planet gear second stage 2632 can be selected to change a gear ratio split between the planet gear first stage 2630 and the planet gear second stage 2632.

The counterclockwise gearbox assembly 2600 includes a gear ratio that defines a ratio of the speed of the input gear (e.g., the sun gear 2606) to the speed of the output (e.g., the ring gear 2610) through the gearbox assembly 2600. Embodiments of the present disclosure detailed herein provide for increased gear ratios for a fixed gear envelope (e.g., with the same size ring gear), or alternatively, a smaller diameter ring gear may be used to achieve the same gear ratios. Thus, the embodiments disclosed herein allow for gear ratios suitable for large diameter engines, or for smaller diameter engines. A total gear ratio of the planet gear 2608 includes a first gear ratio of the planet gear first stage 2630 and a second gear ratio of the planet gear second stage 2632. The first gear ratio of the planet gear first stage 2630 is less than the second gear ratio of the planet gear second stage 2632. In some embodiments, the first gear ratio of the planet gear first stage 2630 is greater than or equal to the second gear ratio of the planet gear second stage 2632. In the embodiment of FIGS. 26 to 28, the total gear ratio of the planet gear 2608 is between seven (7:1) and twelve (12:1). The total gear ratio is selected based on engine size and power requirements and a selection of components for a particular gearbox assembly 2600. For example, the total gear ratio is based on the speed of the fan (e.g., the tip speed of the fan) and the speed of the low-pressure turbine (e.g., based on the number of stages of the low-pressure turbine). In some embodiments, the gear ratio split between the planet gear first stage 2630 and the second stage planet gear can range from 40% to 60% for each stage (i.e., from 40% to 60% for the planet gear first stage 2630 and from 60% to 40% for the planet gear second stage 2632).

In operation, the input shaft 2614 (e.g., the LP shaft 238) rotates and transfers torque to the output shaft 2640 through the gear assembly 2604. In particular, the input shaft 2614 transfers the torque to the sun gear 2606, causing the sun gear 2606 to rotate. The input shaft 2614 and the sun gear 2606 rotate in the counterclockwise direction. The sun gear 2606 transfers the torque to the plurality of planet gears 2608 and drives the plurality of planet gears 2608 such that each planet gear 2608 rotates about the planet gear longitudinal axis 2615. The plurality of planet gears 2608 rotates in the clockwise direction (e.g., in a direction opposite of the sun gear 2606). The planet carrier 2612 holds the plurality of planet gears 2608 stationary with respect to the longitudinal centerline axis 212. The plurality of planet gears 2608 transfers the torque to the ring gear 2610 and drives the ring gear 2610 such that the ring gear 2610 rotates, thus, causing the output shaft 2640 to rotate. The ring gear 2610 (and the output shaft 2640) rotates in the clockwise direction such that the ring gear 2610 rotates in the same direction as the planet gears 2608 and in a different direction as the sun gear 2606.

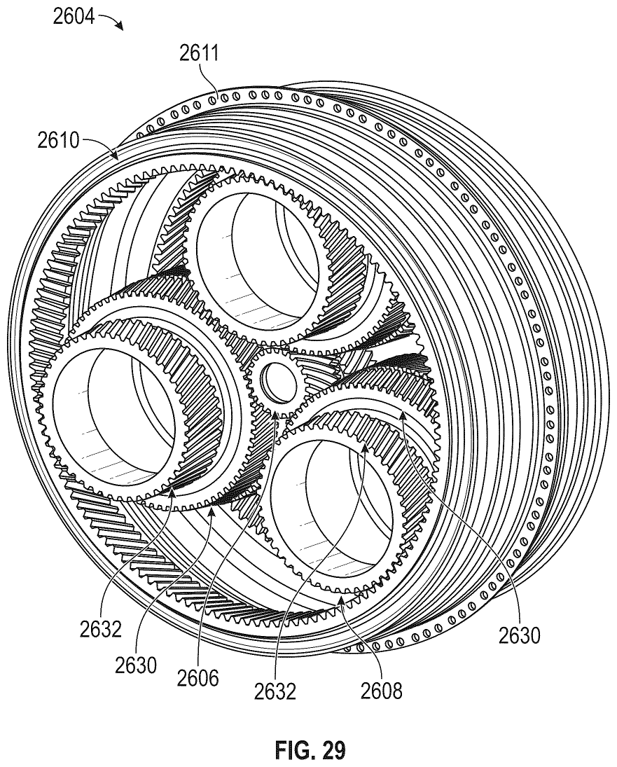

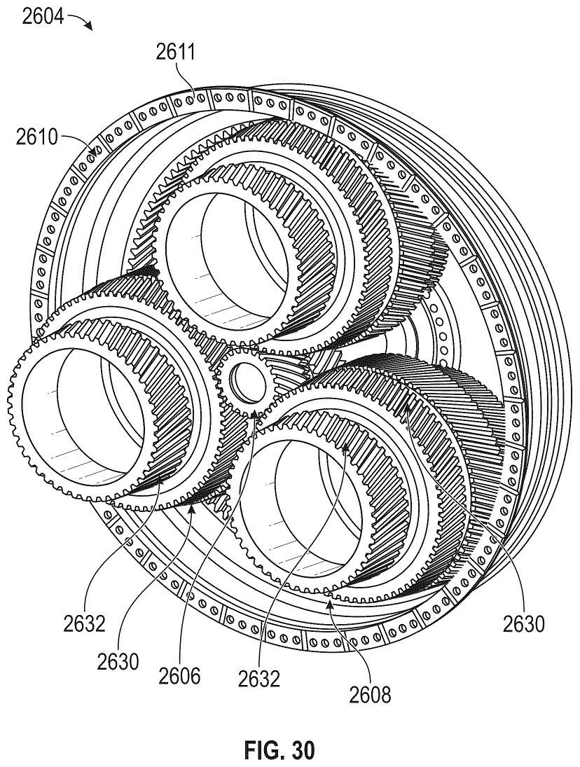

FIG. 29 is a schematic view of the gear assembly 2604 of the counterclockwise gearbox assembly 2600 and isolated from the counterclockwise gearbox assembly 2600, according to the present disclosure. FIG. 30 is a schematic view of the gear assembly 2604, with a portion of a ring gear 2610 removed for clarity, according to the present disclosure.

As shown in FIGS. 29 and 30, the sun gear 2606, the planet gears 2608, and the ring gear 2610 are double helical gears with a first set of helical teeth and a second set of helical teeth that are inclined at an acute angle relative to each other. In this way, the gears mesh with each other at a bi-helical mesh. The bi-helical meshes of the planet gears 2608 axially balance the load over the four (phased) gear sets of each compound planet gear. The helical teeth include a helix angle with respect to the axis of rotation of the gears. The helix angle is in a range of twenty-two point five degrees (22.5°) to thirty-two point five degrees (32.5°) to balance the requirement for an increased stiffness in the mesh with the above considerations of the geometry and heat treatment, the tooling, or the resulting axial load. Preferably, the helix angle is thirty degrees (30°) to provide a greater stiffness in the mesh, while accounting for the considerations above for gearboxes with gear ratios above 7:1. The helix angle can be changed to change a stiffness of the mesh between the gears.

The stiffness of the gears in the gearbox assembly affect the vibrations of the gearbox assembly, thereby effecting vibrations from the gearbox assembly to the low-speed shaft, and, thus, the length LMSR of the low-speed shaft and the MSR and the MEFR. For example, vibrations in the gearbox assembly (e.g., from the gears) propagate through the gearbox assembly, thereby vibrating the gearbox assembly, and the vibrations can propagate through to the low-pressure shaft. Accordingly, the gear teeth type and an angle (e.g., the helix angle) of the gear teeth can be selected to achieve a particular vibrational response in the gearbox assembly so as to avoid exciting the low-pressure shaft when the low-pressure shaft is operating subcritical.

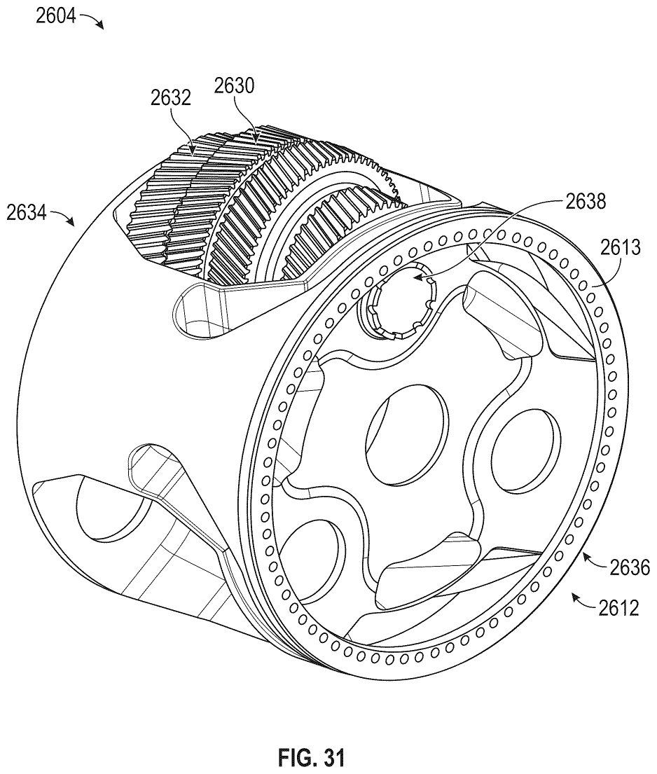

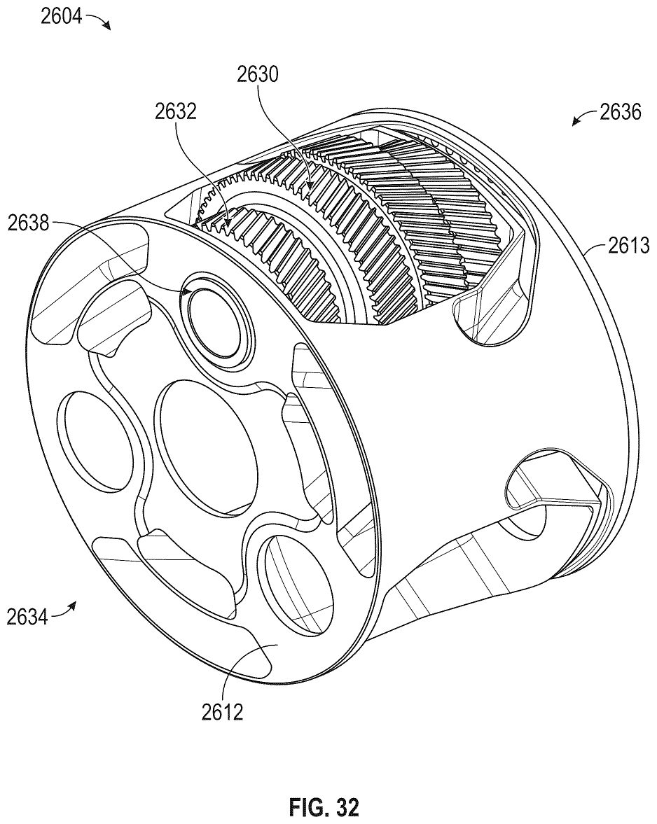

FIG. 31 is an aft schematic view of a planet carrier 2612, according to the present disclosure. FIG. 32 is a forward schematic view of the planet carrier 2612, according to the present disclosure. As shown in FIGS. 31 and 32, the planet carrier 2612 extends from a forward side 2634 to an aft side 2636. The planet gears 2608 extend through an opening 2638 in the forward side 2634 and the aft side 2636 of the planet carrier 2612. In some embodiments, the planet carrier 2612 can be connected to the engine frame via a flexible support system via the planet carrier coupling 2613, with the flexible support system being configured to collect oil and scavenge oil via holes at a lower portion of the flexible support system.

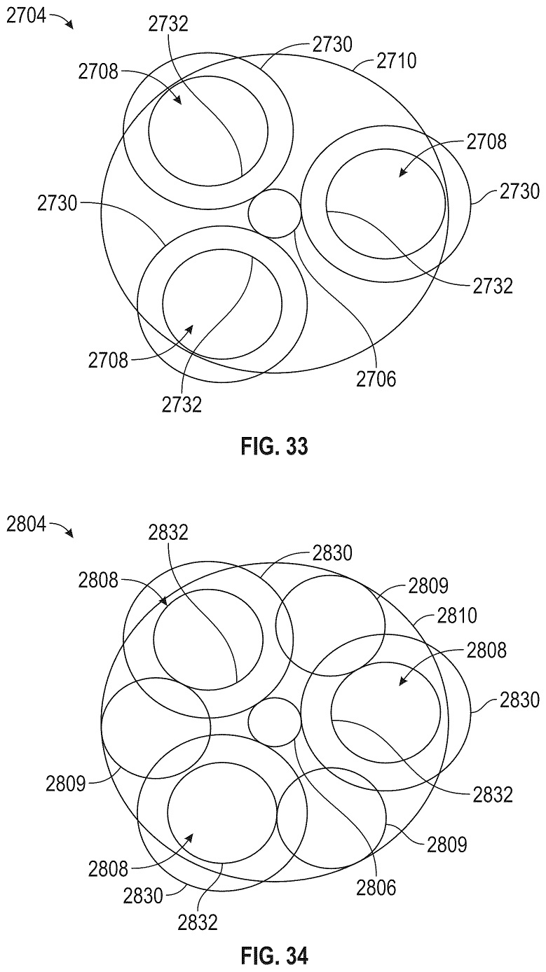

The following are exemplary gear assemblies that can reverse the rotational direction of a turbofan engine according to the examples disclosed herein. In this way an aircraft can comprise at least one turbofan engine rotating in a first direction (with the gear assembly 2604) and at least one turbofan engine rotating in a second direction (with one of the gear assemblies of FIGS. 33 to 36). For example, an aircraft with a pair of turbofan engines can include a first turbofan engine having fan blades rotating in a first rotational direction (e.g., clockwise or counterclockwise), and a second turbofan engine having fan blades rotating in a second rotating direction (e.g., clockwise or counterclockwise) that is opposite to the first rotational direction. For aircraft with more than two turbofan engines, the turbofan engines on the same side of the aircraft body can rotate in the same direction relative to each other, or different directions. Such assemblies may replace or be used with any of the gear assemblies previously described, and can be incorporated into any engine design, including those discussed above.

In one embodiment, the direction of a second turbofan engine of a pair of turbofan engines can be reversed while keeping a substantially similar configuration for the engine components by introducing a plurality of idler gears to the gear assembly driving the fan blades of the turbofan engine. FIGS. 33 and 34 show two exemplary gear assembly configurations for reversing the rotational direction of one turbofan engine of a pair of turbofan engines relative to the rotational direction of the other turbofan engine.

FIG. 33 is a schematic view of a gear assembly 2704 for a counterclockwise gearbox assembly, according to the present disclosure. The gear assembly 2704 can be utilized in the gearbox assembly 255 of the turbofan engine 210 of FIG. 2. In particular, the gear assembly 2704 is utilized in the first turbofan engine 2210a of FIG. 22 for rotating the first fan 2252a (FIG. 22) in the first direction 2211 (FIG. 22) (counterclockwise direction).

The gear assembly 2704 is a star configuration with a sun gear 2706, a plurality of planet gears 2708, and a ring gear 2710. The planet gears 2708 include a planet gear first stage 2730 and a planet gear second stage 2732. The gear assembly 2704 operates substantially similar as to the gear assembly 2604 of FIG. 26. In particular, the sun gear 2706 rotates in the counterclockwise direction, the planet gears 2708 rotate in the clockwise direction, and the ring gear 2710 rotates in the clockwise direction. In this way the output shaft (coupled to the ring gear 2710) rotates in a direction opposite to the input shaft (coupled to the sun gear 2706).

FIG. 34 is a schematic view of a gear assembly 2804 for a clockwise gearbox assembly, according to the present disclosure. The gear assembly 2804 can be utilized in the gearbox assembly 255 of the turbofan engine 210 of FIG. 2. In particular, the gear assembly 2804 is utilized in the second turbofan engine 2210b of FIG. 22 for rotating the second fan 2252b (FIG. 22) in the second direction 2213 (FIG. 22) (clockwise direction).

The gear assembly 2804 is a planetary configuration with a sun gear 2806, a plurality of planet gears 2808, and a ring gear 2810. The planet gears 2808 include a planet gear first stage 2830 and a planet gear second stage 2832. The gear assembly 2804 includes a plurality of idler gears 2809. The plurality of idler gears 2809 are disposed between the planet gears 2808 and the ring gear 2810. In particular, the idler gears 2809 mesh with the planet gear second stage 2832 and the ring gear 2810.

In operation, the sun gear 2806 rotates in the counterclockwise direction and the plurality of planet gears 2808 rotate in the clockwise direction. The planet gear second stage 2832 transfers torque to the idler gears 2809, causing the idler gears 2809 to rotate in the counterclockwise direction. The idler gears 2809 engage the ring gear 2810, causing the ring gear 2810 to rotate in the counterclockwise direction. In this way the output shaft (coupled to the ring gear 2810) rotates in the same direction as the input shaft (coupled to the sun gear 2806). Because the idler gears 2809 are positioned between the planet gear second stage 2832 of the planet gears 2808 and the ring gear 2810, the idler gears 2809 may experience cyclical fatigue in two directions, compared with the one direction experienced by the planet gears 2808. To address this additional direction of cyclical stress, in some examples, the ring gear 2180, the planet gears 2808, the idler gears 2809, and the sun gear 2806, may be made with a greater gear module (i.e., with thicker teeth) to improve the expected service life of the part before failure necessitates repair or replacement.

Preferably, the gear ratios of gear assembly 2704 and gear assembly 2804 are the same, or similar (e.g., within 5% of one another). In this way, different turbofan engines (e.g. the first turbofan engine 2210a or the second turbofan engine 2210b) on the same aircraft can cause the respective fan assemblies to rotate in different directions. In addition, since the gear assemblies are similar except for the idler gears and related aspects, common components can be used in each of the two gear assemblies reducing the number of parts required to assemble and maintain the engines, and the two gear assemblies can achieve the same, or similar, outputs.

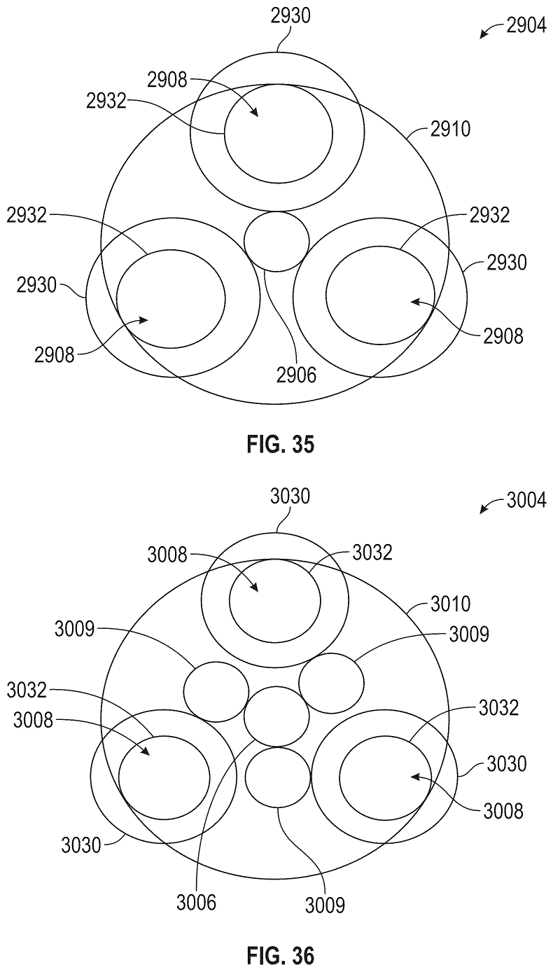

FIGS. 35 and 36 show another embodiment of two gear assembly configurations for reversing the rotational direction of one turbofan engine of a pair of turbofan engines relative to the rotational direction of the other turbofan engine. As in other embodiments, the arrangement of FIGS. 35 and 36 advantageously maintain a substantially similar configuration for the engine components between the two different arrangements of FIGS. 35 and 36.

FIG. 35 is a schematic view of a gear assembly 2904 for a counterclockwise gearbox assembly, according to the present disclosure. The gear assembly 2904 can be utilized in the gearbox assembly 255 of the turbofan engine 210 of FIG. 2. In particular, the gear assembly 2904 is utilized in the first turbofan engine 2210a of FIG. 22 for rotating the first fan 2252a (FIG. 22) in the first direction 2211 (FIG. 22) (counterclockwise direction).

The gear assembly 2904 is a star configuration with a sun gear 2906, a plurality of planet gears 2908, and a ring gear 2910. The planet gears 2908 include a planet gear first stage 2930 and a planet gear second stage 2932. The gear assembly 2904 operates substantially similar as to the gear assembly 2604 of FIG. 26. In particular, the sun gear 2906 rotates in the counterclockwise direction, the planet gears 2908 rotate in the clockwise direction, and the ring gear 2910 rotates in the clockwise direction. In this way the output shaft (coupled to the ring gear 2910) rotates in a direction opposite to the input shaft (coupled to the sun gear 2906).

FIG. 36 is a schematic view of a gear assembly 3000 for a clockwise gearbox assembly, according to the present disclosure. The gear assembly 3004 can be utilized in the gearbox assembly 255 of the turbofan engine 210 of FIG. 2. In particular, the gear assembly 3004 is utilized in the second turbofan engine 2210b of FIG. 22 for rotating the second fan 2252b (FIG. 22) in the second direction 2213 (FIG. 22) (clockwise direction).

The gear assembly 3004 is a planetary configuration with a sun gear 3006, a plurality of planet gears 3008, a plurality of idler gears 3009, and a ring gear 3010. The planet gears 3008 include a planet gear first stage 3030 and a planet gear second stage 3032. The idler gears 3009 mesh with the sun gear 3006 and the planet gears 3008. In particular, the idler gears 3009 mesh with the sun gear 3006 and the planet gear first stage 3030.

The gear assembly 3004 operates substantially similar as to the gear assembly 2804 of FIG. 28. In particular, the sun gear 3006 rotates in the counterclockwise direction, the idler gears 3009 rotate in the clockwise direction, the planet gears 3008 rotate in the counterclockwise direction, and the ring gear 3010 rotates in the counterclockwise direction. In this way the output shaft (coupled to the ring gear 3010) rotates in the same direction as the input shaft (coupled to the sun gear 3006).

Because the idler gears 3009 are positioned between the sun gear 3006 and the planet gears 3008, several advantages are achieved relative to conventional systems as well as other embodiments described herein. These advantages can include, for example, weight savings, reduced axial and radial envelopes, more efficient gearbox assembly and engine integration, and improved access for routing of different components across the gearbox assembly.

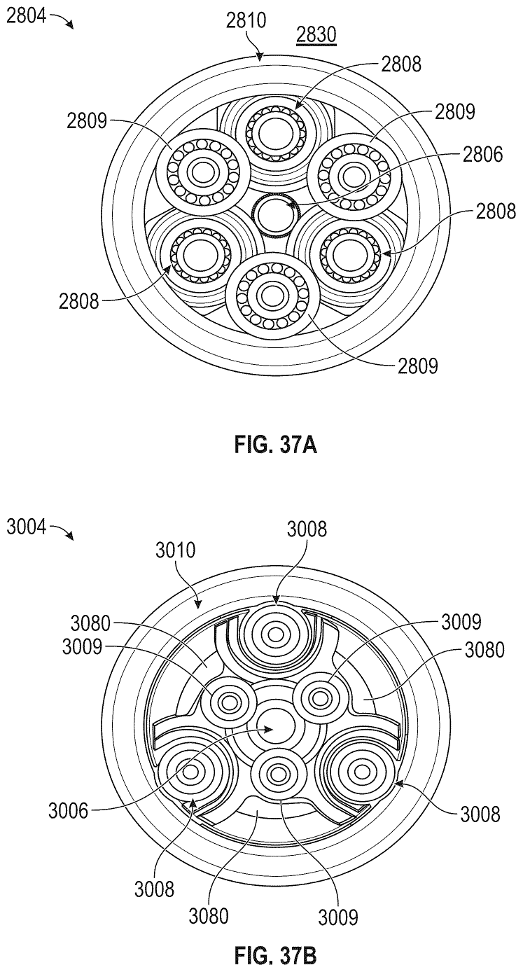

FIGS. 37A and 37B are additional schematic illustrations showing the configuration described above with respect to FIGS. 34 and 36, respectively. As in FIG. 34, FIG. 37A illustrates the gear assembly 2804 with the sun gear 2806, the plurality of planet gears 2808 having the planet gear first stage 2830 and the planet gear second stage 2832, the plurality of idler gears 2809, and the ring gear 2810. On the other hand, FIG. 37B illustrates the gear assembly 3004 with the sun gear 3006, the plurality of planet gears 3008 having the planet gear first stage 3030 and the planet gear second stage 3032, the plurality of idler gears 3009, and the ring gear 3010. Relative to FIG. 37A, the gear assembly 3004 of FIG. 37B provides additional access areas 3080 (e.g., pass through openings) on the static structures through which lines (FAS hydraulic fluid lines) and other components can pass axially across the gear assembly 3004.

As with the other idler gears described above, in some examples, the idler gears 3009 and other components may be made with a greater gear module (i.e., with thicker teeth) to improve the expected service life of the part before failure necessitates repair or replacement.

As described above, the gear assembly 3004 of FIGS. 36 and 37B can advantageously result in reduced axial and radial envelopes. For example, for gear ratios in the range of 5:1 to 12:1, the axial envelope (i.e., the maximum width) of gear assembly 3004 can be in a range from 355 mm to 395 mm, and in some embodiments, in a range from 360 mm to 390 mm, with a corresponding radial envelope (i.e., a maximum diameter) of the gear assembly being in a range from 2800 mm to 1300 mm, and in some embodiments, in a range from 700 mm to 1100 mm.

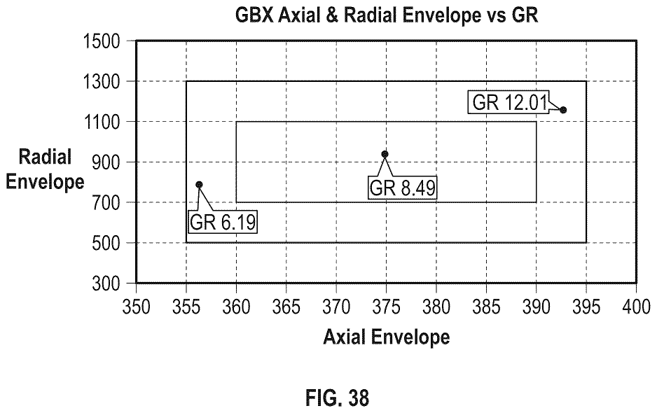

FIG. 38 is a chart illustrating preferred ranges for an axial envelope and a radial envelope, according to the present disclosure. As shown in FIG. 38, in one example, a gear assembly having a gear ratio of 6.19:1 can have an axial envelope of approximately 356 mm and a radial envelope of approximately 800 mm, a gear assembly having a gear ratio of 8.49:1 can have an axial envelope of approximately 375 mm and a radial envelope of approximately 950 mm, and a gear assembly having a gear ratio of 12.01:1 can have an axial envelope of approximately 393 mm and a radial envelope of approximately 1150 mm.

Referring to FIG. 38, in some embodiments, a ratio of the radial envelope to the axial envelope for a gear assembly, with a gear ratio in the 5:1 to 12:1 range, can desirably be between 1.26 (e.g., 2800/395) and 3.66 (e.g., 1300/355). For gear assemblies with a gear ratio in the 7:1 to 10:1 range, a ratio of the radial envelope to the axial envelope, can desirably be between 1.79 (e.g., 700/390) and 3.05 (e.g., 1100/360).

Using the above novel modifications to gear assemblies, different turbofan engines (e.g., the first turbofan engine 2210a or the second turbofan engine 2210b) on the same aircraft can cause the respective fan assemblies to rotate in different directions. In addition, since the gear assemblies are similar except for the idler gears and related aspects, common components can be used in each of the two gear assemblies reducing the number of parts required to assemble and maintain the engines, and the two gear assemblies can achieve the same, or similar, outputs.

Advantageously, this solution allows for identical or nearly identical primary gear assemblies to be used in both the first engine and the second engine of the pair of engines since the fan rotation in one of the engines is achieved by reversing the direction of rotation of the input shaft with a secondary gear assembly (e.g., idler gears) as described herein.

When the rotational direction of one or more fan assemblies is reversed according to any of the options discussed above, several of the shortcomings of gas turbine engines can be mitigated or corrected while requiring only minimal changes to the overall engine design.

For example, the yaw forces introduced by each engine can be reversed, allowing the yaw forces of engines operating in opposite rotational directions to cancel each other out, reducing or eliminating aircraft yaw and improving operational efficiency of the aircraft. Furthermore, the ability to select rotational direction of engines located near the wingtips may allow for the attenuation of wing tip vortices, resulting in a further improvement to operational efficiency.

For open fan engines run in opposing directions, possible debris from the engines can be projected away from the fuselage or from neighboring engines, reducing the likelihood of cross-engine debris damage. Additionally, the airflow off of all engines may be directed away from the aircraft cabin, reducing the undesirable noise and turbulence in the passenger compartment.

Because these results can be achieved with only minimal changes to the gearbox designs as disclosed herein, these advantageous results can be obtained without a significant increase in manufacture or maintenance costs for the aircraft.

Further aspects are provided by the subject matter of the following clauses.

A turbofan engine for an aircraft, the turbofan engine comprising a fan having a plurality of fan blades, each of the plurality of fan blades being rotatable about a pitch axis, and a fan actuation system including one or more actuators for rotating the plurality of fan blades about the pitch axis and one or more radial thrust bearings, wherein the fan actuation system is characterized by a fan actuation system envelope in a range from 300 to 1860, the fan actuation system envelope being given by:

$$\frac{{N}_{FB} \times {D}_{FT} \times {M}_{cruise}}{( \frac{{R}_{TB}}{{N}_{FB}} )}$$

wherein N_{FB} is a number of the plurality of fan blades, D_{FT} is a fan tip diameter of the plurality of fan blades, M_{cruise} is a Mach number of the aircraft at cruise operating conditions, and R_{TB} is a thrust bearing radius of the one or more radial thrust bearings.

A turbofan engine for an aircraft, the turbofan engine comprising a fan having a plurality of fan blades, each of the plurality of fan blades being rotatable about a pitch axis, a nacelle that circumferentially surrounds the fan, and a fan actuation system including one or more actuators for rotating the plurality of fan blades about the pitch axis and one or more radial thrust bearings, wherein the fan actuation system is characterized by a fan actuation system envelope in a range from 300 to 660, the fan actuation system envelope being given by:

$$\frac{{N}_{FB} \times {D}_{FT} \times {M}_{cruise}}{( \frac{{R}_{TB}}{{N}_{FB}} )}$$

wherein N_{FB} is a number of the plurality of fan blades, D_{FT} is a fan tip diameter of the plurality of fan blades, M_{cruise} is a Mach number of the aircraft at cruise operating conditions, and R_{TB} is a thrust bearing radius of the one or more thrust bearings.

A turbofan engine for an aircraft, the turbofan engine comprising a fan having a plurality of fan blades, the fan being an open fan, and each of the plurality of fan blades being rotatable about a pitch axis, and a fan actuation system including one or more actuators for rotating the plurality of fan blades about the pitch axis and one or more radial thrust bearings, wherein the fan actuation system is characterized by a fan actuation system envelope in a range from 660 to 1860, the fan actuation system envelope being given by:

$$\frac{{N}_{FB} \times {D}_{FT} \times {M}_{cruise}}{( \frac{{R}_{TB}}{{N}_{FB}} )}$$

wherein N_{FB} is a number of the plurality of fan blades, D_{FT} is a fan tip diameter of the plurality of fan blades, M_{cruise} is a Mach number of the aircraft at cruise operating conditions, and R_{TB} is a thrust bearing radius of the one or more radial thrust bearings.

The turbofan engine of any preceding clause, wherein the fan actuation system includes a hydraulic system that supplies hydraulic fluid for rotating the plurality of fan blades about the pitch axis.

The turbofan engine of any preceding clause, wherein the cruise operating conditions occur at a mid-level power range of the turbofan engine.

The turbofan engine of the preceding clause, wherein the mid-level power range is 30% to 85% of a sea level static maximum engine rated thrust for the turbofan engine.

The turbofan engine of any preceding clause, wherein the turbofan engine is rated for use on a regional aircraft having a maximum takeoff thrust of 10,000 lbf to 20,000 lbf.

The turbofan engine of any preceding clause, wherein the turbofan engine is rated for use on a narrow body aircraft having a maximum takeoff thrust of 15,000 lbf to 30,000 lbf.

The turbofan engine of any preceding clause, wherein the turbofan engine is rated for use on a wide body aircraft having a maximum takeoff thrust of 40,000 lbf to 110,000 lbf.

The turbofan engine of any preceding clause, wherein N_{FB} is in a range from ten to eighteen.

The turbofan engine of any preceding clause, wherein NEB is in a range from ten to fourteen.

The turbofan engine of any preceding clause, wherein D_{FT} is in a range from 84.0 inches to 180.0 inches.

The turbofan engine of any preceding clause, wherein D_{FT} is in a range from 84.0 inches to 120.0 inches.

The turbofan engine of any preceding clause, wherein D_{FT} is in a range from 120.0 inches to 168.0 inches.

The turbofan engine of any preceding clause, wherein R_{TB} is in a range from 14 inches to 27 inches.

The turbofan engine of any preceding clause, wherein R_{TB} is in a range from 14 inches to 19 inches.

The turbofan engine of any preceding clause, wherein R_{TB} is in a range from 19 inches to 27 inches.

The turbofan engine of any preceding clause, wherein M_{cruise} is in a range from 0.7 to 0.92.

The turbofan engine of any preceding clause, wherein M_{cruise} is in a range from 0.75 to 0.9.

The turbofan engine of any preceding clause, wherein M_{cruise} is in a range from 0.8 to 0.88.

The turbofan engine of any preceding clause, wherein the fan actuation system includes a pressurized pneumatic chamber that is filled with a pressurized gas that biases the plurality of fan blades to a feather position.

The turbofan engine of any preceding clause, wherein the fan actuation system is devoid of counterweights for reducing inertial loading associated with rotation of fan blades.

The turbofan engine of any preceding clause, further comprising core cowl, wherein the turbofan engine has a longitudinal centerline axis, and the core cowl is annular about the longitudinal centerline axis.

The turbofan engine of the preceding clause, further comprising a core inlet that is annular about the longitudinal centerline axis.

The turbofan engine of any preceding clause, further comprising a gearbox assembly, wherein the turbine section includes a low-pressure shaft, and the fan has a fan shaft that is coupled to the low-pressure shaft through the gearbox assembly.

The turbofan engine of the preceding clause, wherein the gearbox assembly has a gear ratio in a range 3.5:1 to 5:1 for a ducted engine.

The turbofan engine of any preceding clause, wherein the gearbox assembly has a gear ratio in a range from 4:1 and 10:1 for an unducted fan engine.

The turbofan engine of any preceding clause, wherein the low-pressure shaft, the gearbox assembly, and the fan shaft are coaxial along the longitudinal centerline axis.

The turbofan engine of any preceding clause, wherein the fan actuation system envelope is in a range from 660 to 1020.

The turbofan engine of any preceding clause, the fan actuation system envelope being in a range from 300 to 660.

The turbofan engine of any preceding clause, the fan actuation system envelope being in a range from 660 to 1860.

The turbofan engine of any preceding clause, the fan actuation system envelope being in a range from 660 to 1020.

The turbofan engine of any preceding clause, further comprising a nacelle that circumferentially surrounds the fan.

The turbofan engine of any preceding clause, wherein the turbofan engine is an open fan engine.

The turbofan engine of any preceding clause, further comprising a fan hub, the plurality of fan blades extending radially from the fan hub.

The turbofan engine of any preceding clause, the fan actuation system being disposed within the fan hub.

The turbofan engine of any preceding clause, further comprising a compressor section, a combustor, and a turbine section.

The turbofan engine of any preceding clause, the compressor section including a low-pressure compressor and a high-pressure compressor, and the turbine section including a high-pressure turbine and a low-pressure turbine.

The turbofan engine of any preceding clause, further comprising a high-pressure shaft that couples the high-pressure compressor and the high-pressure turbine.

The turbofan engine of any preceding clause, further comprising a low-pressure shaft that couples the low-pressure compressor and the low-pressure turbine.

The turbofan engine of any preceding clause, the low-pressure shaft being disposed through the high-pressure shaft.

The turbofan engine of any preceding clause, the gearbox assembly comprising a gear assembly comprising a plurality of gears.

The turbofan engine of any preceding clause, the gearbox assembly including one or more gear bearings.

The turbofan engine of any preceding clause, each of the plurality of fan blades extending from a fan root to a fan tip.

The turbofan engine of any preceding clause, the fan tip diameter DFT being defined from the longitudinal centerline axis to the fan tip of each of the plurality of fan blades.

The turbofan engine of any preceding clause, the fan actuation system including a trunnion mechanism that includes a plurality of trunnions, each fan blade being disposed in a respective trunnion.

The turbofan engine of any preceding clause, the fan blades extending from a disk.

The turbofan engine of any preceding clause, the disk including a plurality of disk segments.

The turbofan engine of any preceding clause, each fan blade being coupled to a respective disk segment at the trunnion mechanism.

The turbofan engine of any preceding clause, the plurality of trunnions being rotatable to rotate the plurality of fan blades about the pitch axis.

The turbofan engine of any preceding clause, the fan actuation system including one or more actuators coupled to the plurality of trunnions.

The turbofan engine of any preceding clause, the fan actuation system including a plurality of trunnion links and a unison ring, the plurality of trunnion links being coupled to the plurality of trunnions and to the unison ring.

The turbofan engine of any preceding clause, the plurality of trunnion links including a plurality of forward trunnion links and a plurality of aft trunnion links.

The turbofan engine of any preceding clause, the unison ring including a plurality of unison rings including a forward unison ring that is positioned forward of the plurality of trunnions and an aft unison ring that is disposed aft of the plurality of trunnions.

The turbofan engine of any preceding clause, the plurality of forward trunnion links being coupled to the forward unison ring.

The turbofan engine of any preceding clause, the plurality of aft trunnion links being coupled to the aft unison ring.

The turbofan engine of any preceding clause, further comprising a plurality of pins that couple the plurality of trunnion links to the unison ring.

The turbofan engine of any preceding clause, the plurality of forward trunnion links being coupled to the forward unison ring by a plurality of forward pins.

The turbofan engine of any preceding clause, the plurality of aft trunnion links being coupled to the aft unison ring by a plurality of aft pins.

The turbofan engine of any preceding clause, the one or more actuators including a hydraulic cylinder and a piston disposed within the hydraulic cylinder.

The turbofan engine of the preceding clause, the hydraulic cylinder and the piston being movable along an axial direction.

The turbofan engine of any preceding clause, the forward unison ring being coupled to the hydraulic cylinder such that the forward unison ring moves when the hydraulic cylinder moves.

The turbofan engine of any preceding clause, the aft unison ring being coupled to the piston such that the aft unison ring moves as the piston moves.

The turbofan engine of any preceding clause, the fan actuation system rotating the plurality of fan blades between a first end position and a second end position.

The turbofan engine of any preceding clause, the first end position being a feather position in which the plurality of fan blades is substantially aligned with a flow of a volume of air across the plurality of fan blades.

The turbofan engine of the preceding clause, the fan actuation system rotating the plurality of fan blades to any position between the first end position and the second end position.

The turbofan engine of any preceding clause, the second end positioned being a reverse position in which the plurality of fan blades exceeds a plane that is transverse to the longitudinal centerline axis by at least 30° to assist with braking the aircraft.

The turbofan engine of any preceding clause, the fan actuation system moving the hydraulic cylinder in a first direction and moving the piston in a second direction.

The turbofan engine of any preceding clause, movement of the hydraulic cylinder and the piston causing the plurality of fan blades to rotate about the pitch axis.

The turbofan engine of any preceding clause, the one or more actuators including a piston retainer.

The turbofan engine of the preceding clause, the piston retainer being coupled to the fan shaft such that the piston retainer rotates with the fan shaft.

The turbofan engine of any preceding clause, the piston being coupled to the piston retainer such that the piston rotates with the piston retainer.

The turbofan engine of any preceding clause, the hydraulic cylinder being axially slidable with respect to the piston and the piston retainer.

The turbofan engine of any preceding clause, the piston retainer comprising a first portion, a second portion that extends radially outward from the first portion, and a third portion that extends axially from the second portion.

The turbofan engine of any preceding clause, the third portion of the piston retainer being coupled to the fan shaft.

The turbofan engine of any preceding clause, the piston being coupled to, and extending forward from, the first portion of the piston retainer.

The turbofan engine of any preceding clause, the hydraulic cylinder being disposed radially outward of the piston retainer and the piston.

The turbofan engine of any preceding clause, the hydraulic cylinder being coupled to the unison ring at a joint such that movement of the hydraulic cylinder in the axial direction causes the plurality of fan blades to pitch about the pitch axis.

The turbofan engine of any preceding clause, the hydraulic cylinder having a first portion, a second portion, a third portion, and a fourth portion.

The turbofan engine of the preceding clause, the first portion of the hydraulic cylinder extending generally in the axial direction and being coupled to the unison ring at the joint.

The turbofan engine of any preceding clause, the second portion of the hydraulic cylinder being disposed radially inward of the first portion and being coupled to the first portion and to the unison ring at the joint.

The turbofan engine of any preceding clause, the third portion of the hydraulic cylinder extending forward from the joint.

The turbofan engine of any preceding clause, the fourth portion of the hydraulic cylinder being coupled to, and extending axially within, the third portion of the hydraulic cylinder.

The turbofan engine of any preceding clause, the first portion of the hydraulic cylinder being sealingly engaged with the third portion of the piston retainer.

The turbofan engine of any preceding clause, the second portion of the piston retainer being sealingly engaged with the first portion of the hydraulic cylinder.

The turbofan engine of any preceding clause, the piston being sealingly engaged with the second portion and the fourth portion of the hydraulic cylinder.

The turbofan engine of any preceding clause, the fan actuation system including one or more hydraulic chambers defined between the hydraulic cylinder, the piston, and the piston retainer.

The turbofan engine of the preceding clause, the one or more hydraulic chambers including a first hydraulic chamber, a second hydraulic chamber, and a third hydraulic chamber.

The turbofan engine of any preceding clause, the first hydraulic chamber being defined between first portion of the hydraulic cylinder, the second portion of the piston retainer, and the third portion of the piston retainer.

The turbofan engine of any preceding clause, the second hydraulic chamber being defined between the first portion of the hydraulic cylinder, the second portion of the hydraulic cylinder, the first portion of the piston retainer, and the second portion of the piston retainer.

The turbofan engine of any preceding clause, the third hydraulic chamber being defined between the second portion of the hydraulic cylinder, an aft end of the piston, and the first portion of the piston retainer,

The turbofan engine of any preceding clause, the first hydraulic chamber and the third hydraulic chamber being supplied with a hydraulic fluid at a first pressure, and the second hydraulic chamber being supplied with the hydraulic fluid at a second pressure.

The turbofan engine of any preceding clause, the first pressure and the second pressure being increased or decreased to cause the hydraulic cylinder to move axially forward or axially rearward to rotate the plurality of fan blades about the pitch axis.

The turbofan engine of any preceding clause, the fan actuation system comprising a hydraulic system that supplies the hydraulic fluid to the one or more hydraulic chambers.

The turbofan engine of any preceding clause, the hydraulic system including a pump to supply the hydraulic fluid to the one or more hydraulic chambers.

The turbofan engine of the preceding clause, the hydraulic system comprising an oil transfer bearing including a fixed portion with a plurality of fluid lines coupled to the pump.

The turbofan engine of the preceding clause, the oil transfer bearing including a sleeve that is rotatable about the fixed portion.

The turbofan engine of any preceding clause, the plurality of fluid lines including a first fluid line in fluid communication with the first hydraulic chamber, a second fluid line in fluid communication with the second hydraulic chamber, and a third fluid line in fluid communication the third hydraulic chamber.

The turbofan engine of any preceding clause, the plurality of fluid lines being coupled to the sleeve.

The turbofan engine of any preceding clause, the first hydraulic chamber and the third hydraulic chamber being provided with the hydraulic fluid at the same first pressure.

The turbofan engine of any preceding clause, the pump supplying the hydraulic fluid to the first hydraulic chamber and the third hydraulic chamber to increase the first pressure P1 and supplying the hydraulic fluid to the second hydraulic chamber to decrease the second pressure P2, to move the hydraulic cylinder in the rearward direction to rotate the plurality of fan blades towards the reverse position.

The turbofan engine of any preceding clause, the pump supplying the hydraulic fluid to the second hydraulic chamber to increase the second pressure P2 and supplying the hydraulic fluid to the first hydraulic chamber and the third hydraulic chamber to decrease the first pressure P1, to move the hydraulic cylinder in the forward direction to rotate the plurality of fan blades towards the feather position.

The turbofan engine of any preceding clause, the one or more actuators further comprising a pressurized pneumatic chamber filled with a pressurized gas to bias the hydraulic cylinder to move the plurality of fan blades to the feather position.

The turbofan engine of any preceding clause, a pressure of the pressurized gas in the pressurized pneumatic chamber being in a range from 720 psi to 920 psi.

The turbofan engine of any preceding clause, the pressurized gas in the pressurized pneumatic chamber causing the hydraulic cylinder to move rearward when the hydraulic system or the turbofan engine fails or is shut down.

The turbofan engine of any preceding clause, the fan actuation system not including a pitch lock device.

The turbofan engine of any preceding clause, the one or more radial thrust bearings being disposed between the plurality of trunnions and the disk such that the plurality of trunnions rotates with respect to the disk to rotate the plurality of fan blades about the pitch axis.

The turbofan engine of any preceding clause, the one or more radial thrust bearings transmitting a load from the plurality of fan blades to a static structure of the turbofan engine.

A turbofan engine for an aircraft, the turbofan engine including a fan having a plurality of fan blades coupled to a fan shaft having one or more fan bearings, each of the plurality of fan blades being rotatable about a pitch axis and extending from a fan hub, and a fan actuation system disposed within the fan hub and including one or more actuators for rotating the plurality of fan blades about the pitch axis and one or more radial thrust bearings, wherein the fan actuation system is characterized by a fan actuation system length envelope in a range from 8.5 to 24, the fan actuation system length envelope being given by

$$\frac{{N}_{FB} \times {D}_{FT}}{{L}_{AXIAL} \times ( \frac{{R}_{TB}}{{N}_{FB}} )} ,$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings.

The turbofan engine of the preceding clause, wherein the fan actuation system includes a pressurized pneumatic chamber that is filled with a pressurized gas that biases the plurality of fan blades to a feather position.

The turbofan engine of any preceding clause, wherein the fan actuation system includes one or more counterweights for reducing inertial loading associated with rotation of the plurality of fan blades.

The turbofan engine of any preceding clause, further comprising a core cowl, wherein the turbofan engine has a longitudinal centerline axis, and the core cowl is annular about the longitudinal centerline axis wherein the core cowl includes a core inlet that is annular about the longitudinal centerline axis.

The turbofan engine of any preceding clause, wherein the fan actuation system includes a hydraulic system that supplies hydraulic fluid for rotating the plurality of fan blades about the pitch axis.

The turbofan engine of any preceding clause, wherein N_{FB} is in a range from ten to eighteen.

The turbofan engine of any preceding clause, wherein N_{FB} is in a range from ten to fourteen.

The turbofan engine of any preceding clause, wherein D_{FT} is in a range from 84.0 inches to 180.0 inches.

The turbofan engine of any preceding clause, wherein D_{FT} is in a range from 84.0 inches to 120.0 inches.

The turbofan engine of any preceding clause, wherein D_{FT} is in a range from 120.0 inches to 180.0 inches.

The turbofan engine of any preceding clause, wherein R_{TB} is in a range from 12 inches to 27 inches.

The turbofan engine of any preceding clause, wherein R_{TB} is in a range from 12 inches to 19 inches.

The turbofan engine of any preceding clause, wherein R_{TB} is in a range from 19 inches to 27 inches.

The turbofan engine of any preceding clause, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings.

The turbofan engine of any preceding clause, wherein A_{FH} is in a range from 25 inches to 75 inches.

The turbofan engine of any preceding clause, wherein A_{FB} is in a range from 16 inches to 23 inches.

The turbofan engine of any preceding clause, wherein the fan actuation system has a fan actuation system axial length (A_{FAS}) defined from an axially forward-most surface of the fan actuation system to the pitch axis of the plurality of fan blades, A_{FAS} being a maximum of 80% A_{FH}.

A turbofan engine for an aircraft, the turbofan engine including a fan having a plurality of fan blades coupled to a fan shaft having one or more fan bearings, each of the plurality of fan blades being rotatable about a pitch axis and extending from a fan hub, a nacelle that circumferentially surrounds the fan, and a fan actuation system disposed within the fan hub and including one or more actuators for rotating the plurality of fan blades about the pitch axis and one or more radial thrust bearings, wherein the fan actuation system is characterized by a fan actuation system length envelope in a range from 8.5 to 13, the fan actuation system length envelope being given by

$$\frac{{N}_{FB} \times {D}_{FT}}{{L}_{AXIAL} \times ( \frac{{R}_{TB}}{{N}_{FB}} )} ,$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings, A_{FH} is in a range from 25 inches to 40 inches, and A_{FB} is in a range from 17 inches to 20 inches.

A turbofan engine for an aircraft, the turbofan engine including a fan having a plurality of fan blades coupled to a fan shaft having one or more fan bearings, the fan being an open fan, and each of the plurality of fan blades being rotatable about a pitch axis and extending from a fan hub, and a fan actuation system disposed within the fan hub and including one or more actuators for rotating the plurality of fan blades about the pitch axis and one or more radial thrust bearings, wherein the fan actuation system is characterized by a fan actuation system length envelope in a range from 8.5 to 24, the fan actuation system length envelope being given by

$$\frac{{N}_{FB} \times {D}_{FT}}{{L}_{AXIAL} \times ( \frac{{R}_{TB}}{{N}_{FB}} )} ,$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, and R_{TB} is a thrust bearing radius of the one or more radial thrust bearings, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings, A_{FH} is in a range from 25 inches to 75 inches, and A_{FB} is in a range from 16 inches to 23 inches, and D_{FT} is in a range from 120.0 inches to 180.0 inches.

The turbofan engine of the preceding clause, wherein R_{TB} is in a range from 12 inches to 27 inches.

A turbofan engine for an aircraft, the turbofan engine including a fan having a plurality of fan blades coupled to a fan disk that is drivingly coupled to a fan shaft, the fan disk defining a disk bore, a fan hub that directs an airflow through the plurality of fan blades, each of the plurality of fan blades being rotatable about a pitch axis and extending from the fan hub, one or more fan bearings that support rotation of the fan shaft, the one or more fan bearings being positioned radially outward of the disk bore, wherein a fan bearing radius ratio is in a range from 1.0 to 2.75, and a fan actuation system disposed within the fan hub and including one or more actuators for rotating the plurality of fan blades about the pitch axis and one or more radial thrust bearings, wherein the fan actuation system is characterized by a fan actuation system length envelope in a range from 8.5 to 24, the fan actuation system length envelope being given by:

$$\frac{{N}_{FB} \times {D}_{FT}}{{L}_{AXIAL} \times ( \frac{{R}_{TB}}{{N}_{FB}} )} ,$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings.

The turbofan engine of the preceding clause, wherein the turbofan engine has a fan hub radius ratio in a range from 0.1 to 0.4.

The turbofan engine of any preceding clause, wherein the one or more radial thrust bearings are tapered roller bearings.

The turbofan engine of any preceding clause, wherein the one or more fan bearings are positioned axially aft of the fan disk.

The turbofan engine of any preceding clause, wherein the fan disk extends between an inner surface and an outer surface, the one or more fan bearings being positioned radially outward of the outer surface.

The turbofan engine of any preceding clause, wherein the one or more fan bearings include at least one of roller bearings or ball bearings.

The turbofan engine of any preceding clause, wherein the ball bearings include four-point contact ball bearings.

The turbofan engine of any preceding clause, further comprising a compressor section, a combustion section, and a turbine section downstream of the fan, the turbine section having an input shaft that couples the compressor section to the turbine section, and a gearbox assembly, the fan shaft being drivingly coupled to the input shaft through the gearbox assembly.

The turbofan engine of any preceding clause, wherein the one or more fan bearings are positioned axially between the fan disk and the gearbox assembly.

The turbofan engine of any preceding clause, wherein the one or more fan bearings are positioned radially outward of the gearbox assembly.

A turbofan engine for an aircraft, the turbofan engine including a fan having a plurality of fan blades coupled to a fan disk that is drivingly coupled to a fan shaft, the fan disk defining a disk bore, and the fan being an open fan, a fan hub that directs an airflow through the plurality of fan blades, each of the plurality of fan blades being rotatable about a pitch axis and extending from the fan hub, one or more fan bearings that support rotation of the fan shaft, the one or more fan bearings being positioned radially outward of the disk bore, wherein a fan bearing radius ratio is in a range from 1.0 to 2.75, and a fan actuation system disposed within the fan hub and including one or more actuators for rotating the plurality of fan blades about the pitch axis and one or more radial thrust bearings, wherein the fan actuation system is characterized by a fan actuation system length envelope in a range of 8.5 to 24, the fan actuation system length envelope being given by

$$\frac{{N}_{FB} \times {D}_{FT}}{{L}_{AXIAL} \times ( \frac{{R}_{TB}}{{N}_{FB}} )} ,$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, and R_{TB} is a thrust bearing radius of the one or more radial thrust bearings, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings, A_{FH} is in a range of 25 inches to 85 inches, and A_{FB} is in a range of 10 inches to 23 inches, and D_{FT} is in a range of 120.0 inches to 192.0 inches.

The turbofan engine of the preceding clause, wherein the turbofan engine has a fan hub radius ratio in a range from 0.1 to 0.4.

The turbofan engine of any preceding clause, wherein the one or more radial thrust bearings are tapered roller bearings.

The turbofan engine of any preceding clause, wherein the one or more fan bearings are positioned axially aft of the fan disk.

The turbofan engine of any preceding clause, wherein the fan disk extends between an inner surface and an outer surface, the one or more fan bearings being positioned radially outward of the outer surface.

The turbofan engine of any preceding clause, wherein the one or more fan bearings include at least one of roller bearings or ball bearings.

The turbofan engine of any preceding clause, wherein the ball bearings include four-point contact ball bearings.

The turbofan engine of any preceding clause, further comprising a compressor section, a combustion section, and a turbine section downstream of the fan, the turbine section having an input shaft that couples the compressor section to the turbine section, and a gearbox assembly, the fan shaft being drivingly coupled to the input shaft through the gearbox assembly.

The turbofan engine of any preceding clause, wherein the one or more fan bearings are positioned axially between the fan disk and the gearbox assembly.

The turbofan engine of any preceding clause, wherein the one or more fan bearings are positioned radially outward of the gearbox assembly.

A turbofan engine for an aircraft, the turbofan engine including a fan having a plurality of fan blades coupled to a fan shaft having one or more fan bearings, each of the plurality of fan blades being rotatable about a pitch axis and extending from a fan hub, a compressor section, a combustion section, and a turbine section, the turbine section including a low-pressure shaft, and a fan actuation system disposed within the fan hub and including one or more actuators for rotating the plurality of fan blades about the pitch axis and one or more radial thrust bearings, wherein the fan actuation system is characterized by a fan actuation system length envelope in a range of 8.5 to 24, the fan actuation system length envelope being given by

$$\frac{{N}_{FB} \times {D}_{FT}}{{L}_{AXIAL} \times ( \frac{{R}_{TB}}{{N}_{FB}} )}$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, and a gearbox assembly including a first stage gear assembly and a second stage gear assembly, an interstage shaft connected to the first stage gear assembly and the second stage gear assembly, the interstage shaft being an output of the first stage gear assembly and an input of the second stage gear assembly, an input shaft connected to the first stage gear assembly and the low-pressure shaft, and an output shaft connected to the second stage gear assembly and the fan shaft such that the fan shaft is drivingly coupled to low-pressure shaft through the first stage gear assembly and the second stage gear assembly.

The turbofan engine of the preceding clause, wherein the gearbox assembly has a gear ratio in a range of 6:1 to 14:1.

The turbofan engine of any preceding clause, further comprising a gearbox lubrication system for supplying a lubricant to the gearbox assembly, the gearbox lubrication system having an interstage lubricant supply line that directs the lubricant from the first stage gear assembly to the second stage gear assembly.

The turbofan engine of any preceding clause, further comprising a fan actuation system hydraulic fluid system for supplying a hydraulic fluid to the one or more actuators, the fan actuation system hydraulic fluid system including one or more fan actuation system hydraulic fluid supply lines that extend through the first stage gear assembly and the second stage gear assembly, the one or more fan actuation system hydraulic fluid supply lines directing the hydraulic fluid to the one or more actuators.

The turbofan engine of any preceding clause, wherein the low-pressure shaft rotates in a first direction and the first stage gear assembly rotates the interstage shaft in the first direction.

The turbofan engine of any preceding clause, wherein the second stage gear assembly rotates the output shaft in a second direction opposite the first direction.

The turbofan engine of any preceding clause, wherein the second stage gear assembly rotates the output shaft in the first direction.

The turbofan engine of any preceding clause, wherein the first stage gear assembly includes a first stage sun gear, a plurality of first stage planet gears, and a first stage ring gear, the low-pressure shaft being coupled to the first stage sun gear such that the low-pressure shaft and the first stage sun gear rotate in a counterclockwise direction, and the interstage shaft being coupled to the first stage ring gear such that the first stage ring gear and the interstage shaft rotate in the counterclockwise direction.

The turbofan engine of any preceding clause, wherein the second stage gear assembly includes a second stage sun gear, a plurality of second stage planet gears constrained by a second stage planet carrier, and a second stage ring gear, the interstage shaft being coupled to the second stage sun gear such that the second stage sun gear rotates in the counterclockwise direction, and the fan shaft being coupled to the second stage planet carrier such that the second stage planet carrier and the fan shaft rotate in a clockwise direction.

The turbofan engine of any preceding clause, wherein the second stage gear assembly includes a second stage sun gear, a plurality of second stage planet gears, and a second stage ring gear, the interstage shaft being coupled to the second stage sun gear such that the second stage sun gear rotates in the counterclockwise direction, and the fan shaft being coupled to the second stage ring gear such that the second stage ring gear and the fan shaft rotate in the counterclockwise direction.

A turbofan engine for an aircraft, the turbofan engine including a fan having a plurality of fan blades coupled to a fan shaft having one or more fan bearings, the fan being an open fan, and each of the plurality of fan blades being rotatable about a pitch axis and extending from a fan hub, a compressor section, a combustion section, and a turbine section, the turbine section including a low-pressure shaft, a fan actuation system disposed within the fan hub and including one or more actuators for rotating the plurality of fan blades about the pitch axis and one or more radial thrust bearings, wherein the fan actuation system is characterized by a fan actuation system length envelope in a range of 8.5 to 24, the fan actuation system length envelope being given by:

$$\frac{{N}_{FB} \times {D}_{FT}}{{L}_{AXIAL} \times ( \frac{{R}_{TB}}{{N}_{FB}} )}$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, and R_{TB} is a thrust bearing radius of the one or more radial thrust bearings, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings, A_{FH} is in a range of 25 inches to 75 inches, and A_{FB} is in a range of 16 inches to 23 inches, and D_{FT} is in a range of 120.0 inches to 180.0 inches, and a gearbox assembly including a first stage gear assembly and a second stage gear assembly, an interstage shaft connected to the first stage gear assembly and the second stage gear assembly, the interstage shaft being an output of the first stage gear assembly and an input of the second stage gear assembly, an input shaft connected to the first stage gear assembly and the low-pressure shaft, and an output shaft connected to the second stage gear assembly and the fan shaft such that the fan shaft is drivingly coupled to low-pressure shaft through the first stage gear assembly and the second stage gear assembly.

The turbofan engine of the preceding clause, wherein the gearbox assembly has a gear ratio in a range of 6:1 to 14:1.

The turbofan engine of any preceding clause, further comprising a gearbox lubrication system for supplying a lubricant to the gearbox assembly, the gearbox lubrication system having an interstage lubricant supply line that directs the lubricant from the first stage gear assembly to the second stage gear assembly.

The turbofan engine of any preceding clause, further comprising a fan actuation system hydraulic fluid system for supplying a hydraulic fluid to the one or more actuators, the fan actuation system hydraulic fluid system including one or more fan actuation system hydraulic fluid supply lines that extend through the first stage gear assembly and the second stage gear assembly, the one or more fan actuation system hydraulic fluid supply lines directing the hydraulic fluid to the one or more actuators.

The turbofan engine of any preceding clause, wherein the low-pressure shaft rotates in a first direction and the first stage gear assembly rotates the interstage shaft in the first direction.

The turbofan engine of any preceding clause, wherein the second stage gear assembly rotates the output shaft in a second direction opposite the first direction.

The turbofan engine of any preceding clause, wherein the second stage gear assembly rotates the output shaft in the first direction.

The turbofan engine of any preceding clause, wherein the first stage gear assembly includes a first stage sun gear, a plurality of first stage planet gears, and a first stage ring gear, the low-pressure shaft being coupled to the first stage sun gear such that the low-pressure shaft and the first stage sun gear rotate in a counterclockwise direction, and the interstage shaft being coupled to the first stage ring gear such that the first stage ring gear and the interstage shaft rotate in the counterclockwise direction.

The turbofan engine of any preceding clause, wherein the second stage gear assembly includes a second stage sun gear, a plurality of second stage planet gears constrained by a second stage planet carrier, and a second stage ring gear, the interstage shaft being coupled to the second stage sun gear such that the second stage sun gear rotates in the counterclockwise direction, and the fan shaft being coupled to the second stage planet carrier such that the second stage planet carrier and the fan shaft rotate in a clockwise direction.

The turbofan engine of any preceding clause, wherein the second stage gear assembly includes a second stage sun gear, a plurality of second stage planet gears, and a second stage ring gear, the interstage shaft being coupled to the second stage sun gear such that the second stage sun gear rotates in the counterclockwise direction, and the fan shaft being coupled to the second stage ring gear such that the second stage ring gear and the fan shaft rotate in the counterclockwise direction.

A turbofan engine for an aircraft, the turbofan engine includes a fan having a plurality of fan blades coupled to a fan shaft having one or more fan bearings, each of the plurality of fan blades being rotatable about a pitch axis and extending from a fan hub, a compressor section, a combustion section, and a turbine section, the turbine section including a low-pressure shaft, a fan actuation system disposed within the fan hub and including one or more actuators for rotating the plurality of fan blades about the pitch axis and one or more radial thrust bearings, wherein the fan actuation system is characterized by a fan actuation system length envelope in a range of 8.5 to 24, the fan actuation system length envelope being given by:

$$\frac{{N}_{FB} \times {D}_{FT}}{{L}_{AXIAL} \times ( \frac{{R}_{TB}}{{N}_{FB}} )}$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, and a gearbox assembly including an input shaft connected to the low-pressure shaft, an output shaft connected to the fan shaft, and a gear assembly includes a sun gear connected to the input shaft and configured to rotate in a first direction, a plurality of planet gears configured to rotate in the first direction or a second direction opposite the first direction, a plurality of idler gears engaged with respective ones of the plurality of planet gears and configured to rotate in a direction opposite the plurality of planet gears, and a ring gear connected to the output shaft and configured to drive the output shaft to rotate in the first direction.

The turbofan engine of the preceding clause, wherein the gearbox assembly has a gear ratio in a range from 6:1 to 14:1.

The turbofan engine of any preceding clause, wherein the gearbox assembly has a gear ratio in a range from 6:1 to 12:1.

The turbofan engine of any preceding clause, wherein each of the plurality of planet gears includes a planet gear first stage and a planet gear second stage.

The turbofan engine of any preceding clause, wherein the gear assembly has an axial envelope and a radial envelope, the gear assembly having a gear ratio in a range from 6:1 to 12:1, and a ratio of the radial envelope to the axial envelope is in a range from 1.26 to 3.66.

The turbofan engine of any preceding clause, wherein the gear assembly has an axial envelope and a radial envelope, the gear assembly having a gear ratio in a range from 6:1 to 10:1, and a ratio of the radial envelope to the axial envelope is in a range from 1.79 to 3.05.

The turbofan engine of any preceding clause, wherein the plurality of idler gears engage with the ring gear, the plurality of planet gears configured to rotate in the second direction, and the plurality of idler gears configured to rotate in the first direction.

The turbofan engine of any preceding clause, wherein each of the plurality of planet gears includes a planet gear first stage and a planet gear second stage, the planet gear first stage engaging the sun gear and the planet gear second stage engaging a respective one of the plurality of idler gears.

The turbofan engine of any preceding clause, wherein the plurality of idler gears engage with the sun gear, the plurality of idler gears configured to rotate in the second direction, and the plurality of planet gears configured to rotate in the first direction.

The turbofan engine of any preceding clause, wherein each of the plurality of planet gears includes a planet gear first stage and a planet gear second stage, the planet gear first stage engaging a respective one of the plurality of idler gears and the planet gear second stage engaging the ring gear.

A turbofan engine for an aircraft, the turbofan engine including a fan having a plurality of fan blades coupled to a fan shaft having one or more fan bearings, the fan being an open fan, and each of the plurality of fan blades being rotatable about a pitch axis and extending from a fan hub, a compressor section, a combustion section, and a turbine section, the turbine section including a low-pressure shaft, and a fan actuation system disposed within the fan hub and including one or more actuators for rotating the plurality of fan blades about the pitch axis and one or more radial thrust bearings, wherein the fan actuation system is characterized by a fan actuation system length envelope in a range of 8.5 to 24, the fan actuation system length envelope being given by:

$$\frac{{N}_{FB} \times {D}_{FT}}{{L}_{AXIAL} \times ( \frac{{R}_{TB}}{{N}_{FB}} )}$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, and R_{TB} is a thrust bearing radius of the one or more radial thrust bearings, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings, A_{FH} is in a range of 25 inches to 75 inches, and A_{FB} is in a range of 16 inches to 23 inches, and D_{FT} is in a range of 120.0 inches to 180.0 inches, and a gearbox assembly including an input shaft connected to the low-pressure shaft, an output shaft connected to the fan shaft, and a gear assembly including a sun gear connected to the input shaft and configured to rotate in a first direction, a plurality of planet gears configured to rotate in the first direction or a second direction opposite the first direction, a plurality of idler gears engaged with respective ones of the plurality of planet gears and configured to rotate in a direction opposite the plurality of planet gears, and a ring gear connected to the output shaft and configured to drive the output shaft to rotate in the first direction.

The turbofan engine of the preceding clause, wherein the gearbox assembly has a gear ratio in a range of 6:1 to 14:1.

The turbofan engine of any preceding clause, wherein the gearbox assembly has a gear ratio in a range from 6:1 to 12:1.

The turbofan engine of any preceding clause, wherein each of the plurality of planet gears includes a planet gear first stage and a planet gear second stage.

The turbofan engine of any preceding clause, wherein the gear assembly has an axial envelope and a radial envelope, the gear assembly having a gear ratio in a range from 6:1 to 12:1, and a ratio of the radial envelope to the axial envelope is in a range from 1.26 to 3.66.

The turbofan engine of any preceding clause, wherein the gear assembly has an axial envelope and a radial envelope, the gear assembly having a gear ratio in a range from 6:1 to 10:1, and a ratio of the radial envelope to the axial envelope is in a range from 1.79 to 3.05.

The turbofan engine of any preceding clause, wherein the plurality of idler gears engage with the ring gear, the plurality of planet gears configured to rotate in the second direction, and the plurality of idler gears configured to rotate in the first direction.

The turbofan engine of any preceding clause, wherein each of the plurality of planet gears includes a planet gear first stage and a planet gear second stage, the planet gear first stage engaging the sun gear and the planet gear second stage engaging a respective one of the plurality of idler gears.

The turbofan engine of any preceding clause, wherein the plurality of idler gears engage with the sun gear, the plurality of idler gears configured to rotate in the second direction, and the plurality of planet gears configured to rotate in the first direction.

The turbofan engine of any preceding clause, wherein each of the plurality of planet gears includes a planet gear first stage and a planet gear second stage, the planet gear first stage engaging a respective one of the plurality of idler gears and the planet gear second stage engaging the ring gear.

Although the foregoing description is directed to the preferred embodiments of the present disclosure, other variations and modifications will be apparent to those skilled in the art and may be made without departing from the disclosure. Moreover, features described in connection with one embodiment of the present disclosure may be used in conjunction with other embodiments, even if not explicitly stated above.

1. A turbofan engine for an aircraft, the turbofan engine comprising:
a fan having a plurality of fan blades coupled to a fan shaft having one or more fan bearings, each of the plurality of fan blades being rotatable about a pitch axis and extending from a fan hub;
a compressor section, a combustion section, and a turbine section, the turbine section including a low-pressure shaft; and
a fan actuation system disposed within the fan hub and including one or more actuators for rotating the plurality of fan blades about the pitch axis and one or more radial thrust bearings, wherein the fan actuation system is characterized by a fan actuation system length envelope in a range of 8.5 to 24, the fan actuation system length envelope being given by:
$$\frac{{N}_{FB} \times {D}_{FT}}{{L}_{AXIAL} \times ( \frac{{R}_{TB}}{{N}_{FB}} )}$$
wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings; and
a gearbox assembly comprising:
a first stage gear assembly and a second stage gear assembly;
an interstage shaft connected to the first stage gear assembly and the second stage gear assembly, the interstage shaft being an output of the first stage gear assembly and an input of the second stage gear assembly;
an input shaft connected to the first stage gear assembly and the low-pressure shaft; and
an output shaft connected to the second stage gear assembly and the fan shaft such that the fan shaft is drivingly coupled to low-pressure shaft through the first stage gear assembly and the second stage gear assembly.

2. The turbofan engine of claim 1, wherein the gearbox assembly has a gear ratio in a range of 6:1 to 14:1.

3. The turbofan engine of claim 1, further comprising a gearbox lubrication system for supplying a lubricant to the gearbox assembly, the gearbox lubrication system having an interstage lubricant supply line that directs the lubricant from the first stage gear assembly to the second stage gear assembly.

4. The turbofan engine of claim 1, further comprising a fan actuation system hydraulic fluid system for supplying a hydraulic fluid to the one or more actuators, the fan actuation system hydraulic fluid system including one or more fan actuation system hydraulic fluid supply lines that extend through the first stage gear assembly and the second stage gear assembly, the one or more fan actuation system hydraulic fluid supply lines directing the hydraulic fluid to the one or more actuators.

5. The turbofan engine of claim 1, wherein the low-pressure shaft rotates in a first direction and the first stage gear assembly rotates the interstage shaft in the first direction.

6. The turbofan engine of claim 5, wherein the second stage gear assembly rotates the output shaft in a second direction opposite the first direction.

7. The turbofan engine of claim 5, wherein the second stage gear assembly rotates the output shaft in the first direction.

8. The turbofan engine of claim 1, wherein the first stage gear assembly comprises:
a first stage sun gear;
a plurality of first stage planet gears; and
a first stage ring gear, the low-pressure shaft being coupled to the first stage sun gear such that the low-pressure shaft and the first stage sun gear rotate in a counterclockwise direction, and the interstage shaft being coupled to the first stage ring gear such that the first stage ring gear and the interstage shaft rotate in the counterclockwise direction.

9. The turbofan engine of claim 8, wherein the second stage gear assembly comprises:
a second stage sun gear;
a plurality of second stage planet gears constrained by a second stage planet carrier; and
a second stage ring gear, the interstage shaft being coupled to the second stage sun gear such that the second stage sun gear rotates in the counterclockwise direction, and the fan shaft being coupled to the second stage planet carrier such that the second stage planet carrier and the fan shaft rotate in a clockwise direction.

10. The turbofan engine of claim 8, wherein the second stage gear assembly comprises:
a second stage sun gear;
a plurality of second stage planet gears; and
a second stage ring gear, the interstage shaft being coupled to the second stage sun gear such that the second stage sun gear rotates in the counterclockwise direction, and the fan shaft being coupled to the second stage ring gear such that the second stage ring gear and the fan shaft rotate in the counterclockwise direction.

11. A turbofan engine for an aircraft, the turbofan engine comprising:
a fan having a plurality of fan blades coupled to a fan shaft having one or more fan bearings, the fan being an open fan, and each of the plurality of fan blades being rotatable about a pitch axis and extending from a fan hub;
a compressor section, a combustion section, and a turbine section, the turbine section including a low-pressure shaft;
a fan actuation system disposed within the fan hub and including one or more actuators for rotating the plurality of fan blades about the pitch axis and one or more radial thrust bearings, wherein the fan actuation system is characterized by a fan actuation system length envelope in a range of 8.5 to 24, the fan actuation system length envelope being given by:
$$\frac{{N}_{FB} \times {D}_{FT}}{{L}_{AXIAL} \times ( \frac{{R}_{TB}}{{N}_{FB}} )}$$
wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, and R_{TB} is a thrust bearing radius of the one or more radial thrust bearings, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings, A_{FH} is in a range of 25 inches to 75 inches, and A_{FB} is in a range of 16 inches to 23 inches, and D_{FT} is in a range of 120.0 inches to 180.0 inches; and
a gearbox assembly comprising:
a first stage gear assembly and a second stage gear assembly;
an interstage shaft connected to the first stage gear assembly and the second stage gear assembly, the interstage shaft being an output of the first stage gear assembly and an input of the second stage gear assembly;
an input shaft connected to the first stage gear assembly and the low-pressure shaft; and
an output shaft connected to the second stage gear assembly and the fan shaft such that the fan shaft is drivingly coupled to low-pressure shaft through the first stage gear assembly and the second stage gear assembly.

12. The turbofan engine of claim 11, wherein the gearbox assembly has a gear ratio in a range of 6:1 to 14:1.

13. The turbofan engine of claim 11, further comprising a gearbox lubrication system for supplying a lubricant to the gearbox assembly, the gearbox lubrication system having an interstage lubricant supply line that directs the lubricant from the first stage gear assembly to the second stage gear assembly.

14. The turbofan engine of claim 11, further comprising a fan actuation system hydraulic fluid system for supplying a hydraulic fluid to the one or more actuators, the fan actuation system hydraulic fluid system including one or more fan actuation system hydraulic fluid supply lines that extend through the first stage gear assembly and the second stage gear assembly, the one or more fan actuation system hydraulic fluid supply lines directing the hydraulic fluid to the one or more actuators.

15. The turbofan engine of claim 11, wherein the low-pressure shaft rotates in a first direction and the first stage gear assembly rotates the interstage shaft in the first direction.

16. The turbofan engine of claim 15, wherein the second stage gear assembly rotates the output shaft in a second direction opposite the first direction.

17. The turbofan engine of claim 15, wherein the second stage gear assembly rotates the output shaft in the first direction.

18. The turbofan engine of claim 11, wherein the first stage gear assembly comprises:
a first stage sun gear;
a plurality of first stage planet gears; and
a first stage ring gear, the low-pressure shaft being coupled to the first stage sun gear such that the low-pressure shaft and the first stage sun gear rotate in a counterclockwise direction, and the interstage shaft being coupled to the first stage ring gear such that the first stage ring gear and the interstage shaft rotate in the counterclockwise direction.

19. The turbofan engine of claim 18, wherein the second stage gear assembly comprises:
a second stage sun gear;
a plurality of second stage planet gears constrained by a second stage planet carrier; and
a second stage ring gear, the interstage shaft being coupled to the second stage sun gear such that the second stage sun gear rotates in the counterclockwise direction, and the fan shaft being coupled to the second stage planet carrier such that the second stage planet carrier and the fan shaft rotate in a clockwise direction.

20. The turbofan engine of claim 18, wherein the second stage gear assembly comprises:
a second stage sun gear;
a plurality of second stage planet gears; and
a second stage ring gear, the interstage shaft being coupled to the second stage sun gear such that the second stage sun gear rotates in the counterclockwise direction, and the fan shaft being coupled to the second stage ring gear such that the second stage ring gear and the fan shaft rotate in the counterclockwise direction.
